(19) United States
(12) Patent Application Publication
(10) Pub. No.: US 2005/0062809 A1
(43) Pub. Date: Mar. 24, 2005

(54) Liquid ejection apparatus and method for driving the same

(75) Inventors: Keiichiro Yoshino, Nagano-ken (JP); Toshio Kumagai, Nagano-ken (JP); Takeo Seino, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/871,611

(22) Filed: Jun. 21, 2004

(30) Foreign Application Priority Data
Jun. 20, 2003 (JP) PAT. 2003-177049
Jun. 20, 2003 (JP) PAT. 2003-177050
Sep. 5, 2003 (JP) PAT. 2003-314609
Mar. 31, 2004 (JP) PAT. 2004-105796

(51) Int. Cl. B41J 2/175

(52) U.S. Cl. 347/85

(57) ABSTRACT

A liquid ejection apparatus comprises a liquid cartridge for storing a liquid, a liquid ejection head for ejecting the liquid toward a target, a liquid supply path for guiding the liquid to the liquid ejection head from the liquid cartridge, and a capping device for drawing the liquid from the liquid ejection head. The liquid supply path comprises a plurality of wall surfaces, and a part of the wall surface is formed of a flexible member that is flexed by the inside-and-outside pressure difference of the liquid supply path. A pressure pump for adjusting the pressure of a fluid within the liquid supply path in the upstream side of the flexible member is provided.

### BACKGROUND OF THE INVENTION

The present invention relates to a liquid ejection apparatus and a driving method thereof.

Heretofore, in general, as a liquid ejection apparatus for ejecting a liquid from a nozzle toward a target, an ink jet recording apparatus has been widely used. This ink jet recording apparatus comprises a carriage and a recording head mounted on the carriage. While moving the carriage on the recording head, the apparatus ejects ink from the nozzle formed on the recording head and performs printing on a recording medium.

Such an ink jet recording apparatus, when not being operated, often suffers an increase in viscosity of the ink in the nozzle and solidification of the ink because of evaporation of the ink solvent, such as water vapor and the like from the nozzle of the recording head. As a result, there is the possibility of poor performance of the printing, such as dust deposition on the nozzle and poor ink ejection.

To solve these problems, an ink jet recording apparatus comprising capping means has been known. In more detail, the capping means comprises a cap capable of covering the nozzle surface of the recording head and a suction pump capable of depressurizing the inside of the cap. When not being operated, the nozzle surface of the recording head is covered by this cap with humidity in the space formed by the recording head and the cap being maintained, thereby preventing the ink from being solidified.

Moreover, the depressurization of the inside of the cap by the suction pump in a state of covering the nozzle surface of the recording head by the cap allows ink, dust and the like to be drawn from the nozzle. This protects the ink from increased viscosity, dust and the like in the vicinity of the nozzle, thereby making it possible to maintain the performance of the nozzle in an optimum state.

In the ink jet recording apparatus as described above, there are often cases where bubbles and impurities mixed in the ink are stagnated in the ink flow path from an ink cartridge to the recording head. Because of these bubbles and impurities, it is feared that the ink filling factor in the ink flow path is reduced, supply property of the ink to the recording head is reduced, bubbles and impurities flow out of the nozzle during printing, and printing quality is reduced.

Hence, to increase the ink filling factor in the ink flow path, an ink jet recording apparatus comprising a valve unit, which is a “choke valve”, has been known (for example, see Japanese Laid-Open Patent Application Publication No. 2001-38925). To describe it in detail, this valve unit is provided in the ink flow path between an ink cartridge and the recording head, and is capable of opening and closing the ink flow path.

By putting the valve unit into a closed state, and covering the nozzle surface of the recording by the cap, and depressurizing the inside of the cap by suction means, a negative pressure accumulates within the ink flow path in a section downstream from the valve unit. After that, by putting the valve unit into an open state while the negative pressure is in an accumulated state, the flow speed of the ink in the ink flow path is increased instantaneously. Thus, “choke cleaning” is performed, which discharges from the nozzle the bubbles and impurities stagnated together with the ink flow speed sped up instantaneously. As a result, it is possible to increase the filling factor of the ink in the ink flow path.

Incidentally, the valve unit disclosed in the above publication is configured such that the switching of its valve opening and closing is usually performed by an actuator and the like. Consequently, it is necessary not only to perform the drive control for the cap and the absorption pump, but also to perform the drive control for the actuator of the valve unit, which is a cause of making the control complicated. Further, there is a need to consider arrangement of space for the actuator, and this can increase the size of the apparatus.

The present invention has been made in view of the above-described problems, and an objective of the invention is to provide a liquid ejection apparatus and a driving method thereof, which is capable of choke cleaning with simple control without increasing the size of the size of the apparatus.

### SUMMARY OF THE INVENTION

To achieve the above-described objective, the present invention provides a liquid ejection apparatus comprising liquid reservoir means for storing liquid, a liquid ejection head for ejecting liquid toward a target, a liquid supply path for guiding liquid to the liquid ejection head from the liquid reservoir means, and suction means for drawing liquid from the liquid ejection head. In the liquid injection apparatus, the liquid supply path comprises a plurality of wall surfaces, and a flexible member that is flexed by the inside-and-outside pressure difference of the liquid supply path, which forms a part of the wall surface. Pressure adjusting means for adjusting the pressure of the fluid within the liquid supply path in the upstream side of the flexible member is provided.

According to the present invention, the pressure of the fluid within the liquid supply path in the upstream side of the flexible member is reduced by the pressure adjusting means, and liquid from a liquid ejection head is drawn by the suction means, so that the pressure within the liquid supply path is totally reduced. The pressure difference is generated inside and outside of the liquid supply path, and the flexible member is flexed in a direction to reduce a flow path cross-sectional area of the liquid supply path. Consequently, flow path resistance of the liquid supply path is increased, thereby reducing flow amount within the liquid supply path in the vicinity of the flexible member.

In this state, by allowing a suction operation by the suction means to continue, it is possible to accumulate the negative pressure within the liquid supply path in the section downstream of the portion where the flexible member is provided. Consequently, after accumulating negative pressure, by the pressure adjusting means, the pressure of liquid in the section upstream of the flexible member is increased, so that the negative pressure accumulated within the liquid supply path is eliminated instantly, thereby increasing the flow speed of liquid within the liquid supply path instantaneously. As a result, the choke cleaning for discharging the bubbles and impurities together with liquid stagnated within the liquid supply path is performed instantly.

According to the present invention, since such a choke cleaning is performed, no opening and closing valve, opened and closed by an actuator and the like are provided, and therefore, the size of the apparatus is not increased. Further, the choke cleaning is simply performed only by controlling the pressure adjusting means and the suction means.

According to another aspect of the present invention, a driving method for a liquid ejection apparatus is provided. The liquid ejection apparatus comprises liquid reservoir means for storing liquid, a liquid ejection head for ejecting liquid toward a target from a nozzle, a liquid supply path for guiding liquid to the liquid ejection head from the liquid reservoir means, and suction means for drawing liquid from the nozzle of the liquid ejection head, and the liquid supply path is formed by a flexible member in which a part of the wall surface constituting the liquid supply path is flexed by the pressure difference between the inside and the outside of the liquid supply path. The driving method of the liquid ejection apparatus has a pressure reducing step for reducing the pressure of the fluid within the liquid supply path in the upstream side of the flexible member by the pressure adjusting means, a drawing step for drawing liquid from the nozzle of the liquid ejection head by the suction means when the pressure of the fluid within the liquid supply path in the upstream side of the flexible member decreases below a predetermined value, and a pressure increasing step for increasing the pressure of the fluid within the liquid supply path in the upstream side of the flexible member by the pressure adjusting means subsequent to the drawing step.

According to this aspect, by advancing to the drawing step after the pressure reducing step, it is possible to totally reduce the pressure within the liquid supply path. By reducing the pressure within the liquid supply path, the flexible member is flexed in a direction to reduce the flow path cross-sectional area of the liquid supply path. Consequently, flow path resistance of the liquid supply path is increased, thereby reducing flow amount of liquid within the liquid supply path. By allowing this state to continue, it is possible to accumulate negative pressure within the liquid supply path in the section downstream of the portion where the flexible member is provided. As a result, volume of bubbles stagnated within the liquid supply path is increased, which is put into a state that is easy to be discharged to the outside through the liquid ejection head. Further, after this, by advancing to the pressure increasing step, it becomes possible to eliminate the accumulation of negative pressure within the liquid supply path and discharge bubbles stagnated within the liquid supply path from the nozzle instantly. As a result, choke cleaning is effectively performed.

According to still another aspect of the present invention, a liquid ejection apparatus is provided, which comprises liquid reservoir means for storing liquid, a liquid ejection head for ejecting liquid toward the target, and a liquid supply path for guiding liquid to the liquid ejection head from the liquid reservoir means. The liquid supply path comprises a bubble trap flow path comprising a bubble accumulator capable of trapping bubbles contained in liquid, and a bubble non-trap flow path in which a flow path cross-sectional surface is determined so as to be able to move bubbles against buoyancy of the bubbles, and the bubble trap flow path and the bubble non-trap flow path are mutually arranged in parallel. Further, distribution means for changing a distribution factor of flow amount of liquid, which flows through the bubble trap flow path and the bubble non-trap flow path, is provided.

According to this liquid ejection apparatus, when liquid is ejected from the liquid ejection head toward the target, by the distribution means, a greater amount of liquid flows to the bubble trap flow path than to the bubble non-trap flow path. As a result, a bubble contained in the liquid supplied to the liquid ejection head has a high probability of being trapped in the bubble trap flow path, and it is possible to prevent ejection performance from being reduced due to the discharging of the bubble together with liquid from the liquid ejection head.

Further, when the volume of the bubble trapped in the bubble trap flow path is increased, and there arises a limit on the trapping ability of the bubble in the bubble trap flow path, a greater amount of liquid flows to the bubble non-trap flow path than to the bubble trap flow path by the distribution means. By the flow of liquid from the bubble non-trap flow path to the liquid ejection head, the bubble trapped in the bubble trap flow path is guided to the bubble non-trap path. At this time, the bubble non-trap flow path is formed in such a manner as to become a flow path cross-sectional surface not easy to trap the bubble, and therefore, the bubble guided to the bubble non-trap flow path is moved to the liquid ejection head. As a result, elimination of the bubble stagnated in the bubble trap flow path is performed much accurately.

According to another aspect of the present invention, a driving method of the liquid ejection apparatus is provided, which comprises liquid reservoir means for storing liquid, a liquid ejection head for ejecting the liquid toward a target, a liquid supply path for guiding liquid to the liquid ejection head from the liquid reservoir means, a bubble trap flow path in which the liquid supply path traps the bubble contained in liquid, and a bubble non-trap flow path, which is connected in parallel to the bubble trap flow path and determines a flow path cross-sectional area so as to be able to move the bubble against buoyancy of the bubble. This method comprises a flow path changing step for changing a distribution factor of the flow amount of liquid so that the flow amount of the liquid flowing the bubble non-trap flow path is larger than that of the liquid flowing the bubble trap flow path, a flow amount reducing step for reducing the flow amount of the liquid flowing the liquid supply path in the section upstream of the bubble trap low path and the bubble non-trap flow path, a drawing step for drawing liquid from the liquid ejection head, and a flow increasing step for increasing the flow amount of the liquid flowing the liquid supply path subsequent to the drawing step.

According to this method, in a state where the flow amount of liquid flowing to the bubble non-trap flow path is high, the flow amount of liquid flowing into the liquid supply path is reduced, and at the same time, liquid is drawn from the liquid ejection head, thereby accumulating the negative pressure within the liquid supply path. As a result, the volume of the bubble stagnated in the liquid supply path is increased such that the bubble is in a state easy to be discharged outside through the liquid ejection head. After that, by advancing to the flow amount increasing step, the accumulation of the negative pressure within the liquid supply path is eliminated, and the bubble stagnated within the liquid supply path is discharged from the liquid ejection head instantly. As a result, the choke cleaning is performed, and the elimination of the bubble trapped in the bubble trap flow path is more accurately performed.

### BRIEF DESCRIPTION OF THE DRAWINGS

FIG. 1 is a top view of an ink ejection recording apparatus in a first embodiment;

FIG. 2 is a cross-sectional view of an ink cartridge;

FIG. 3 is a partial cross-sectional view of an ink jet recording apparatus;

FIG. 4 is a view of one side of a valve unit;

FIG. 5 is the other side view of the valve unit;

FIG. 6 is an exploded perspective view of the valve unit seen from one direction;

FIG. 7 is an exploded perspective view of the valve unit seen from another direction;

FIG. 8 is a cross-sectional view, with a part cut away, showing the valve unit;

FIG. 9 is a block diagram showing an electrical arrangement for the ink jet recording apparatus;

FIG. 10 is a partial cross-sectional view showing an operating state of the valve unit;

FIG. 11 is a partial cross-sectional view showing another operating state of the valve unit;

FIG. 12 is a perspective view of an ink jet recording apparatus according to a second embodiment;

FIG. 13 is a partial perspective view of the ink jet recording apparatus;

FIG. 14 is a perspective view of a flow concentration path;

FIG. 15 is a perspective view showing a mounted state of the flow concentration path;

FIG. 16 is a partial cross-sectional view showing the operating state of an ink introduction chamber;

FIG. 17 is a partial cross-sectional view showing another operating state of the ink introduction chamber;

FIG. 18 is a partial cross-sectional view of the valve unit;

FIG. 19 is a perspective view of a flow concentration path in a third embodiment;

FIG. 20 is a top view of the main body of a choke valve;

FIG. 21 is an under surface view of the main body of the choke valve;

FIG. 22 is a cross-sectional view for explaining the operation of the ink introduction chamber;

FIG. 23 is a perspective view of a flow concentration path in a fourth embodiment;

FIG. 24 is a top view of a choke valve;

FIG. 25 is a perspective view of a regulating plate of the choke valve;

FIG. 26 is an essential part, top view of the choke valve;

FIG. 27 is an essential part, cross-sectional view of the choke valve;

FIG. 28 is an essential part, cross-sectional view showing the operating state of the choke valve;

FIG. 29 is an essential part, cross-sectional view showing another operating state of the choke valve;

FIG. 30 is an explanatory drawing showing the case where the regulating plate is not provided on the choke valve;

FIG. 31 is a partial cross-sectional view of the valve unit in a first modification;

FIG. 32 is a cross-sectional view showing the operating state of the valve unit in the first modification;

FIG. 33 is a partial cross-sectional view of the valve unit in a second modification;

FIG. 34 is a partial side view of the valve unit in a third modification;

FIG. 35 is a cross-sectional view showing the operational state of the valve unit in the third modification;

FIG. 36 is a partial cross-sectional view of the valve unit in a fourth modification;

FIG. 37 is a partial cross-sectional view of the valve unit in a fifth modification;

FIG. 38 is a partial cross-sectional view of the valve unit in a sixth modification;

FIG. 39 is a partial cross-sectional view of the valve unit in a fifth embodiment;

FIG. 40 is a partial cross-sectional view of the valve unit; and

FIG. 41 is a view showing the operating state of the valve unit.

### DETAILED DESCRIPTION OF THE PREFERRED EMBODIMENTS

(First Embodiment)

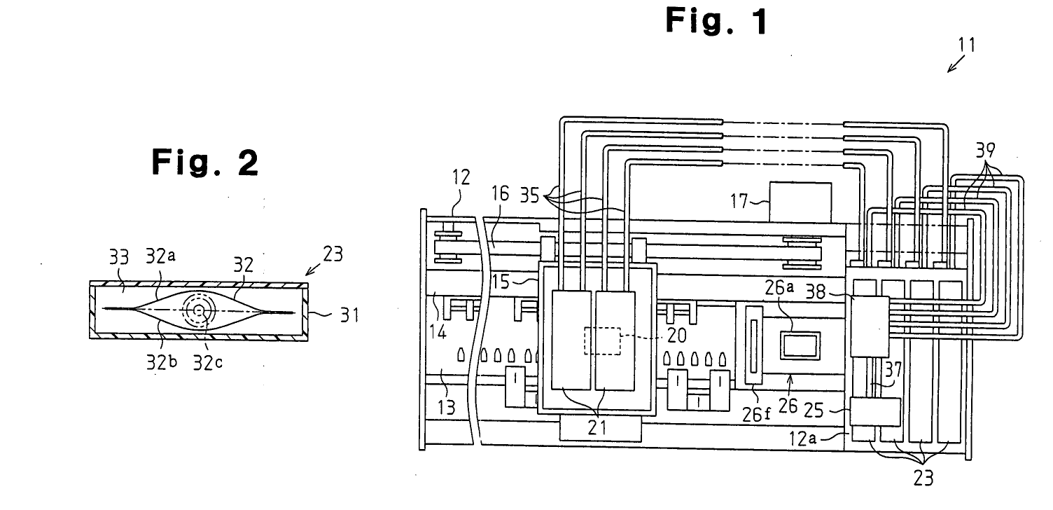

A first embodiment according to the present invention will be described below according to FIGS. 1 to 11.

As shown in FIG. 1, an ink jet recording apparatus 11 as a liquid ejection apparatus of the present embodiment comprises a main body case 12, a platen 13, a guide shaft 14, a carriage 15, a timing belt 16, a carriage motor 17, and a recording head 20 as a liquid ejection head. Further, the ink jet recording apparatus 11 comprises a valve unit 21 as a liquid supply valve unit, an ink cartridge 23 as liquid reservoir means and a liquid cartridge, a pressure pump 25, and a capping device 26 as suction means.

The main body case 12 is a substantially rectangular case, and a cartridge holder 12a is formed in the right side end portion shown in FIG. 11. In the present embodiment, the longitudinal direction of the main body case 12 is taken as the main scanning direction.

The platen 13 is provided along the main scanning direction within the main body case 12, and is a member for supporting a recording medium (not shown) as a target to be fed through paper feeding means (not shown). In the present embodiment, the recording medium is delivered in a direction orthogonal to the main scanning direction, that is, a secondary scanning direction.

The guide shaft 14 is formed in a bar shape, and is provided in parallel with the platen 13, that is, along the main scanning direction within the main body case 12. The carriage 15 is interposed relatively movable for the guide shaft 14 in a position opposing the platen 13, and reciprocates in the main scanning direction.

The carriage 15 is connected to the carriage motor 17 through the timing belt 16. The carriage motor 17 is supported by the main body case 12, and when the carriage motor 17 is driven, the carriage 15 is driven through the timing belt 16. As a result, the carriage 15 is reciprocated along the guide shaft 14.

The recording head 20 is provided on the surface opposing the platen 13 of the carriage 15, and comprises a plurality of unillustrated nozzles for ejecting an ink as a liquid toward the platen 13. The valve unit 21 is mounted on the carriage 15, and supplies temporarily stored ink for the recording head 20 in a pressure adjusted state. In the present embodiment, two valve units 21 are provided, and one of the valve units 21 is capable of adjusting the pressure of the ink of two colors. In the present embodiment, through the one valve unit 21 with respect to the ink of each color of black and yellow, and the other valve unit 21 with respect to the ink of each color of magenta and cyan adjust the pressures thereof and supply the ink to the recording head 20. Needless to mention, the colors may be changed to a combination of other colors.

The ink cartridge 23 is detachably accommodated in the cartridge holder 12a, and four ink cartridges 23 are provided corresponding to the ink colors. In FIG. 2 one of the four cartridges 23 is shown, and the ink cartridge 23 comprises an ink case 31 as a pressure chamber and an ink pack 32 as a liquid accommodating portion. The ink case 31 is formed in a substantially rectangular shape. Further, the ink pack 32 is formed by superposing two sheets of film 32a and 32b as flexible portions, and the ink as a liquid is sealed inside thereof.

The ink pack 32 comprises an ink discharge port 32c, and is accommodated within the ink case 31. At this time, the ink discharge port 32c alone is in a state of being exposed from the ink case 31, and the other portion is accommodated within the ink case 31 so as to be in a sealed state. Consequently, a gap 33 is formed between the ink case 31 and the ink pack 32.

Further, the ink case 31 is provided with a communication port (not shown) communicating with the gap 33, and by allowing the air to flow through this communication port, pressure in the gap 33 is increased, thereby making it possible to generate a force such as that crushing the ink pack 32. The ink discharge port 32c of the ink pack 32, as shown in FIG. 1, is connected to the valve unit 21 through an ink supply tube 35 provided for each color. The ink supply tube 35 constitutes a liquid supply path. Consequently, by introducing air to the gap 33 within the ink case 31, the ink within the ink pack 32 is supplied to the valve unit 21 through the ink supply tube 35.

The pressure pump 25, in the present embodiment, is positioned on the ink cartridge 23, and is fixed to the main body case 12. The pressure pump 25 is capable of drawing air and discharging it as pressurized air. The pressurized air is supplied to a pressure detector 38 through a pressurization tube constituting an airflow path.

The pressure detector 38 detects the pressure of the air supplied from the pressure pump 25. In the present embodiment, based on the pressure detected in the pressure detector 38, the drive of the pressure pump 25 is adjusted. Consequently, the air supplied from the pressure pump 25 is adjusted to a pressure within a predetermined range by the pressure detector 38. The pressure detector 38 is connected to the communication hole of the ink cartridge 23 through four pieces of air supply tube constituting the airflow path, and the air adjusted to a pressure of predetermined range is introduced to the gap 33 of the ink cartridge 23.

Thus, the ink pack 32 of each ink cartridge 23 is pressurized by the pressurized air supplied from the pressure pump 25, and the ink within the ink pack 32 is supplied to the valve unit 21. The ink temporarily stored in the valve unit 21 is supplied to the recording head 20 in a pressure adjusted state.

At this time, while the recording medium is moved in the second scanning direction by the paper feeding means based on image data, the carriage 15 is moved to the main scanning direction, and the ink from the recording head 20 is ejected, so that printing on the recording medium becomes possible.

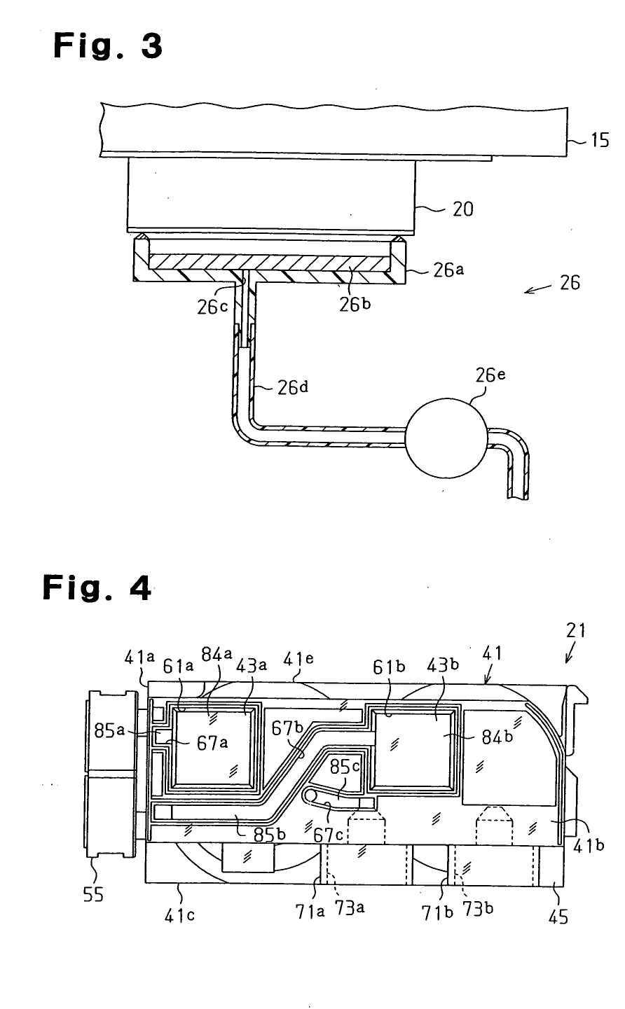

The capping device 26 is provided in a non-printing area (home position) in the moving path of the carriage 15. On the upper surface of the capping device 26, a cap 26a is arranged, which is formed by an elastic member such as elastomer capable of adhering to the nozzle surface of the recording head 20 and sealing thereof. As shown in FIG. 3, this cap 26a moves (lifts) to the recording head when the carriage 15 moves to the home position, and the cap 26a seals the nozzle surface of the recording head 20.

An absorber 26b containing the ink is provided in the inside of the cap 26a, and during idle periods of the ink jet recording apparatus 11, by sealing the nozzle surface of the recording head 20 with the cap 26a, the inside of the cap 26a is maintained in a high humidity state so as to prevent ink viscosity from increasing. As material for the absorber 26b, a sponge and the like are used, but no limit is imposed on this material as long as it absorbs the ink.

Further, a discharge port 26c for discharging the ink, bubbles, impurities and the like is provided on the underside of the cap 26a, and this discharge port 26c is connected to one end of an ink discharge tube 26d. The other end of the ink discharge tube 26d is connected to an unillustrated waste liquid tank.

A tube pump 26e is provided in the midst of the ink discharge tube 26d, and by the suction operation of the tube pump 26e, a negative pressure is formed within the cap 26a. Ink being increased in viscosity, dust, and bubbles produced by exchange of the cartridges in the recording head 20 are discharged into the waste liquid tank through the ink discharge tube 26d. This allows the “cleaning operation” to be performed.

In the meantime, as shown in FIG. 1, the capping device 26 is provided with a wiping member 26f formed in a rectangular shape from an elastic raw material such as rubber and the like in the vicinity of the printing area of the cap 26a. The wiping member 26f is constituted such that it advances into the moving path of the recording head 20 when the need arises, thereby wiping out and cleaning the nozzle surface.

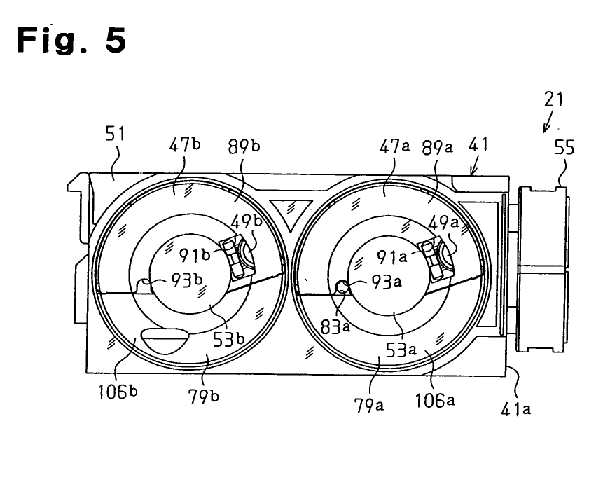

Next, the valve unit 21 will be described in detail according to FIGS. 4 to 8.

As shown in FIGS. 4 to 8, the valve unit 21 comprises a flow path forming member 41, first and second filters 43a and 43b, a first film member 45 as a flexible member, and first and second fitting members 47a and 47b. Further, the valve unit 21 further comprises first and second valve members 49a and 49b as opening and closing valves, a second film member 51, first and second pressure receiving plates 53a and 53b.

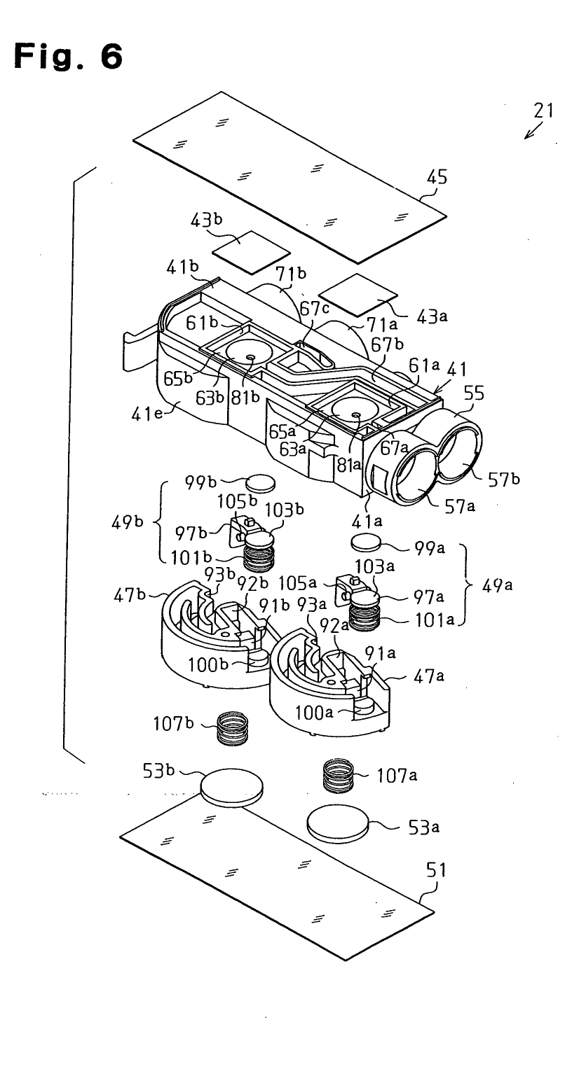

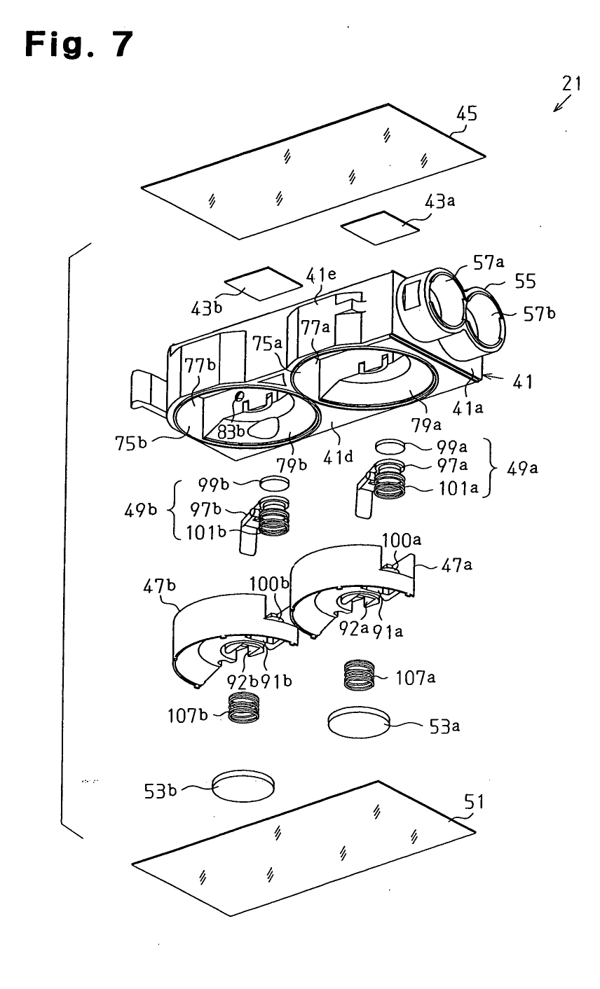

The flow path forming member 41 is formed in a substantially rectangular shape, and an ink introduction portion 55 is provided in its back surface 41a (the left side surface in FIG. 4). As shown in FIGS. 6 and 7, the ink introduction portion 55 has a shape as if having connected two cylinders, and comprises first and second ink introduction holes 57a and 57b. One piece each of the ink supply tube 35 (see FIG. 1) is connected to these first and second ink introduction holes 57a and 57b, so that ink of a total of two colors from the ink supply tube 35 is guided within the flow path forming member 41.

As shown in FIGS. 4 and 6, the flow path forming member 41 is provided with first and second square recess portions 61a and 61b as large cross-sectional area flow paths in its first side surface 41b. Further, as shown in FIG. 6, first and second spherical recess portions 63a and 63b as small cross-sectional flow paths, respectively are formed in the undersides of the first and second square recess portions 61a and 61b. These first and second spherical recess portions 63a and 63b are shaped into a spherical shape. Consequently, first and second step surfaces 65a and 65b as substantially annular steps are formed between the first and second square recess portions 61a and 61b and the first and second spherical recess portions 63a and 63b.

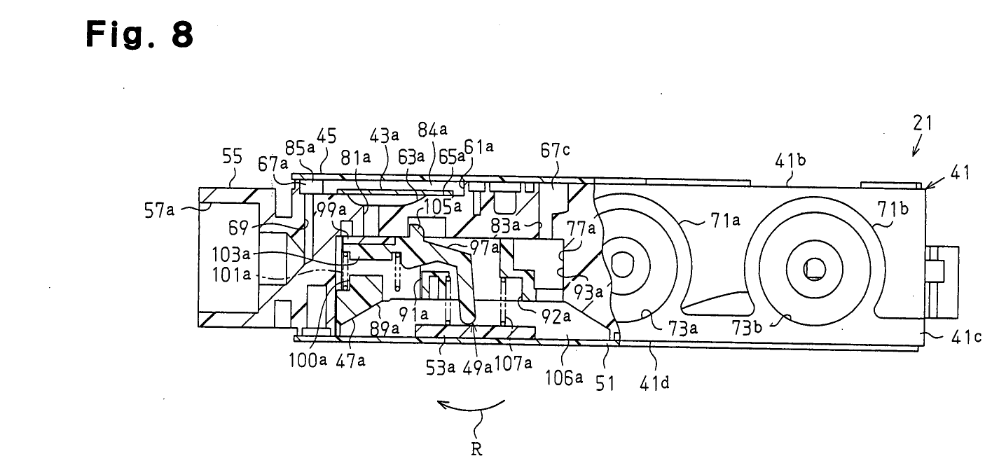

Further, as shown in FIGS. 4 and 6, the flow path forming member 41 is provided with first to third grooves 67a to 67c in its first side surface 41b. The first groove 67a has one end connected with the first square recess portion 61a. Further, as shown in FIG. 8, the first groove 67a has its other end connected with the first ink introduction hole 57a through a communication hole 69 formed within the flow path forming member 41.

Further, as shown in FIGS. 4 and 6, the second groove 67b has one end connected with the second square recess portion 61b. Further, the second groove 67b, similarly to the first groove 67a, has its other end connected with the second ink introduction hole 57b through the communication hole (not shown) formed within the flow path forming member 41. The third groove 67c is provided in the vicinity of the second square recess portion 61b and the second groove 67b.

As shown in FIGS. 4 and 8, the flow path forming member 41 comprises first and second ink discharge portions 71a and 71b in its under surface 41c. These first and second ink discharge portions 71a and 71b are formed in a cylindrical shape, respectively, and comprise first and second ink discharge holes 73a and 73b. The first ink discharge hole 73a communicates with the third groove 67c.

The first and second ink discharge holes 73a and 73b are connected to the nozzles provided in the recording head 20 (see FIG. 1) for each ink color. Consequently, the ink discharged from the first and second ink discharge holes 73a and 73b is guided to the recording head 20 for each color, and is ejected from the nozzle.

In the meantime, as shown in FIG. 7, the flow path forming member 41 is provided with first and second circular recess portions 75a and 75b in its second side surface 41d. The first and second circular recess portions 75a and 75b comprise the first and second engaging recess portions 77a and 77b and the first and second non-engaging recess portions 79a and 79b, respectively.

The first and second engaging recess portions 77a and 77b are formed in such a manner as to be semicircular in cross-section, and the undersides thereof are flat, respectively. In the meantime, the first and second non-engaging recess portions 79a and 79b are similarly formed in such a manner as to be semicircular in cross-section, but are formed shallower than the first and second engaging recess portions 77a and 77b. The first and second non-engaging recess portions 79a and 79b are formed in such a manner as to be substantially spherical on the undersides thereof.

As shown in FIG. 8, the first engaging recess portion 77a communicates with the first spherical recess portion 63a through the communication hole 81a. Further the second engaging recess portion 77b also communicates with the second spherical recess portion 63b through the communication hole 81b (see FIG. 6).

Further, the first engaging recess portion 77a communicates with the third groove 67c through the communication hole 83c. Consequently, the first engaging recess portion 77a communicates with the first ink discharge hole 73a (see FIG. 4) through the third groove 67c. Further, as shown in FIG. 7, the second engaging recess portion 77b is provided with the communication hole 83b, and this communication hole 83b communicates with the second ink discharge hole 73b (see FIG. 4).

As shown in FIGS. 4 and 6 to 8, the first and second filters 43a and 43b are formed in a substantially square slice shape. The first and second filters 43a and 43b are attached to the first and second step surfaces 65a and 65b (see FIG. 6) in such a manner as to divide between the first and second square recess portions 61a and 61b and the first and second spherical recess portions 63a and 63b.

The first film member 45, in the present embodiment, is formed by a flexible member, which has a substantially rectangular shape and has a high gas barrier property, and is hot-welded to the first side surface 41b of the flow path forming member 41. At this time, with the openings of the first and second square recess portions 61a and 61b and the first to third grooves 67a to 67c sealed by the first film member 45, the first film member 45 is hot-welded to the flow path forming member 41.

In this way, as shown in FIGS. 4 and 8, the first film member 45, the first square recess portion 61a of the flow path forming member 41, and the first spherical recess portion 63a form a first ink introduction chamber 84a. Similarly, the first film member 45, the second square recess portion 61b, and the second spherical recess portion 63b form a second ink introduction chamber 84b.

This first film member 45 is allowed to bend by the pressure difference between the inside and the outside of the first and second ink introduction chambers 84a and 84b. That is, the first film member 45 is flexed in a direction to reduce the volume of the first and second ink introduction chambers 84a and 84b when the pressure inside the first and second ink introduction chambers 84a and 84b is reduced to lower than a predetermined pressure. As a result, the first film member 45 abuts against the first and second filters 43a and 43b within the first and second ink introduction chambers 84a and 84b, so that the flow of the ink passing through the first and second filers 43a and 43b is blocked. The first film member 45 if flexed by the pressure difference between the inside and the outside of the first and second ink introduction chambers 84a and 84b may be changed to a material other than the film member.

Further, as shown in FIG. 4, a first flow path 85a is formed by the first film member 45 and the first groove 67a of the flow path forming member 41, and a second flow path 85b by the first film member 45 and the second groove 67b, and a third flow path 85c by the first film member 45 and the third groove 67c.

As shown in FIGS. 5 to 7, the first and second fitting members 47a and 47b are formed in a substantially semicircular shape, and are fitted in the first and second engaging recess portions 77a and 77b of the flow path forming member 41, respectively. As shown in FIGS. 5 and 8, first and second consecutive large spherical recess portions 89a and 89b are formed by the first and second fitting members 47a and 47b and the first and second non-engaging recess portions 79a and 79b.

Further, as shown in FIGS. 5 to 8, the first and second fitting members 47a and 47b are provided with the communication holes 81a and 81b formed in the flow path forming member 41, and first and second ink inflow holes 91a and 91b allowing the first and second large recess portions 89a and 89b to be connected, respectively. Further, the first and second fitting members 47a and 47b are provided with the first and second large recess portions 89a and 89b and the first and second ink flow holes 93a and 93b allowing the first and second large recess portions 89a and 89b and the communication holes 83a and 83b to be connected, respectively.

The first and second fitting members 47a and 47b are provided with first and second substantially cylindrical projecting portions 100a and 100b at a position opposing the communication holes 81a and 81b, respectively. Furthermore, the first and second fitting members 47a and 47b are provided with the first and second central holes 92a and 92b communicating with the first and second ink inflow holes 91a and 91b in respective central portions.

The valve unit 21 in the present embodiment is mounted on the carriage 15 (see FIG. 1) with the upper surface 41e shown in FIG. 4 positioned at the upper most portion of a vertical direction. The first and second ink inflow holes 91a and 91b and the first and second ink outflow holes 93a and 94b are provided in such a manner as to be connected with the central portions in a substantially vertical direction of the first and second large recess portions 89a and 89b relative to the first and second fitting members 47a and 47b, respectively.

As shown in FIGS. 6 to 8, the first and second valve members 49a and 49b comprise first and second valve member main bodies 97a and 97b, first and second adhering portions 99a and 99b, and first and second valve biasing springs 101a and 11b. The first and second valve member main bodies 97a and 97b are substantially L-shaped, and disc portions 103a and 103b are formed in the first ends thereof. Support shafts 105a and 105b are formed in the vicinity of the disc portions 103a and 103b.

As shown in FIG. 8, the first and second valve member main bodies 97a and 97b are rotatably supported for the first and second fitting members 47a and 47b through the support shafts 105a and 105b. At this time, the disc portions 103a and 103b of the first and second valve member main bodies 97a and 97b confront the communication holes 81a and 81b. Further, the second ends of the first and second valve member main bodies 97a and 97b penetrate the first and second central holes 92a and 92b of the first and second fitting members 47a and 47b.

As shown in FIGS. 6 to 8, the first and second adhering portions 99a and 99b are formed in a disc shape by the flexible member, and are fixed in such a manner as to be superposed on the surfaces at the side of the communication holes 81a and 81b of the disc portions 103a and 103b in the first and second valve member main bodies 97a and 97b.

The first and second valve biasing springs 101a and 101b have respective one ends thereof engagingly fixed from the outside on the first and second projecting portions 100a and 100b of the first and second fitting members 47a and 47b, and have the other ends thereof fixed on the disc portions 103a and 103b of the first and second valve member main bodies 97a and 97b. Consequently, the first and second valve member main bodies 97a and 97b are biased by the first and second valve biasing springs 101a and 101b in a direction of the arrow R shown in FIG. 8 with the support shafts 105a and 105b as rotational centers. The first and second valve member main bodies 97a and 97b when in a state of no force being applied from the outside are biased in the direction of the arrow mark R shown in FIG. 8, and the first and second adhering portions 99a and 99b abut against the communication holes 81a and 81b. Further, when a force is applied to the first and second valve member main bodies 97a and 97b in a direction opposite to the direction of the arrow R shown in FIG. 8, the first and second adhering portions 99a and 99b are isolated from the communication holes 81a and 81b. That is, when the force is not applied to the first and second valve member main bodies 97a and 97b or the force is applied in a direction opposite to the direction of the arrow R, a space between the communication holes 81a and 81b and the first and second ink inflow holes 91a and 91b is switched so as to be in a communication or a non-communication state.

As shown in FIGS. 5 to 8, the second film member 51 is formed almost in the same shape and by the same material as that of the first film member 45, and is hot-welded to the second side surface 41d of the flow path forming member 41. At this time, with the openings of the first and second large recess-portions 89a and 89b sealed by the second film member 51, the first film member 45 is hot-welded to the flow path forming member 41. By so doing, as shown in FIGS. 5 and 8, the first and second pressure chambers 106a and 106b are formed by the second film member 51 and the first and second large recess portions 89a and 89b.

That is, as shown in FIGS. 4 to 8, in the valve unit 21, the ink flowed into the first ink introduction hole 57a flows into the first pressure chamber 106a through the communication hole 69, the first flow path 85a, the first ink introduction chamber 84a, the communication hole 81a, the first ink inflow hole 91a, and the first central hole 92a. Further, the ink flowed into the first pressure chamber 106a is supplied to the recording head 20 (see FIG. 1) through the first ink outflow hole 93a, the communication hole 83a, the third flow path 85c, and the first ink discharge hole 73a.

Similarly, the ink flowing into the second ink introduction hole 57b from the ink supply tube 35 flows into the second pressure chamber 106b through the communication hole, the second flow path 85b, the second ink introduction chamber 84b, the communication hole 81b, the second ink inflow hole 91b, and the second central hole 92b. The ink flowed into the second pressure chamber 106b is supplied to the recording head 20 through the second ink outflow hole 93b, the communication hole 83b, and the second ink discharge hole 73b. In the present embodiment, each flow path from these first and second ink introduction holes 57a and 57b to the recording head 20 constitute the liquid supply path.

The second film member 51 is allowed to bend by the pressure difference between the inside and the outside of the first and second pressure chambers 106a and 106b. That is, the second film member 51 is flexed in such a direction to reduce the volume of the first and second pressure chambers 106a and 106b when the pressure within the first and second pressure chambers 106a and 106b is reduced lower than the predetermined pressure.

The first and second pressure receiving plates 53a and 53b are formed in a disc shape, and as shown in FIGS. 5 and 8, are fixed to the second film member 51 so as to be positioned within the first and second pressure chambers 106a and 106b, respectively.

As shown in FIGS. 6 to 8, first and second pressure receiving springs 107a and 107b are located between the first and second pressure receiving plates 53a and 53b and the first and second large recess portions 89a and 89b. These first and second pressure receiving springs 107a and 107b bias the first and second pressure receiving plates 53a and 53b so as to be isolated from the first and second large recess portions 89a and 89b. Consequently, in a state of the external force being not applied, the first and second pressure receiving plates 53a and 53b are in a state of being isolated from the first and second large recess portions 89a and 89b.

The first and second pressure receiving plates 53a and 53b abut against the second ends of the first and second valve member main bodies 97a and 97b. When the first and second pressure receiving plates 53a and 53b move to approach the first and second large recess portions 89a and 89b against biasing forces of the first and second pressure receiving springs 107a and 107b, the first and second valve member main bodies 97a and 97b receive a force to rotate in a direction opposite to the direction of the arrow R shown in FIG. 8.

That is, when the pressure within the first and second pressure chambers 106a and 106b is reduced so that the second film member 51 is flexed, the first and second pressure receiving plates 53a and 53b move to approach the first and second large recess portions 89a and 89b against the biasing force of the first and second pressure receiving springs 107a and 107b. Then, the first and second valve member main bodies 97a and 97b rotate in the direction opposite to the direction of the arrow R shown in FIG. 8, and a communication state is established between the communication holes 81a and 81b and the first and second ink inflow holes 91a and 91b. Further, when the pressure within the first and second pressure chambers 106a and 106b is increased, the first and second pressure receiving plates 53a and 53b move so as to be isolated from the first and second large recess portions 89a and 89b, and a non-communication state is established between the communication holes 81a and 81b and the first and second ink inflow holes 91a and 91b.

Next, the electrical constitution for the ink jet recording apparatus 11 as constituted above will be described.

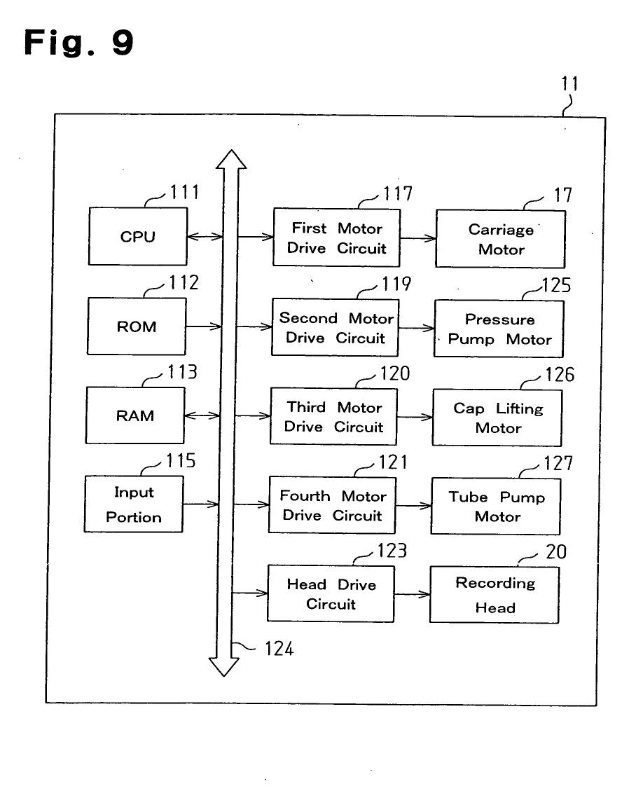

As shown in FIG. 9, the ink jet recording apparatus 11 comprises a CPU 111, a ROM 112, and a RAM 113. Further, the ink jet recording apparatus 11 comprises an input portion 115, a first motor drive circuit 117, a second motor drive circuit 119, a third motor drive circuit 120, a fourth motor drive circuit 121, and a head drive circuit 123. These are mutually connected through a bus 124.

The CPU 111 receives an ON signal from the input portion 115. In the present embodiment, the input portion 115 is provided in the main body case 12 and the like of the ink jet recording apparatus 11, and is constituted such that the ON signal is inputted to the CPU 111 by the operation of a user. The CPU 111 is connected to the carriage motor 17 through the first motor drive circuit 117, and outputs a drive control signal for drive control to the carriage motor 17.

Further, the CPU 111 is connected to a pressure pump motor 125 through the second motor drive circuit 119, and outputs a drive control signal for driving the pressure pump motor 125. The pressure pump motor 125 is connected to the pressure pump 25 so as to be able to transmit power to the pressure pump 25. In the present embodiment, the pressure pump motor 125 is rotated in the normal direction so that pressurized air is delivered from the pressure pump 25. Further, the stopping of the drive of the pressure pump motor 125 stops the delivery of the pressurized air from the pressure pump 25.

Further, the CPU 111 is connected to a cap lifting motor 126 through the third motor drive circuit 120, and outputs a drive control signal for reciprocally rotating the cap lifting motor 126. The cap lifting motor 126 is connected to the cap 26a so as to be able to transmit the power. In the present embodiment, the cap lifting motor 126 is rotated in the normal direction so that the cap 26a is lifted. Further, the cap lifting motor 126 is rotated in the reverse direction so that the cap 26a is lowered.

Further, the CPU 111 is connected to a tube pump motor 127 through the fourth motor drive circuit 121, and outputs a drive control signal for reciprocally rotating the tube pump motor 127. The tube pump motor 127 is connected so as to be able to transmit the power to the tube pump 26e. In the present embodiment, the tube pump motor 127 is rotated in the normal direction so that negative pressure is formed within the cap 26a by the tube pump 26e. Further, by stopping the driving of the tube pump motor 127, the suction operation in the tube pump 26e is stopped.

Furthermore, the CPU 111 is connected to the recording head 20 through the head drive circuit 123, and outputs a nozzle drive signal to an unillustrated nozzle drive body for ejecting the ink from the nozzle provided in the recording head 20.

The CPU 111 operates according to various programs stored in the ROM 112, and temporarily stores an arithmetic processing result and the like in the RAM 113. To describe in more detail, the ROM 112 comprises a choke cleaning program and other programs.

A choke cleaning program is a program, which drives the carriage motor 17 through the first motor drive circuit 117 and moves the carriage 15 to a home position when the CPU 111 receives an ON signal from the input portion 115. Further, when the CPU 111 receives the ON signal from the input portion 115 based on the choke cleaning program, the pressure pump motor 125 is stopped through the second motor drive circuit 119 so as not to deliver the pressurized air from the pressure pump 25.

Further, when the carriage 15 moves to the home position based on the choke cleaning program, the CPU 111 drives the cap lifting motor 126 through the third motor drive circuit 120, and lifts the cap 26a so as to seal the nozzle surface of the recording head 20. Furthermore, when, based on the choke cleaning program, the cap 26a is lifted, the CPU 111 drives the tube pump motor 127 through the fourth motor drive circuit 121, and forms the negative pressure within the cap 26a by the suction operation of the tube pump 26e.

In addition, when, based on the choke cleaning program, a predetermined time elapses from the driving of the tube pump motor 127, the CPU 111 drives the pressure pump motor 125 through the second motor drive circuit 119, and starts the delivery of the pressurized air from the pressure pump 25.

That is, when the CPU 111 receives the ON signal from the input portion 115, first, according to a choke cleaning program, it outputs a drive signal to the carriage motor 17, and moves the carriage 15 to the home position. Further, the CPU 111 stops the pressure pump motor 125 based on the ON signal from the input portion 115, and stops the delivery of the pressurized air from the pressure pump 25.

Subsequently, the CPU 111 drives the cap lifting motor 126 according to the choke cleaning program, and lifts the cap 26a so as to seal the nozzle surface of the recording head 20. The CPU 111 drives the tube pump motor 127, and forms negative pressure within the cap 26a by the suction operation of the tube pump 26c.

Further, the CPU 111 measures the driving time of the tube pump motor 127 according to the choke cleaning program, and when a predetermined time elapses, it drives the pressure pump motor 125, and starts the delivery of the pressurized air from the pressure pump 25.

Next, the operation of the ink jet recording apparatus 11 constituted as described above will be described.

First, the operation of the ink jet recording apparatus 11 at the time of normal printing will be described. At the time of normal printing, the ink is in a state of filling from the ink pack 32 to the recording head 20 for each color. The pressure pump motor 125 is in a state of being driven through the second motor drive circuit 119 by the CPU 111, and the ink within the ink pack 32 is maintained in a pressurized state by the pressurized air introduced into the gap 33 of the ink cartridge 23. Consequently, during printing, the ink is in a state of being supplied in a pressurized state from the ink cartridge 23 to the valve unit 21.

The valve unit 21 is supplied with the ink introduced in a pressurized state from the ink pack 32 for each color. As shown in FIG. 8, for example, the ink supplied to the first ink introduction chamber 84a through the first ink introduction hole 57a is maintained in a state of having a high pressure. Consequently, the first film member 45 of the valve unit 21 is maintained in a state of not being flexed. As a result, the ink supplied within the first ink introduction hole 57a is in a state capable of passing through the first filter 43a.

In this state, when printing is started based on image data, ejection of ink is performed from the recording head 20, and according to the ejection amount of the ink, the ink within the first pressure chamber 106a of the valve unit 21 is supplied to the recording head 20 through the first ink discharge hole 73a and the like. As a result, the ink within the first pressure chamber 106a is reduced, and the pressure within the first pressure chamber 106a is reduced.

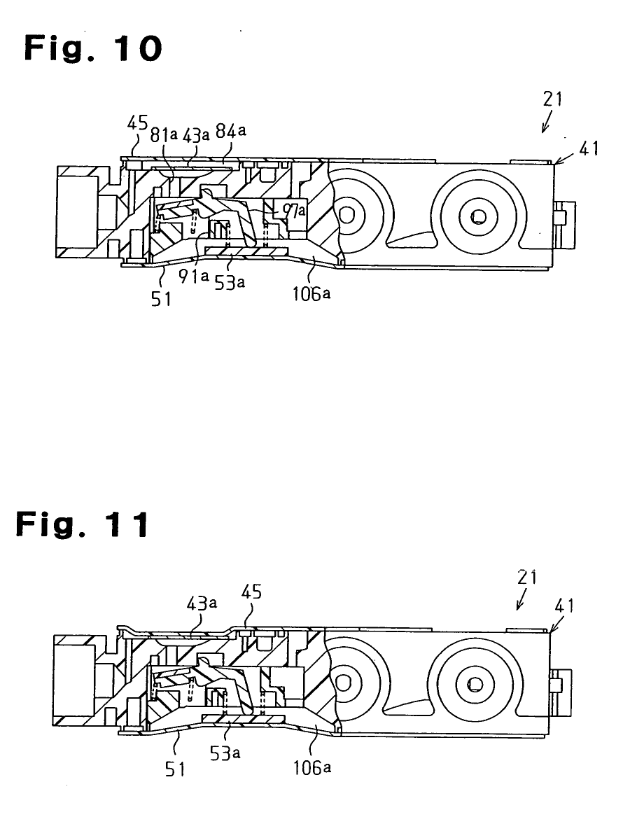

When the pressure of the ink within the first pressure chamber 106a is reduced lower than the predetermined pressure, as shown in FIG. 10, the second film member 51 is flexed in a direction to reduce the volume within the first pressure chamber 106a. As a result, the first valve member main body 97a is rotated by the first pressure receiving plate 53a, and a communication state is established between the communication hole 81a and the first ink inflow hole 91a. The ink stored in a pressurized state within the first ink introduction chamber 84a flows within the first pressure chamber 106a, and the ink is caused to fill the first pressure chamber 106a.

When the ink within the first ink introduction chamber 84a flows within the first pressure chamber 106a, the ink passes through the first filter 43a. At this time, since the first filter 43a has a structure difficult for the air to penetrate, the bubbles and impurities mixed in the ink are almost all in a trapped state within the first ink introduction chamber 84a.

Further, when the ink flows within the first pressure chamber 106a, the ink pressure within the first pressure chamber 106a is increased. As a result, the flexing of the second film member 51 is eliminated, and the first valve member main body 97a rotates toward the original position, and a non-communication state is established again between the communication hole 81a and the first ink inflow hole 91a.

That is, when the ink within the first pressure chamber 106a is reduced, and the inner pressure decreases to below the predetermined value, a communication state is established between the communication hole 81a and the first ink inflow hole 91a, and the ink is supplied to the first pressure chamber 106a. Further, the ink is supplied to the first pressure chamber 106a, so that the pressure of the ink within the first pressure chamber 106a is increased, and when it becomes equal to or more than the predetermined value, a non-communication state is established between the communication hole 81a and the first ink inflow hole 91a, and the supply of the ink to the first pressure chamber 106a is stopped.

As a result, during printing, the ink adjusted to have a pressure value within a predetermined range is in an accumulated state within the first pressure chamber 106a, and stability of the ink supply to the recording head 20 is secured.

With respect to the ink supplied to the second ink introduction chamber 84b through the second ink introduction hole 57b, similarly to the ink supplied to the first ink introduction chamber 84a, it is adjusted to fall within the predetermined range of the pressure in the second pressure chamber 106b, and is supplied to the recording head 20 in a stable state.

Next, the operation of the ink jet recording apparatus 11 at the choke cleaning will be described. In the present embodiment, the input portion 115 (see FIG. 9) is operated by the user, so that the choke cleaning is performed. When the input portion 115 is operated by the user, and an ON signal is inputted to the CPU 111, the CPU 111 first drives the carriage motor 17 so as to move the carriage 15 to the home position according to a choke cleaning program.

Further, the CPU 111 advances to a pressure reducing step, and stops the pressure pump motor 125 so as not to allow the pressurized air to be delivered from the pressure pump 25. As a result, the ink is supplied in a non-pressurized state from the ink cartridge 23 to the valve unit 21. Subsequently, the CPU 111 advances to a capping step, and drives the cap lifting motor 126 so as to lift the cap 26a and seal the nozzle surface of the recording head 20. When the CPU 111 lifts the cap 26a, it advances to a drawing step, and drives the tube pump motor 127, and forms negative pressure within the cap 26a.

As a result, the ink is drawn through the recording head 20, and the ink within the first and second pressure chambers 106a and 106b of the valve unit 21 begin to be reduced. In FIG. 11 an ink reduced state is shown in the first pressure chamber 106a, and with respect to the second pressure chamber 106b, since it is similar to the first pressure chamber 106a, the illustration thereof is omitted. As shown in FIG. 11, when the pressure within the first and second pressure chambers 106a and 106b decrease to below the predetermined pressure, similarly to the printing time, the second film member 51, the first and second valve member main bodies 97a and 97b and the like begin to operate, and a communication state is established between the communication holes 81a and 81b and the first and second ink inflow holes 91a and 91b.

As a result, the ink within the first and second ink introduction chambers 84a and 84b is allowed to flow into the first and second pressure chambers 106a and 106b. However, at this choke cleaning, as described above, the ink from the ink cartridge 23 is supplied in a non-pressurized state within the first and second ink introduction chambers 84a and 84b. Consequently, the pressure within the first and second ink introduction chambers 84a and 84b begin to be reduced as a communication state is established between the communication holes 81a and 81b and the first and second ink inflow holes 91a and 91b.

When the pressure within the first and second ink introduction chambers 84a and 84b is reduced lower than the predetermined pressure, the first film member 45 is flexed, and the first film member 45 abuts against the first and the second filters 43a and 43b. As a result, the ink flow passing through the first and second filters 43a and 43b is blocked.

In this state, by allowing the suction operation to be still continued by the tube pump 26e, with the first and second ink introduction chambers 84a and 84b as a boundary, the negative pressure is accumulated in the downstream side thereof. The CPU 111 measures the driving time of the tube pump motor 127 according to the choke cleaning program, and when the predetermined time elapses, it advances to a pressure increasing step, and starts the driving of the pressure pump motor 125. The CPU 111 completes the processing of the choke cleaning program when the driving of the pressure pump motor 125 is started.

As a result, the delivery of the pressurized air from the pressure pump 25 is started, and the ink is supplied in a pressurized state from the ink cartridge 23 to the valve unit 21. Then, the ink is supplied to the first and second ink introduction chambers 84a and 84b in the valve unit 21, and the bending of the first film member 45 is eliminated. In this way, the first film member 45 is isolated from the first and second filters 43a and 43b, and the flow of the ink passing through the first and second filters 43a and 43b is allowed.

The ink flows instantly from the upstream side to eliminate the negative pressure accumulated in the section downstream of the first and second ink introduction chambers 84a and 84b, and the ink flow speeds up instantaneously and begins to flow. As a result, the bubbles and impurities stagnated in the section downstream of the first and second ink introduction chambers 84a and 84b are discharged instantly together with the ink from the nozzle of the recording head 20. As a result, the filling factor for the ink in the ink jet recording apparatus 11 is enhanced.

According to the first embodiment, the following effect is obtained.

(1) In the first embodiment, the ink jet recording apparatus 11 comprises the pressure pump 25 and the like, and becomes an apparatus of an air pressurized system for pressure-transferring the ink toward the recording head 20 by introducing the pressurized air into the ink cartridge 23 from the pressure pump 25. The first and second ink introduction chambers 84a and 84b formed in the valve unit 21 are provided in the ink flow path between the ink cartridge 23 and the recording head 20. The first and second ink introduction chambers 84a and 84b have a part of wall surfaces thereof formed by the first film member 45 which is flexed by the difference between the pressure of the ink of the inside thereof and the atmospheric pressure.

Consequently, according to the present embodiment, in a state of the nozzle of the recording head 20 being covered by the cap 26a, the driving of the pressure pump 25 is stopped, so that the pressure of the fluid within the ink supply tube 35 is reduced. In the present embodiment and each of the embodiments to be described later, various types of fluid such as an ink, an ink solvent, a water vapor, and the air are included as the fluid. In this state, by performing the suction operation of the tube pump 26c, the pressure of the fluid within the valve unit 21 and the ink supply tube 35 is totally reduced. In this way, the pressure within the first and second ink introduction chambers 84a and 84b is reduced lower than the predetermined pressure, and the first film member 45 is flexed inside.

As a result, the first film member 45 abuts against the first and second filters 43a and 43b, and the ink flow passing through the first and second filters 43a and 43b is blocked. In this state, by allowing the suction operation to be continued by the tube pump 26e, the negative pressure is accumulated in the section downstream of the abutting portion between the first film member 45 and the first and second filters 43a and 43b. Further, in a state of negative pressure being accumulated, the driving of the pressure pump 25 is started, so that the flexing of the first film member 45 is restored, and the accumulated negative pressure is eliminated instantly. As a result, the bubbles and impurities stagnated in the section downstream of the first and second ink introduction chambers 84a and 84b is discharged together with the ink instantly from the nozzle of the recording head 20, and the choke cleaning is performed. As a result, the filling factor of the ink in the ink jet recording apparatus 11 is enhanced.

In the present embodiment, it is not the driving of the choke valve to open and close by an actuator, but the driving of the pressure pump 25 usually provided for a pressure supply system apparatus that performs the choke cleaning. Consequently, the choke cleaning is performed by a simple control without increasing the size of the apparatus by a new choke valve and the like.

(2) In the first embodiment, the first and second ink introduction chambers 84a and 84b comprise the first and second square recess portions 61a and 61b and the first and second spherical recess portions 63a and 63b. The first and second step surfaces 65a and 65b are formed between these first and second square recess portions 61a and 61b and first and second spherical recess portions 63a and 63b. Further, the first film member 45 is provided so as to confront these first and second step surfaces 65a and 65b.

Consequently, when the pressure within the first and second ink introduction chambers 84a and 84b is lowered, and the first film member 45 is flexed, the first film member 45 moves in a direction to abut against the first and second step surfaces 65a and 65b. As a result, responsibility for increase and decrease of a flow path resistance for the increase and decrease of the pressure within the first and second ink introduction chambers 84a and 84b is made more reliably, thereby performing the choke cleaning more reliably.

(3) In the first embodiment, the first and second step surfaces 65a and 65b are positioned in the section downstream of the first film member 45. Consequently, when the choke cleaning is performed, a drawing force toward the downstream side is applied to the first film member 45, but at this time, the first film member 45 more reliably approaches the first and second step surfaces 65a and 65b. As a result, compared to the case where the first film member 45 is positioned at the upstream side of the first and second step surfaces 65a and 65b, the first film member 45 is allowed to approach the first and second step surfaces 65a and 65b more reliably. As a result, the choke cleaning is more reliably performed.

(4) In the first embodiment, the first and second ink introduction chambers 84a and 84b are provided integrally with the valve unit 21 comprising the first and second pressure chambers 106a and 106b and the first and second valve members 49a and 49b. Consequently, one valve unit 21 is allowed to have both the function to secure the stability of the ink supply to the recording head 20 during printing and the function to reliably perform the choke cleaning. As a result, the structure of the ink jet recording apparatus 11 is simplified.

(5) In the first embodiment, the first and second step surfaces 65a and 65b of the first and second ink introduction chambers 84a and 84b are provided with the first and second filters 43a and 43b. These first and second filters 43a and 43b are provided so as to confront the first film member 45.

Consequently, the bubbles and impurities contained in the ink supplied from the ink cartridge 23 to the recording head 20 are trapped in the first and second filters 43a and 43b. As a result, when the ink is ejected toward the recording medium from the recording head 20, the bubbles and impurities ejected from the nozzle are reduced, and printing of high quality is performed.

When the choke cleaning is performed, since the first film member 45 bends in a direction to abut against the first and second filters 43a and 43b, the bubbles and impurities trapped in the first and second filters 43a and 43b are pressed, and are allowed to pass through the first and second filters 43a and 43b. Consequently, at the choke cleaning, the bubbles and impurities trapped are discharged more reliably, and the filling factor for the ink between the ink cartridge 23 and the recording head 20 is more effectively enhanced.

(Second Embodiment)

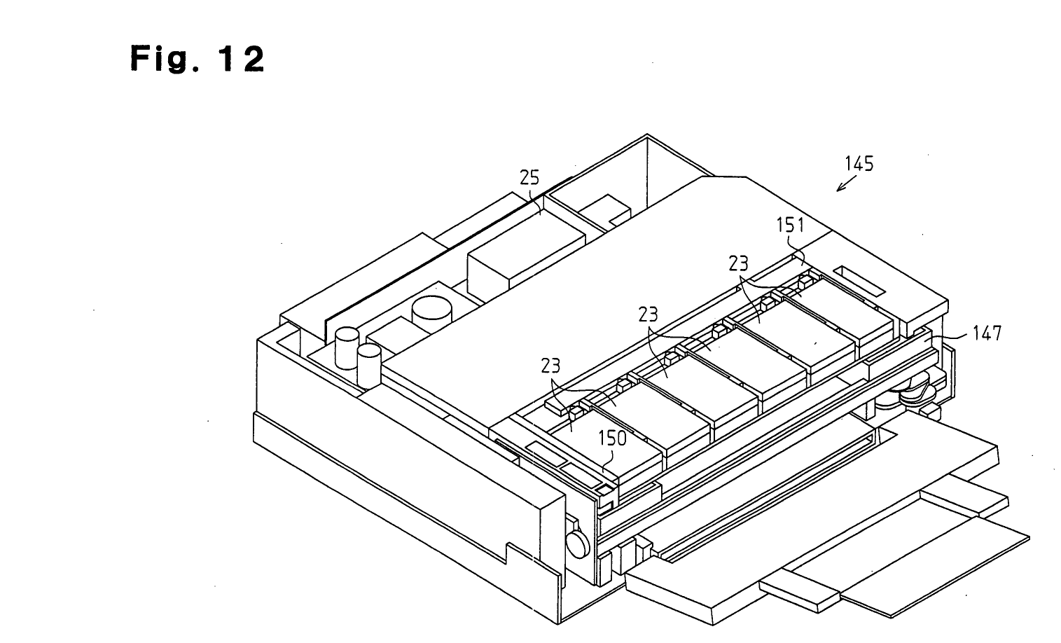

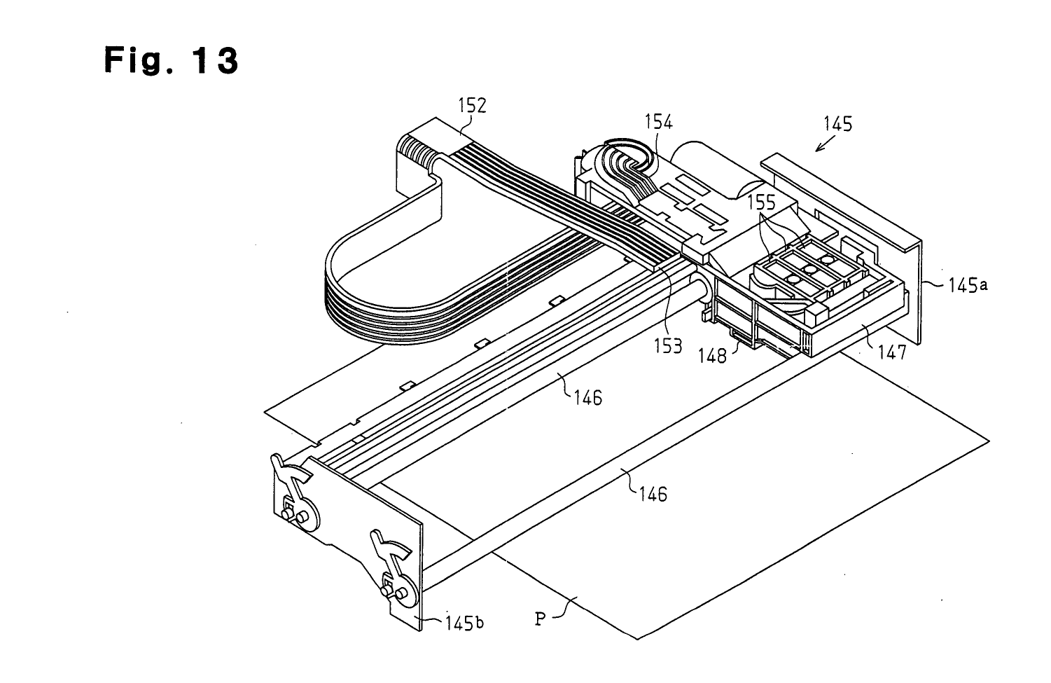

Next, a second embodiment according to the present invention will be described according to FIGS. 12 to 18. Since the second embodiment is a constitution in which the valve unit alone of the first embodiment is changed, the detailed description of the components that are the same as those in the first embodiment will be omitted. FIG. 12 is a perspective view of an ink jet recording apparatus 145 as a liquid ejection apparatus, and FIG. 13 is an essential part perspective view of the ink jet recording apparatus 145.

As shown in FIG. 13, the ink jet recording apparatus 145 is provided with mutually opposing frame plates 145a and 145b at both sides thereof, and a guide shaft 146 is installed between the frame plates 145a and 145b. A carriage 147 is interposed relatively movable for a guide shaft 146, and is reciprocally movable in a main scanning direction by a carriage motor 17 (see FIG. 9). A recording medium P as a target is conveyed below a guide shaft 146 by an unillustrated paper feeding means, and is delivered in a secondary scanning direction. Further, the carriage 147 is provided with a recording head 148 as a liquid ejection head, and three pieces of valve unit 155. In the present embodiment, the recording head 148 is formed with a plurality of nozzle ejection orifices for ejecting six types of ink, respectively.

An ink cartridge 23 as liquid reservoir means and a liquid cartridge in which the ink supplied to the recording head 148 is accumulated, as shown in FIG. 12, are mounted by being lined up in a row above the carriage 147. At this time, each ink cartridge 23 is detachably accommodated into a holder 150 installed in the ink jet recording apparatus 145, respectively. The air delivered from a pressure pump 25 (see FIG. 1) constituting the pressure adjusting means is introduced to the communication hole (not shown) formed in an ink case 31 through a flow concentration path 151 which constitutes a liquid supply path mounted on the holder 150. The air introduced through the communication hole flows into a gap 33 (see FIG. 2) within the ink case 31.

The ink led out by crushing an ink pack 32 by air flow into the gap 33 flows into the flow concentration path 151 through an ink discharge port 32c (see FIG. 2) as a liquid lead out port. In this flow concentration path 151, to be described later, there are formed an air flow path and a plurality of ink flow paths, and the air flow path has one end connected to the pressure pump 25 and the other end connected to the gap 33 of each ink cartridge 23. Further, each ink flow path has one end connected to each cartridge 23, and at the same time, it has the other end connected to an ink supply tube 152, which constitutes the liquid supply path.

As shown in FIG. 13, the ink supply tube 152 comprises a flexible member, and at the same time, it is formed in a band shape, and comprises the same number of ink flow paths as that of the ink cartridge 23. The ink supply tube 152 is pulled around within the ink jet recording apparatus 145, and has an upstream side end portion 153 thereof connected to the flow concentration path 151, and has a downstream side 154 thereof connected to the carriage 147. A downstream side end portion 154 communicates with each valve unit 155 mounted on the carriage 147. The ink delivered from the ink cartridge 23 to a valve unit 155 through the flow concentration path 151 and the ink supply tube 152 is led out to the recording head 148 from the valve unit 155.

(Flow Concentration Path)

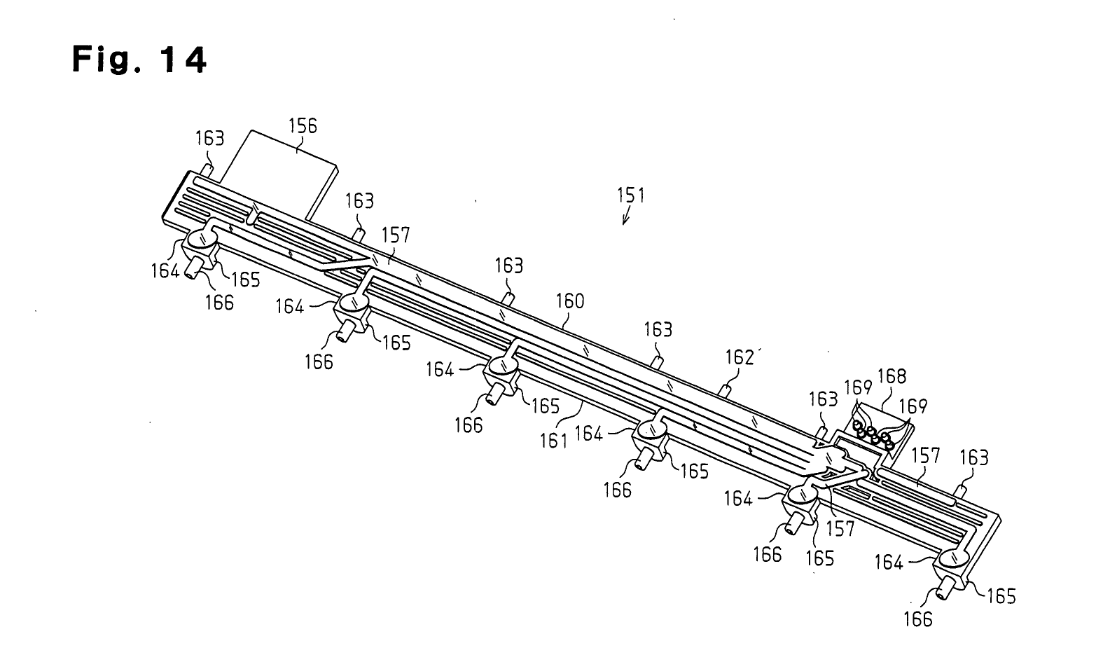

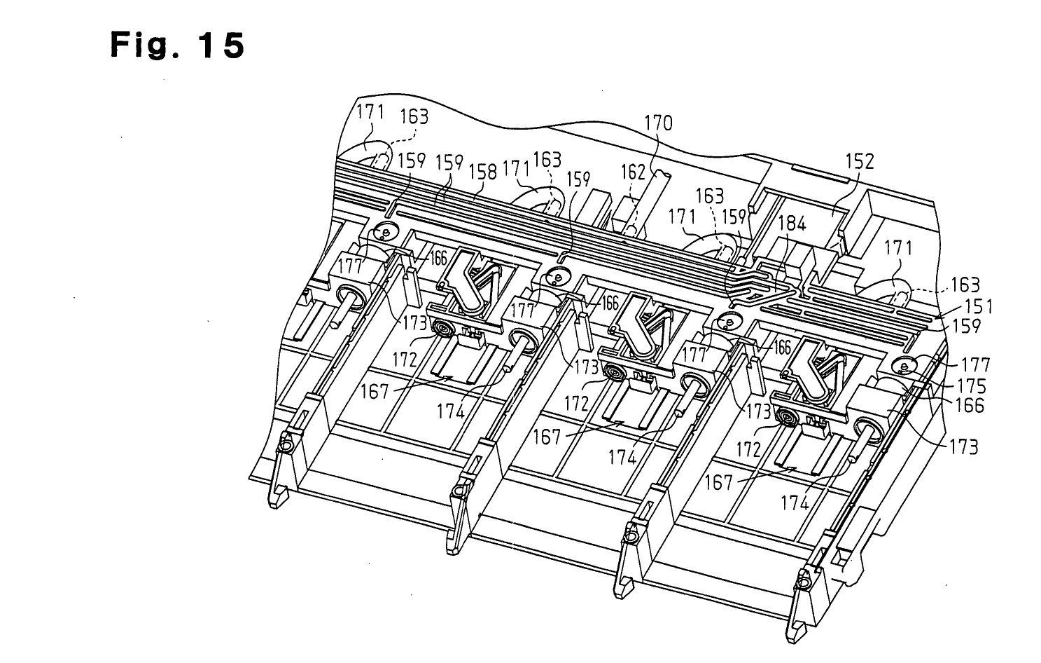

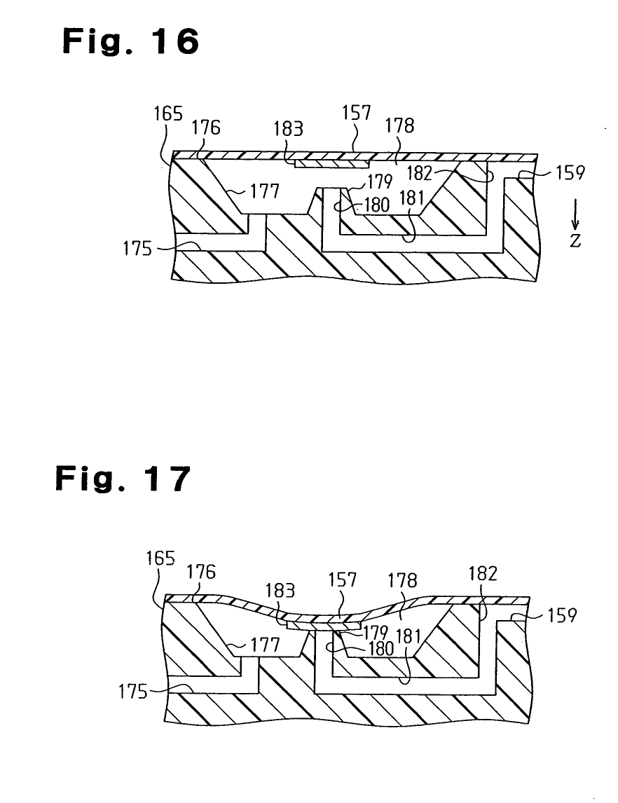

Next, the flow concentration path 151 will be described in detail. FIG. 14 is a perspective view of the flow concentration path 151, and FIG. 15 is a perspective view of an essential part of the flow concentration path 151 of the ink jet recording apparatus 145. FIGS. 16 and 17 are cross-sectional views of an essential part of the flow concentration path 151.

As shown in FIG. 14, the flow concentration path 151 comprises a main body 156, and a film 157 as a flexible member hot-welded to the main body 156. The main body 156 comprises a thermoplastic resin, and as shown in FIG. 15, it is formed by a section of an air groove 158 constituting pressure adjusting means and six sections of ink grooves 159 aligned along a longitudinal direction. FIG. 15 shows the main body 156 in a state with the film 157 not being attached. The film 157 is capable of being hot-welded to the main body 156, and is formed of a flexible member having a high gas barrier property.

The air groove 158 and the ink groove 159 have the upper surfaces thereof opened, and have the openings thereof sealed by the film 157 hot-welded to the main body 156. The air flow path is formed by the attached film 157 and the air groove 158, and the ink flow path is formed by the film 157 and each ink groove 159.

Further, in the flow concentration path 151, as shown in FIG. 14, there are formed a section of a pump connecting portion 162 and six sections of air lead out portions 163 in the first side surface 160. The pump connecting portion 162 and the air lead out portion 163 protruded from a first side surface 160 of the main body 156, and are formed in a cylindrical shape. Unillustrated holes formed within the pump connecting portions 162 and the air lead out portion 163 communicate with the air groove 158. Further, six pieces of an ink introduction portion 164 as connecting portions are formed in a second side surface 162 of the flow concentration path 151. An ink introduction portion 164 is provided with a protruding portion 165, which protrudes from the second side surface 161 of the main body 156 and has a substantially L-shaped cross section, and an interposal portion 166, which protrudes from the protruding portion 165 and is formed in a cylindrical shape. The interposal portion 166 is interposed into the connecting portion 167 shown in FIG. 15 when the flow concentration path 151 is mounted on the holder 151.

Further, as shown in FIG. 14, a tube connecting portion 168 is provided in the first side surface 160 of the flow concentration path 151. Six sections of ink lead out ports 169 are protrude in the tube connecting portion 168. An unillustrated hole formed in this ink lead out port 169 communicates with each ink flow path (an ink groove 159) of the main body 156. Each ink lead out port 169 is connected to an upstream side end portion 153 of the ink supply tube 152.

Next, the air flow path and each ink flow path formed in the flow concentration path 151 will be described in detail. As shown in FIG. 15, the pump connecting portion 162 protruding from the main body 156 is fitted in a pump side tube 170. The pump side tube 170 has one end connected with the pump connecting portion 162 and the other end connected with the pressure pump 25, and introduces the air delivered from the pressure pump 25 into the air flow path through the pump connecting portion 162.

Further, each air lead out portion 163 is connected to a distribution tube 171. The distribution tube 171 has one end connected to the air lead out portion 163 and the other end connected to the flow path (not shown) of the connecting portion 167 provided in the holder 150. The flow path penetrates into the connecting portion 167, and is opens at a case engaging port 172 formed at one side surface of the connecting portion 167. The case engaging portion 172 is provided in the connecting portion 167 connectable to the communication hole of the ink cartridge 23 mounted on the holder 150. Consequently, the air delivered from the pressure pump 25 flows into the air flow path of the flow concentration path 151 through the pump side tube 170, and is distributed by each distribution tube 171, and flows into the gap 33 within the ink case 31 from the case engaging port 172.

The interposal portion 166 of the flow concentration path 151 is interposed into a support portion 173 of the connecting portion 167. This support portion 173 is formed with an unillustrated ink hole. This ink hole has one end connected with the interposal portion 166 interposed into the support portion 173, and has the other end connected with the hole within an ink supply needle 174 fixed to the support portion 173. This ink supply needle 174 is formed in a hallow shape. When the ink cartridge 23 is mounted on the holder 150, the ink supply needle 174 is inserted into the ink discharge portion 32c of the ink cartridge 23, so that the ink within the ink pack 32 flows into the ink hole of the support portion 173. Hence, the ink pushed out from the ink pack 32 flows into the ink hole of the support portion 173 through the ink supply needle 174. The ink hole of the support portion 173 communicates with a path 175 within the interposal portion 166 interposed into the support portion 173, and the ink flowed into the ink hole of the support portion 173 is led out to the path 175.

As shown in FIGS. 16 and 17, the path 175 penetrating and formed into the interposal portion 166 penetrates into the protruding portion 165, and is opens at the underside of a recess portion 177 formed at the upper surface 176 of each protruding portion 165. The recess portion 177 as a large cross-sectional area flow path, is open at the upper surface 176, and is sealed by the film 157 so as to become an ink introduction chamber 178 temporarily storing the ink. This recess portion 177 corresponds to six sections of ink grooves 159, and forms one section each for the ink introduction portion 164 of the main body 156. Hence, a total of six recess portions 177 are formed in the main body 156.

In the underside of the recess portion 177, a protruding portion 179 corresponding to the step and the seal portion is formed. This protruding portion 179 is formed in a tapered shape toward the upper surface 176, and as shown in FIGS. 16 and 17, a communication hole 180 penetrates into the central portion of the protruding portion 179. In this way, each recess portion 177 is formed in each ink introduction portion 164, and the path 175 of each interposal portion 166 is opened at the underside of the recess portion 177. The length of the path 175 of each interposal portion 166 is all formed equally. Hence, the length of the flow path from the ink discharge port 32c of each ink cartridge 23 fixed on the holder 150 to each ink introduction chamber 178 is constant. To be more precise, the length of the flow path from each ink discharge portion 32c to the end edge of the path 175 opened at the underside of each recess portion 177 is constant or the opening from each ink discharge port 32c to the communication hole 180 formed in the protruding portion 179 is constant or the length of the flow path from the opening of the path 175 of the interposal portion 166 provided in the flow concentration path 151 to the opening of the path 175 of the ink introduction chamber 178 is constant.

A seal member 183 comprising an elastic material such as an elastomer is fixed to the inner side (the recess portion 177) of the film 157 sealing the recess portion 177. The film 157 blocking the recess portion 177 is flexible in the vertical direction (along the z direction) by the pressure difference between the inside and the outside of the ink introduction chamber 178. The seal member 183, as shown in FIG. 17, is capable of blocking the opening of the communication hole 180 when the film 157 is displaced to the recess portion 177. That is, when the pressure within the ink introduction chamber 178 is reduced to lower than the predetermined pressure, as shown in FIG. 17, the film 157 is flexed in a direction to reduce the volume of the ink introduction chamber 178. As a result, the film 157 abuts against the upper surface of the protruding portion 179, and blocks the flow of the ink passing through the communication hole 180 of the protruding portion 179.

The communication hole 180 formed in the protruding portion 179 extends vertically downward from the upper surface of the protruding portion 179, and is connected to a first hole 181 formed similarly in the main body 156. A first hole 181 is substantially flexed vertically for the communication hole 180, and extends horizontally. The first hole 181 is formed extending from the ink introduction chamber 178 to the ink groove 159, and communicates with a second hole 182. The second hole 182 extends upward vertically to the upper surface 176 from the end portion of the first hole 181. The second hole 182 communicates with the ink flow path (the ink groove 159) formed in the main body 156.

Each ink flow path (the ink groove 159), as shown in FIG. 15, is concentrated into a concentration portion 184 of the main body 156. Further, each ink flow path is flexed from the upper surface 176 (see FIG. 16) to the under surface, and is flexed again to the upper surface 176. Each ink flow path is formed so as to communicate with the ink lead out port 169 (see FIG. 14) provided in the tube connecting portion 168. Consequently, the ink introduced from each ink cartridge 23 through the ink supply needle 174 flows into the ink flow path (the ink groove 159) through the path 175, the ink introduction chamber 178, the communication hole 180 and the like. Further, the ink flowing into the ink flow path is led out to the ink supply tube 152 connected to the ink lead out port 169. The ink introduced into the ink supply tube 152 is led out to the valve unit 155 mounted on the carriage 147.

(Valve Unit)

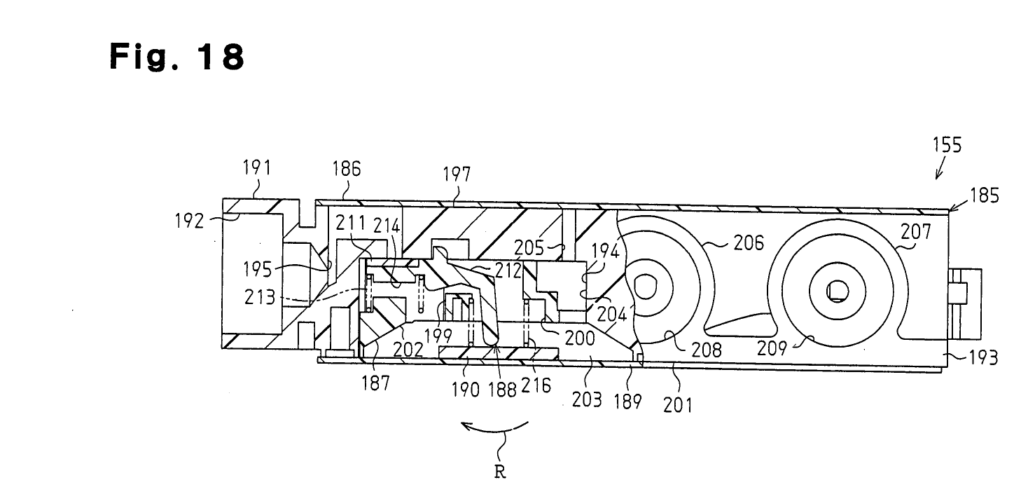

Next, a valve unit 155 as the liquid supply valve unit will be described. FIG. 18 shows a cross-sectional view of the valve unit 155. As shown in FIG. 18, the valve unit 155 comprises a flow path forming member 185, a first film member 186 as a flexible member, and a first fitting member 187 and a second fitting member (not shown). Further, the valve unit 155 comprises a first valve member 188 and a second valve member (not shown) as opening and closing valves, a second film member 189, a first pressure receiving plate 190, and a second pressure receiving plate (not shown).

The flow path forming member 185 comprises a thermoplastic resin formed in a substantially rectangular shape, and an ink introduction portion 191 is provided in its back surface. The ink introduction portion 191 has a shape as if having connected two cylinders, and comprises a first ink introduction hole 192 and a second introduction hole (not shown). The ink supply tube 152 communicates with this first ink introduction hole 192 and the second introduction hole, so that the ink of a total of two colors is introduced into the flow path forming member 185. Since the ink flow paths in the flow path forming member 185 corresponding to the first ink introduction hole 192 and the second ink introduction hole have substantially the same constitution, for the sake of convenience, the detailed description of the ink flow path and the second pressure chamber corresponding to the second introduction hole is omitted, and at the same time, the illustration thereof is omitted in FIG. 18.

The first ink introduction hole 192 communicates with a first communication hole 195 formed in the flow path forming member 185. The first communication hole 195 is formed in a substantially inversed L-shape within the flow path forming member 185, and has an opening portion in the midst thereof. This opening portion is sealed by the first film member 186 being hot-welded to the first side surface 197 of the flow path forming member 185. The flow path of the ink is formed from the first communication hole 195 and the first film member 186. The first film member 186 and the second film member 189 are formed by a flexible material that has a high gas barrier property.

Further, a first engaging recess portion 194 is formed in the second side surface 201 of the flow path forming member 185, and this first engaging recess portion 194 is fitted in the first fitting member 187. The first communication hole 195 communicates with a first ink inflow hole 199 penetrating into the first fitting member 187.

The second film member 189 is hot-welded to the second side surface 201 of the flow path forming member 185. At this time, the opening of a first recess portion 202 provided in the second side surface 201 is sealed by the second film member 189. In this way, a first pressure chamber 203 is formed by the second film member 189 and the first recess portion 202. The second film member 189 is flexed by the pressure difference between the inside and the outside of the first pressure chamber 203. That is, the second film member 189 is flexed in a direction to reduce the volume of the first pressure chamber 203 when the pressure within the first pressure chamber 203 is reduced to lower than the predetermined pressure.

The first pressure chamber 203 communicates with the first communication hole 195 through the first ink inflow hole 199 and a first central hole 200. Further, the first pressure chamber 203 communicates with a first ink outflow hole 204 formed in the first fitting member 187. The first ink outflow hole 204 communicates with a communication hole 205 formed in the flow path forming member 185.

Further, the flow path forming member 185 comprises a first ink discharge portion 206 and a second ink discharge portion 207 in the under surface 193. These first and second discharge portions 206 and 207 comprise first and second discharge holes 208 and 209, respectively. The first discharge hole 208 is formed by being continued to the communication hole 205. Further, the second discharge hole 209 is formed by being continued to an unillustrated communication hole (the ink flow path corresponding to the second ink induction hole).

The first and second ink discharge holes 208 and 209 communicate with the recording head 148, and the ink discharged from the first and second ink discharge holes 208 and 209 is ejected from the nozzle for each color. That is, the ink that has flowed into the first ink introduction hole 192 flows into the first pressure chamber 203 through the first communication hole 195, the first ink inflow hole 199, and the first central hole 200. Further, the ink that has flowed into the first pressure chamber 203 is supplied to the recording head 148 through the first ink outflow hole 204, the communication hole 205, and the first ink discharge hole 208.

Further, the first valve member 188 is mounted on the first fitting member 187 fitted in the first engaging recess portion 194. An adhering portion 211 of the first valve member 188 is fixed to a first valve member main body 212 so as to be superposed on the surface of the first communication hole 195. A first biasing spring 213 has one end fixed to the first fitting member 187 and the other end to a first disc portion 214 of the first valve member main body 212. Consequently, the first valve member 188 is biased in the direction of the arrow R in FIG. 18 by the first biasing spring 213.

When the second film member 189 is flexed by the reduction of the pressure in the first pressure chamber 203, the first pressure receiving plate 190 moves so as to approach the first recess portion 202 against the biasing force of a first pressure receiving spring 216. Then, the first valve member 188 rotates in the direction opposite to the arrow R shown in FIG. 18, and the first communication hole 195 is in a state of communicating with the first ink inflow hole 199 and the first central hole 200. Further, when the pressure within the first pressure chamber 203 is increased, the first pressure receiving plate 190 moves so as to be isolated from the first recess portion 202, and a non-communication state is established between the first communication hole 195 and the first ink inflow hole 199.

Next, the operation of the ink jet recoding apparatus 145 constituted as above will be described. The description of the electrical constitution of the ink jet recording apparatus 145 will be omitted as it is the same as that of the first embodiment.

At the time of the normal printing, the flow path of the ink from the ink cartridge 23 to the recording head 148 is in a state of being filled with the ink for each color. The ink supplied to each ink introduction chamber 178 of the flow concentration path 151 is maintained in a state of high pressure. Consequently, the film 157 sealing the ink introduction chamber 178 is maintained in a state in which it is not flexed. As a result, the ink that has flowed into the ink introduction chamber 178 is in a state capable of being led out to each ink flow path of the flow concentration path 151 through the communication hole 180.

Further, the valve unit 155 mounted on the cartridge 147 is supplied with the ink for each color, which is introduced in a pressurized state through the flow concentration path 151 and the ink supply tube 152. For example, the ink flowing from the first ink introduction hole 192 flows within the first pressure chamber 203 through the first communication hole 195.

In this state, when printing is started based on image data, the ejection of ink is performed from the recording head 148, and according to the ejection amount of the ink, the ink within the pressure chamber 203 is supplied to the recording head 148 through the first ink discharge hole 208 and the like. As a result, the ink within the first pressure chamber 203 is reduced, and the pressure within the first pressure chamber 203 is reduced.

For example, when the ink within the first pressure chamber 203 is reduced, the second film member 189 is flexed in a direction to reduce the volume within the first pressure chamber 203. As a result, the first valve member 188 is rotated by the first pressure receiving plate 190, and a communication state is established between the first communication hole 195 and the first ink inflow hole 199, as well as the first central hole 200. The ink within the first communication hole 195 and the ink supply tube 152 flows within the first pressure chamber 203, and the ink is caused to fill the first pressure chamber 203. Consequently, the ink within the ink supply tube 152 upstream of the first ink introduction hole 192 and the ink within the ink flow path within the flow concentration path 151 are led out to the valve unit 155.

When the ink flows within the first pressure chamber 203, the pressure of the ink within the first pressure chamber 203 is increased. As a result, the flexing of the second film member 189 alone is eliminated. The first valve member 188 rotates to its original position, and a non-communication state is established again between the first communication hole 195 and the first ink inflow hole 199.

Next, the operation of the ink jet recording apparatus 145 during choke cleaning will be described. When an input portion 115 (see FIG. 9) is operated by a user, a CPU 111 first drives the carriage motor 17 according to the choke cleaning program disclosed in the first embodiment, and moves the carriage 147 to the home position (for example, to the left end between the frame plate 145a and the frame plate 145b).

Further, the CPU 111 advances to a pressure reducing step, and stops a pressure pump motor 125 so as not to allow pressurized air to be delivered from the pressure pump 25. Subsequently, the CPU 111 advances to a capping step, and drives a cap lifting motor 126 so as to lift a cap 26a and seal the nozzle surface of the recording head 148. When the CPU 111 lifts the cap 26a, it advances to a drawing step, and drives a tube pump motor 127, and forms the negative pressure within the cap 26a.

As a result, the ink is drawn through the recording head 148, and first, the ink within the first pressure chamber 203 and the second pressure chamber in the valve unit 155 begins to be reduced. Similarly to the printing operation, the pressure within the first pressure chamber 203 and the second pressure chamber decrease to below the predetermined pressure, so that the second film member 189, the first valve member 188 and the second valve member start operating, and a communication state is established between the first communication hole 195 and the second communication hole, and the first ink inflow hole 199 and the second ink inflow hole.

Then, the ink within the ink flow path of the ink supply tube 152 and the flow concentration path 151 in the upstream side of the valve unit 155 flows within the valve unit 155. Further, at this time, since the pressurized air from the pressure pump 25 is in a state of not being delivered, the ink within each ink introduction chamber 178 provided in the upstream side of the ink flow path of the ink supply tube 152 and the flow concentration path 151 begins to gradually reduce also.

When the pressure within each ink introduction chamber 178 is reduced to lower than the predetermined pressure, as shown in FIG. 17, the film 157 sealing the ink introduction chamber 178 is flexed, and the seal member 183 blocks the opening of the communication hole 180 of the protruding portion 179. As a result, the flow of ink flowing from the ink introduction chamber 178 to the communication hole 180 is blocked.

In this state, by allowing the suction operation to be continued by a tube pump 26e constituting suction means, with the first ink introduction chambers 178 as a boundary, negative pressure is accumulated in the downstream side thereof. The CPU 111 measures the driving time of the tube pump motor 127 according to the choke cleaning program, and when the predetermined time elapses, it advances to a pressure increasing step, and starts the driving of the pressure pump motor 125. The CPU 111 completes the processing of the choke cleaning program when the driving of the pressure pump motor 125 is started.

As a result, the delivery of the pressurized air from the pressure pump 25 is started, and the ink is supplied in a pressurized state from the ink cartridge 23 through the connecting portion 167. Then, the ink is supplied to the ink introduction chamber 178 in a pressurized state, and the bending of the film 157 is eliminated. In this way, the film 157 and the protruding portion 179 are isolated, and the flow of the ink passing through the communication hole 180 is allowed.

At this time, the length of the flow path from the ink discharge port 32c of the each ink cartridge 23 to each ink introduction chamber 178 is constant. To be more precise, the length of the flow path to the opening of the path 175 formed in each ink introduction chamber 178 from the ink discharge port 32c of the ink cartridge 23 or to the opening of the communication hole 180 is constant, respectively. Hence, when the ink is supplied from each ink cartridge 23 in a pressurized state, substantially at the same time, the filling of the ink into the ink introduction chamber 178 is completed, and substantially at the same time, the flexing of the film 157 is eliminated.

The ink flows from the upstream side instantly to eliminate the negative pressure accumulated in the section downstream of each ink introduction chamber 178, and the ink speeds up instantaneously and begins to flow. As a result, the bubbles and impurities stagnated in the section downstream of each ink introduction chamber 178, that is, within the flow path from the flow concentration path 151 to the valve unit 155 are discharged together with the ink instantly from the nozzle of the recording head 148 through the ink supply tube 152, thereby performing choke cleaning.

Consequently, according to the second embodiment, the following effects are obtained.

(6) In the second embodiment, the ink jet recording apparatus 145 comprises the pressure pump 25 and the like, and becomes an apparatus of an air pressurized system for pressure-transferring the ink to the recording head 148 by introducing pressurized air from the pressure pump 25 into the ink cartridge 23. Each ink introduction chamber 178 is provided in the midst of the ink flow path between the ink cartridge 23 and the recording head 148, and in the upstream side of the ink flow path formed in the flow concentration path 151. This ink introduction chamber 178 has a part of the wall surface formed by the film 157 which is flexed by the difference between the pressure of the ink inside and the atmospheric pressure.

Consequently, according to the present embodiment, in a state of the opening surface of the nozzle of the recording head 148 being covered by the cap 26a, the driving of the pressure pump 25 is stopped, so that the pressure of the fluid within the flow concentration path 151, the ink supply tube 152 and the valve unit 155 is reduced. In this state, by performing the suction operation of the tube pump 26c, the pressure of the fluid within the flow concentration path 151, the ink supply tube 152 and the valve unit 155 is totally reduced. Hence, the pressure within each ink introduction chamber 178 is reduced lower than the predetermined pressure, and the film 157 is flexed inside.

As a result, the seal member 183 within the film 157 abuts against the protruding portion 179, and the ink flow passing through the communication hole 180 is blocked. In this state, by allowing the suction operation to be continued by the tube pump 26e, the negative pressure is accumulated in the section downstream of the abutting portion between the film 157 and the protruding portion 179. Further, by starting the driving of the pressure pump 25 in a state of the negative pressure being accumulated, the flexing of the film member 157 is restored, and the negative pressure accumulated is eliminated instantly. As a result, the bubbles, impurities and the like within the flow path across the whole ink flow path from each ink cartridge 23 to the nozzle opening of the recording head 148 is discharged instantly together with the ink from the nozzle of the recording head 148, thereby performing the so-called choke cleaning. As a result, the filling factor of the ink in the ink jet recording apparatus 145 is enhanced.

Further, since the ink introduction chamber 178 is provided in the upstream side of the ink flow path formed in the flow concentration path 151, the ink introduction chamber 178 is provided with a relatively stable supply of the ink from the ink cartridge 23. Consequently, the flexing of the film 157 for sealing the ink introduction chamber 178 is easily eliminated, and reliability of the displacing operation of the film 157 is enhanced. Consequently, the ink is relatively and stably led out to the downstream side of the ink introduction chamber 178.

(7) In the second embodiment, the ink introduction chamber 178 is provided in the flow concentration path 151. Further, the first pressure chamber 203 and second pressure chamber are provided in the valve unit 155 of the downstream of the flow concentration path 151. Hence, the valve unit 155 is made compact and light weight or the structure of the valve unit 155 is simplified. Consequently, when the number of ink cartridges 23 is increased and the number of valve units 155 mounted on the carriage 147 is increased, the load on the carriage motor 17 is reduced.

(8) In the second embodiment, each ink introduction chamber 178 is formed in the ink introduction portion 164 formed in the flow concentration path 151. The length of the flow path from the ink discharge port 32c of each ink cartridge 23 to each ink introduction chamber 178 is made constant. To be more precise, in a state in which the holder 150 is provided with the ink cartridge 23, the length of the flow path from the ink discharge part 32c of the ink cartridge 23 to the opening of the path 175 of the ink introduction chamber 178 or to the opening of the communication hole 180 of the ink introduction chamber 178 is made constant.

Hence, in a state of a film 157 blocking the communication hole 180 by the driving of the tube pump 26c, the time required from starting the driving of the pressure pump 25 to the elimination of the flexing of the film 157 is substantially constant for each ink introduction chamber 178. Hence, unlike the case where the time required from starting the driving of the pressure pump 25 to the elimination of the flexing of the film 157 is different for each ink introduction chamber, there is no need to drive the pressure pump 25 by matching the ink introduction chamber where the time required until the elimination of the flexing of the film 157 takes long. Hence, the driving time of the pressure pump 25 for eliminating the flexing of the film 157 is made the minimum possible. Consequently, the time required for the choke cleaning is shortened.

(9) In the second embodiment, the protruding portion 179 into which the communication hole 180 penetrates is formed in the undersides of each ink introduction chamber 178 (a recess portion 177), and each protruding portion 179 is allowed to confront the film 157 constituting the ink introduction chamber 178. Consequently, at the choke cleaning, the film 157 is flexed to the ink introduction chamber 178 so as to be able to abut against the protruding portion 179, thereby sealing the communication hole 180 more reliably. Hence, in the flow path of the downstream of the film 157, the negative pressure is more reliably accumulated, and therefore, the choke cleaning is more reliably performed.

(Third Embodiment)

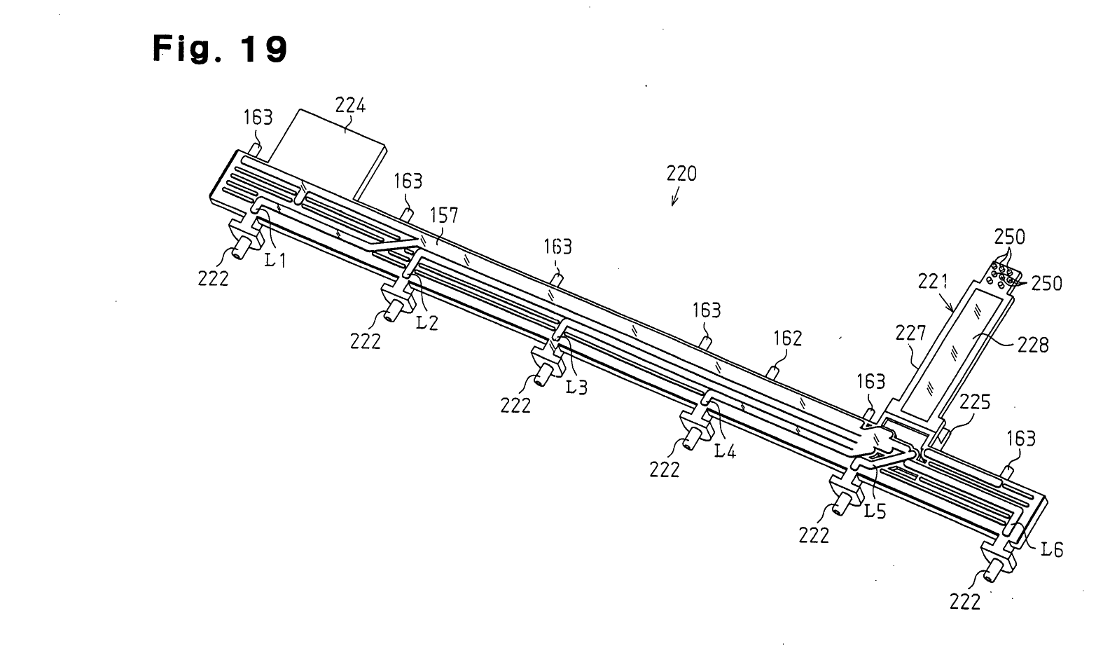

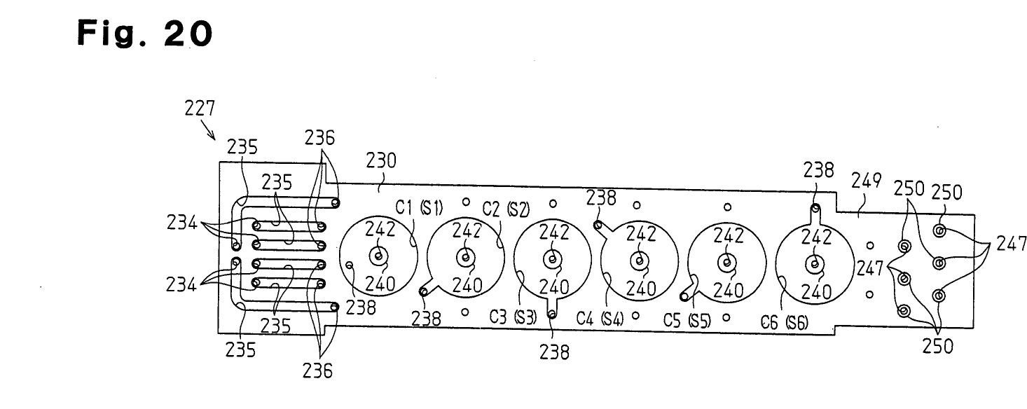

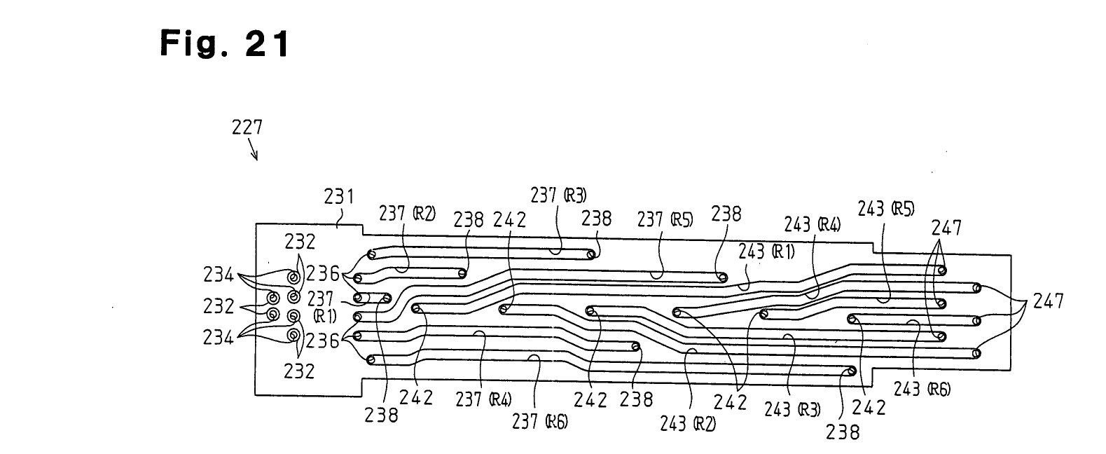

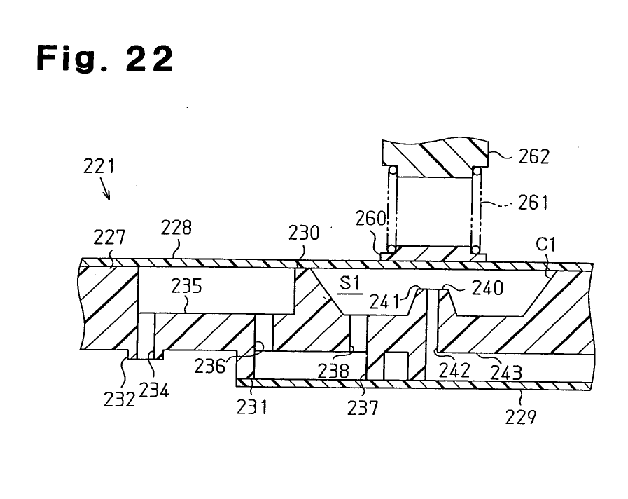

Next, a third embodiment according to the present invention will be described according to FIGS. 19 to 22. Since the third embodiment has a constitution in which the valve units or the ink introduction chambers of the first and second embodiments alone are changed, the description of the like parts will be omitted. FIG. 19 is a perspective view of a flow concentration path 220 constituting a liquid supply path, FIG. 20 is a top view of a main body 227 of a choke valve 221 connected to the flow concentration path 220, and FIG. 21 is an under surface view of the main body 227. FIG. 22 is an essential part cross-sectional view of the choke valve 221.

The flow concentration path 220 of the present embodiment has a constitution where the ink introduction chamber 178 shown in FIG. 16 alone is omitted from the flow concentration path 151 disclosed in the second embodiment. Consequently, the ink that has flowed into cylindrical interposal portions 222 provided in one side surface of the flow concentration path 220 is directly flowed into a first ink flow path L1 to a sixth ink flow path L6 formed in the flow concentration path 220. The interposal portions 222 corresponding to the first ink flow path L1 to the sixth ink flow path L6 protruded from the left end to the right end in order in the flow concentration path 220 in FIG. 19, respectively.

Further, where the length of the total flow path of the first flow path L1 to the sixth flow pat L6 is represented by D1 to D6, the size of D1 to D6 becomes smaller as it goes from the length D1 to the length D6 except the length D5. The length D5 is the smallest. That is, an inequality is established where the length D1>the length D2>the length D3>the length D4>the length D6>the length D5.

A valve side connecting portion 225 provided in the main body 224 of the flow concentration path 220 is connected to a choke valve 221. The choke valve 221 comprises a main body 227 as a flow path forming member formed in a substantially rectangular plate shape, and the first film 228 and the second film 229 (see FIG. 22) as flexible members. The main body 227 is made of a thermoplastic resin. The first and second approx rectangular shaped films 228 and 229 are hot-welded to the main body 227, and are formed of a flexible member having a high gas barrier property. As shown in FIG. 22, the first film 228 and the second film 229 are hot-welded to an upper surface 230 and an undersurface 231 of the main body 227, respectively.

As shown in FIGS. 20 and 21, the main body 227 is formed with a first recess portion C1 to a sixth recess portion C6 as a large cross-sectional area flow path and respective ink grooves and the like communicate with those recess portions. The first recess portion C1 to the sixth recess portion C6 and the grooves connected with those recess portions have opening portions, respectively, and these opening portions are sealed by the hot-welding of the first film 228 and the second film 229 to the main body 227. The first recess portion C1 to the sixth recess portion C6, the grooves, the first film 228 and the second film 229 constitute a first flow path R1 to a sixth flow path R6. FIGS. 20 and 21 show a state where the first film 228 and the second film 229 are not hot-welded to the main body 227.

As shown in FIGS. 21 and 22, the under surface 231 of the main body 227 is formed with six sections of introduction protrusion 232. Each introduction protrusion 232 is fitted in an ink lead out port 169 of the flow concentration path 220. As shown in FIG. 22, an introduction hole 234 penetrates into the introduction protrusion 232, and the introduction hole 234 is continuously formed in the upper side groove 235 formed in the upper surface 230 of the main body 227. In FIG. 22 the first recess portion C1 is shown and the corresponding grooves, holes and the like constituting the first flow path R1.

As shown in FIG. 22, the upper side groove 235 is open at its upper surface 230, and the opening is sealed by the first film 228. One end of the upper side groove 235 communicates with the introduction hole 234, and the other end communicates with an upstream side communication hole 236. The upstream side communication hole 236, as shown in FIG. 22, penetrates the main body 227 and extends up and down, and communicates with an introduction groove 237. The introduction groove 237 is open at its under surface 231, and the opening is sealed by the hot-welding of the second film 229 to the main body 227. Further, as shown in FIG. 21, the introduction groove 237 constituting the first flow path R1 to the sixth flow path R6 extends to the vicinity of the corresponding first recess portion C1 to sixth recess portion C6, respectively. Consequently, the length and size of each introduction groove 237 is different, respectively.

As shown in FIG. 22, the introduction groove 237 communicates with the downstream side communication hole 238. The downstream side communication holes 238 penetrate the main body 227 and extend up and down. Further, the downstream side holes 238 are open at the under sides of the first recess portion C1 to the sixth recess portion C6 formed in the upper surface 230, respectively. The first recess portion C1 to the sixth recess portion C6 are formed in a substantially circular shape, and the side surface thereof is an inclined surface (tapered shape) with its cross-sectional area becoming smaller from the upper surface 230 to the under surface 231. The first recess portion C1 to the sixth recess portion C6, as shown in FIG. 20, are arranged in order from one end portion formed with each introduction protrusion 232 of the main body 227 (the introduction hole 234) to the other end portion.

As shown in FIG. 22, the first recess portion C1 (from the second recess portion C2 to the sixth recess portion 6) is open at the upper surface 230, and is sealed by the first film 228. Protrusions 240 constituting steps and seal portions are formed substantially in the center of the undersides of the first recess portion C1 to the sixth recess portion C6, respectively. The protrusion 240 is formed such that its upper surface 241 becomes lower than the upper surface 230 of the main body 227. The first ink introduction chamber S1 (the second ink introduction chamber S2 to the sixth ink introduction chamber S6) is formed by the first recess portion C1 to the sixth recess portion C6 and the first film 228. The protruding portion 240 is penetrated with a communication hole 242 as a small section area flow path, and this communication hole 242 is open at the upper surface 241.

The first film 228 constituting the first ink introduction chamber S1 to the sixth ink introduction chamber S6 is flexed by the pressure difference between the inside and the outside of the first ink introduction chamber S1 to the sixth ink introduction chamber S6. That is, the first film 228 is flexed in a direction to reduce the volume of the first ink introduction chamber S1 to the sixth ink introduction chamber. S6 when the pressure within the first ink introduction chamber S1 to the sixth ink introduction chamber S6 is reduced lower than the predetermined pressure. As a result, the first film 228 abuts against the upper surfaces 241 of the protruding portions 240 formed in the first ink introduction chamber S1 to the sixth ink introduction chamber S6, respectively, and blocks the flow of the ink into the communication hole 242.

Further, a spring seat 261 is attached to the outer side surface of the first film 228. Further, six sections of biasing spring 261 are provided so as to confront the first ink introduction chamber S1 to the sixth ink introduction chamber S6 through the first film 228 in the vicinity of the first film 228. One end of each biasing spring 261 is fixed to a spring seal 260, and the other end to a fixing portion 262. The fixing portion 262 is supported by the ink jet recording apparatus 145. The biasing spring 261 biases the first film 228 to the insides of the first ink introduction chamber S1 to the sixth ink introduction chamber S6, and allows the first film 228 to abut against the protruding portion 240.

In a state of the ink being supplied to the first ink introduction chamber S1 to the sixth ink introduction chamber S6 in a pressurized state by the driving of the pressure pump 25 at the time of printing and the like, as shown in FIG. 22, the first film 228 is maintained in a state of not abutting against the protruding portion 240 against the biasing force of the biasing spring 261. That is, the biasing spring 261 comprises a biasing force amount unable to allow the first film 228 to abut against the protruding portion 240 in a state of the ink being supplied in a pressurized state to the first ink introduction chamber S1 to the sixth ink introduction chamber S6.

Further, when the pressure pump 25 stops driving in case the ink cartridge 23 and the like are taken out from the holder 150, the first film 228 is abutted against the protruding portion 240 by the biasing force of the biasing spring 261. That is, the biasing spring 261 has a biasing force capable of allowing the first film 228 to abut against the protruding portion 240 when the ink is being supplied in a non-pressurized state from the first ink introduction chamber S1 to the sixth in introduction chamber S6.

The communication hole 242 formed in the protruding portion 240 is continuously formed in a lead out groove 243. The lead out groove 243 is open at the under surface 231, and has the opening sealed by the second film 229. The lead out groove 243 constituting the first flow path R1 to the sixth flow path R6, respectively extends from just under the corresponding first recess portion C1 to the sixth recess portion C6, and to the base end portion of the main body 227. Consequently, the length and size of each lead out groove 243 is different, respectively.

As shown in FIG. 21, each lead out groove 243 communicates with a lead out hole 247 in the base end portion of the main body 227. Each lead out hole 247 vertically penetrates the main body 227 from the under surface 231 to the upper surface 230.

Further, as shown in FIG. 20, a tube connecting portion 249 provided in the other end portion of the main body 227 is formed with six sections of connecting protrusion 250, and each connecting protrusion 250 is connected to each flow path of the ink supply tube 152. The lead out hole 247 connected to each lead out groove 243 penetrates the corresponding connecting protrusion 250, and is open at the upper end of the connecting protrusion 250. The first flow path R1 to the sixth flow path R6 are connected to each ink flow path of the ink supply tube 152 through each connecting protrusion 250. The ink supply tube 152, similarly to the second embodiment, is connected to the valve unit 155 mounted on the carriage 147.

Consequently, the ink led out from the first ink flow path L1 to the sixth ink flow path L6 flows into the first flow path R1 to the sixth flow path R6 within the choke valve 221 through each introduction protrusion 232 formed in the main body 227 of the choke valve 221, respectively. At this time, the ink flows into the first ink introduction chamber S1 to the sixth ink introduction chamber S6 provided in the midst of the first ink flow path R1 to the sixth flow path R6. The ink flowed into the first ink introduction chamber S1 to the sixth ink introduction chamber S6 is led out to the ink flow path within the ink supply tube 152 from each connecting protrusion 250 of the main body 227.

Further, the lengths M1 to M6 of the flow path from the opening of each introduction hole 234 to the first ink introduction chamber S1 to the sixth ink introduction chamber S6, to be precise, are of a length from the opening of each introduction hole 234 to the opening in the underside of the first ink introduction chamber S1 to the sixth ink introduction chamber S6 of the downstream side communication hole 238 or of a length to the opening of the communication hole 242 formed in each protrusion 240. These lengths become larger in order of the lengths M1 to M6 (the length M1<the length M2<the length M3<the length M4<length M5<length M6).

The first flow path R1 to the fourth flow path R4 of the choke valve 221 shown in FIG. 21 communicate with the first ink flow path L1 to the fourth ink flow path L4 of the flow concentration path 220 shown in FIG. 19, respectively. The fifth flow path R5 of the choke valve 221 communicates with the sixth ink flow path L6 of the flow concentration path 220, and the sixth flow path R6 of the choke valve 221 communicates with the fifth ink flow path L5 of the flow concentration path 220. The length of the total ink flow path obtained by adding the lengths D1 to D6 of the ink flow path in the flow concentration path 220 and the lengths M1 to M6 of the ink flow path in the choke valve 221, respectively is made constant. That is, for example, the value (the length D1+the length M1) obtained by adding the length D1 of the first ink flow path L1 of the flow concentration path 220 and the length M1 of the first flow path R1 of the choke valve 221 is equal to the value (the length D2+the length M2) obtained by adding the length D2 of the ink flow path L2 of the flow concentration path 220 and the length M2 of the second flow path R2 of the choke valve 221. Further, it is also equal to the value (the length D3+the length M3, the length D4+the length M4, the length D5+the length M6, and the length D6+the length M5) obtained by adding the length of other ink flow paths. That is, the length of the total flow path comprising the ink flow path of the flow concentration path 220 and the ink flow path of the choke valve 221 connected therewith are set to become equal.

At the time of normal printing, the ink is in a state of filling from the ink cartridge 23 to the recording head 148 for each color. At this time, the ink supplied to the first ink introduction chamber S1 to the sixth ink introduction chamber S6 of the choke valve 221 is maintained in a state of having high pressure. Consequently, the first film 228 sealing the first recess portion C1 to the sixth recess portion C6 is maintained in a state of not being flexed. As a result, the ink that has flowed into the first ink introduction chamber S1 to the sixth ink introduction chamber S6 is in a state capable of being led out to the lead out groove 243 through the communication hole 242.

In this state, when printing is started based on image data, the ejection of ink is performed from the recording head 148, and according to the ejection amount of the ink, the ink within the first pressure chamber 203 of the valve unit 155 and the second pressure chamber is supplied to the recording head 148. As a result, the pressure within the first pressure chamber 203 and the second pressure chamber is reduced. For example, when a first valve member 188 is rotated by the first pressure receiving plate 190, the ink in the upstream side of the valve unit 155, that is, in the first communication hole 195 is filled within the first pressure chamber 203. In this way, the ink within the choke valve 221 and the flow concentration path 220 is pushed out in order to the ink supply tube 152.

Next, the operation of the ink jet recording apparatus 145 at the choke cleaning will be described. When an input portion 115 (see FIG. 9) is operated by the user, a CPU 111 moves the carriage 147 to a home position. The CPU 111 advances to a pressure reducing step, and stops the driving of a pressure pump motor 125. Then, the pressure pump 25 stops, and the first film 228 is abutted against the upper surface 241 of the protruding portion 240 by the biasing force of each biasing spring 261 shown in FIG. 22. As a result, the flow of the ink flowing into each communication hole 180 from each ink introduction chamber 178 is blocked. Subsequently, the CPU 111 lifts a cap 26a and advances to the drawing step through the capping step sealing the nozzle surface of the recording head 148.

As a result, the ink is drawn through the recording head 148, and first, the ink within the first pressure chamber 203 and the second pressure chamber of the valve unit 155 begins to reduce. This allows the first valve member 188 and the second valve member to rotate, and a communication state is established between the first communication hole 195 and the second communication hole, and the first ink inflow hole 199 and the second ink inflow hole. The ink within the ink supply tube 152 of the upstream side of the valve unit 155 flows within the valve unit 155.

In this state, by allowing the suction operation to be continued by a tube pump 26e, with the first ink introduction chamber S1 to the sixth ink introduction chamber S6 as a boundary, negative pressure is accumulated in the downstream side thereof. The CPU 111 measures the driving time of a tube pump motor 127 according to the choke cleaning program, and when a predetermined time elapses, it advances to a pressure increasing step and starts the driving of the pressure pump motor 125. When the CPU 111 starts the driving of the pressure pump motor 125, the processing of the choke cleaning is completed.

As a result, the delivery of the pressurized air from the pressure pump 25 is started, and the ink is supplied from the ink cartridge 23 to the valve unit 155 in a pressurized state. Then, the ink is supplied to the first ink introduction chamber S1 to the sixth ink introduction chamber S6 in a pressurized state, and the flexing of the first film 228 is eliminated against the biasing force of each biasing spring 261. In this way, the first film 228 and the protruding portion 240 are isolated, and the flow of the ink passing through the communication hole 242 is allowed. At this time, since the total length of the ink flow path from the ink discharge port 32c to the first ink introduction chamber S1 to the sixth ink introduction chamber S6 is substantially constant, the time required from starting the driving of the pressure pump 25 to the elimination of the flexing of the first film 228 constituting a part of the first ink introduction chamber S1 to the sixth ink introduction chamber S6 is substantially constant.

The ink flows instantly from the upstream side to eliminate the negative pressure accumulated in the section downstream of the first ink introduction chamber S1 to the sixth ink introduction chamber S6, and the ink speeds up instantaneously and begins to flow. As a result, the bubbles and impurities stagnated in the section downstream of each of the first ink introduction chamber S1 to the sixth ink introduction chamber S6 are discharged instantly together with the ink from the nozzle of the recording head 148, and the choke cleaning is performed.

Consequently, according to the third embodiment, in addition to the effect disclosed in (9) of the second embodiment, the following effects are obtained.

(10) In the third embodiment, the ink jet recording apparatus 145 comprises the pressure pump 25 and the like, and becomes an air pressurized system for pressure-transferring the ink to the recording head 148 by introducing the pressurized air from the pressure pump 25 into the ink cartridge 23. The choke valve 221 provided integrally with six sections of the first introduction chamber S1 to the sixth introduction chamber S6 is provided in the midst of the ink flow path between the ink cartridge 23 and the recording head 148, and between the flow concentration path 220 and the ink supply tube 152. Further, the first ink introduction chamber S1 to the sixth ink introduction chamber S6 have a part of the wall surfaces formed by the first film 228, which is flexed by the difference between the pressure of the ink inside and the atmospheric pressure.

Consequently, according to the present embodiment, in a state of the nozzle of the recording head 148 being covered by the cap 26a, the driving of the pressure pump 25 is stopped, so that the pressure of the fluid within the flow concentration path 220, the choke valve 221, the ink supply tube 152 and the valve unit 155 is reduced. This allows the pressure within the first ink introduction chamber S1 to the sixth ink introduction chamber S6 to be reduced lower than the predetermined pressure and the first film 228 to be flexed inside, and at the same time, the first film 228 to abut against the protruding portion 240 by the biasing force of the biasing spring 261. Hence, the flow of the ink passing through the communication hole 242 is blocked.

In this state, by allowing the suction operation to be continued by the tube pump 26e, negative pressure is accumulated in the section downstream of the abutting portion between the first film 228 and the protruding portion 240. Further, in a state of the negative pressure being accumulated, the driving of the pressure pump 25 is started, so that the flexing of the first film 228 is restored, and the accumulated negative pressure is eliminated instantly. As a result, the bubbles and impurities and the like stagnated within the ink supply tube 152 and the valve unit 155 of the downstream of the first ink introduction chamber S1 to the sixth ink introduction chamber S6 are discharged instantly together with the ink from the nozzle of the recording head 148, and the choke cleaning is performed. As a result, the filling factor for the ink in the ink jet recording apparatus 145 is enhanced.

(11) In the third embodiment, the length from the ink discharge portion 32c of each ink cartridge 23 to the first ink introduction chamber S1 to the sixth ink introduction chamber S6 is made substantially constant. Hence, in a state of the first film 228 abutting against the protruding portion 240 by the driving of the tube pump 26e so as to block the communication hole 242, the time required from starting the driving of the pressure pump 25 to the elimination of the flexing of the first film 228 is substantially constant in the first ink introduction chamber S1 to the sixth ink introduction chamber S6. Hence, unlike the present embodiment, that is, unlike the case where the time required from starting the driving of the pressure pump 25 to the elimination of the flexing of the first film 228 is different for each ink introduction chamber, there is no need to drive the pressure pump 25 by matching the ink introduction chamber and the ink flow path where the time required until the flexing of the first film 228 is eliminated is long. Hence, the driving time of the pressure pump 25 for eliminating the flexing of the first film is made the shortest length.

Consequently, according to the third embodiment, the following effects are obtained.

(12) In the third embodiment, by forming six section of the first ink introduction chamber S1 to the sixth ink introduction chamber S6 in the main body 227, the choke valve 221 is constituted. Hence, rather than forming the first ink introduction chamber S1 to the sixth ink introduction chamber S6 in separate members, respectively, the choke valve 221 is easily mounted on the flow concentration path 220. Further, since the first ink introduction chamber S1 to the sixth ink introduction chamber S6 are formed in one main body 227, the number of manufacturing processes for the choke valve 221 is reduced. Further, the valve unit 155 is reduced, and made compact and light-weight.

(13) In the third embodiment, six sections of biasing spring 261 confronting the first ink introduction chamber S1 to the sixth ink introduction chamber S6 are provided in the outside of the first film 228. Each biasing spring 261 presses the first film 228 to the side of the first ink introduction chamber S1 to the sixth ink introduction chamber S6. The biasing spring 261 has sufficient biasing force to maintain the first film 228 in a state of not abutting against the protruding portion 240 when the ink is supplied in a pressurized state to the first ink introduction chamber S1 to the sixth ink introduction chamber S6. Further, the biasing spring 261 has a biasing force amount to allow the first film 228 to abut against the protruding portion 240 when the ink is supplied in a non-pressurized state to the first ink introduction chamber S1 to the sixth ink introduction chamber S6. Hence, when the ink cartridge 23 is taken out from the holder 150, the biasing spring 261 allows the first film 228 to abut against the protruding portion 240, thereby reliably blocking the communication hole 242. As a result, in a non-mounting state of the ink cartridge 23, the ink stagnated in the ink flow path of the downstream of the communication hole 242 from the ink supply needle 174 of the holder 150 is prevented from leaking.

(Fourth Embodiment)

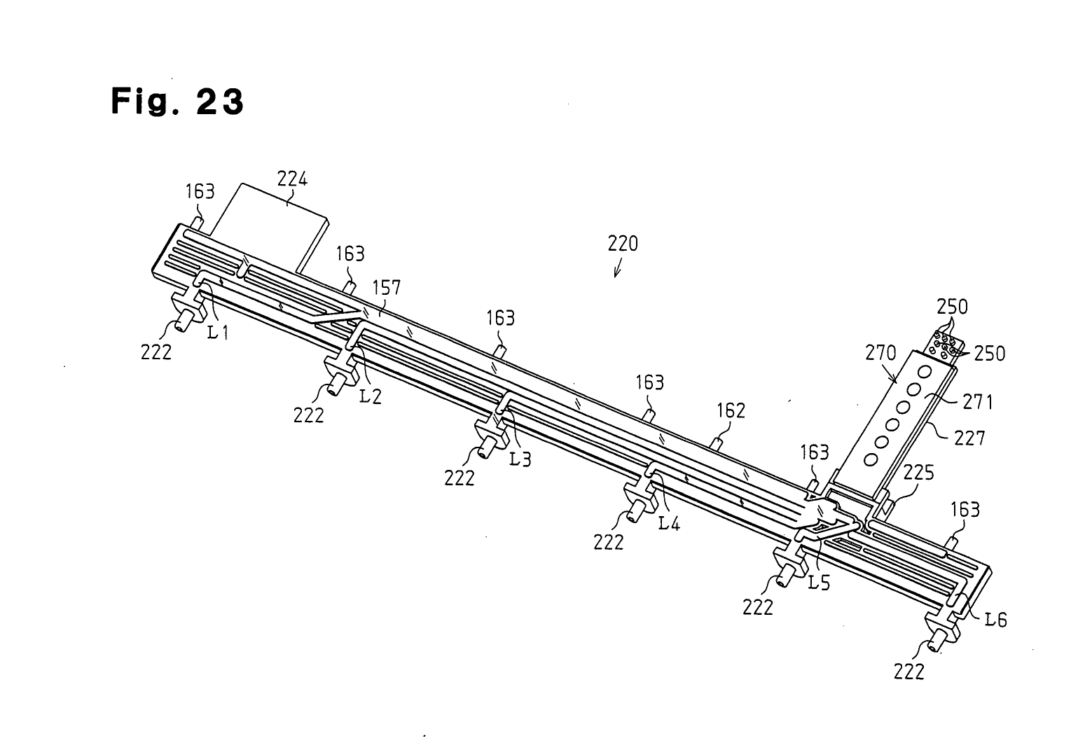

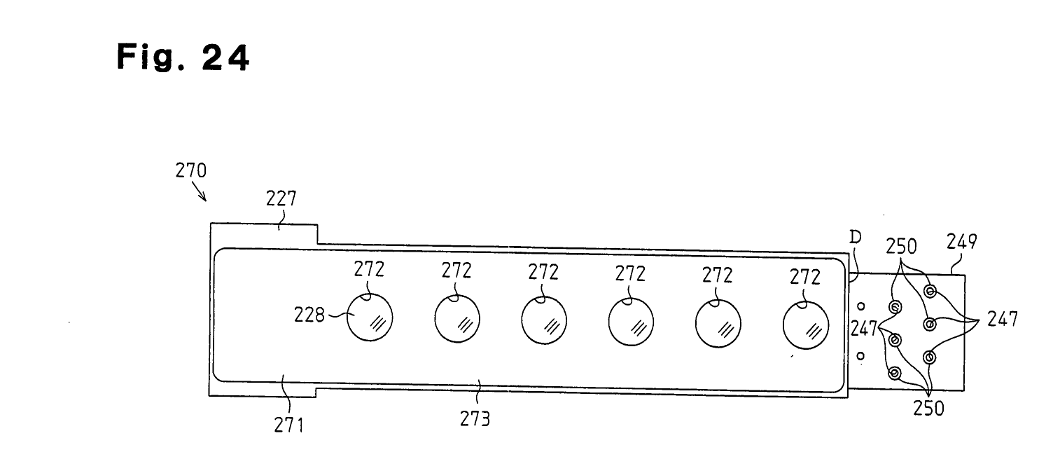

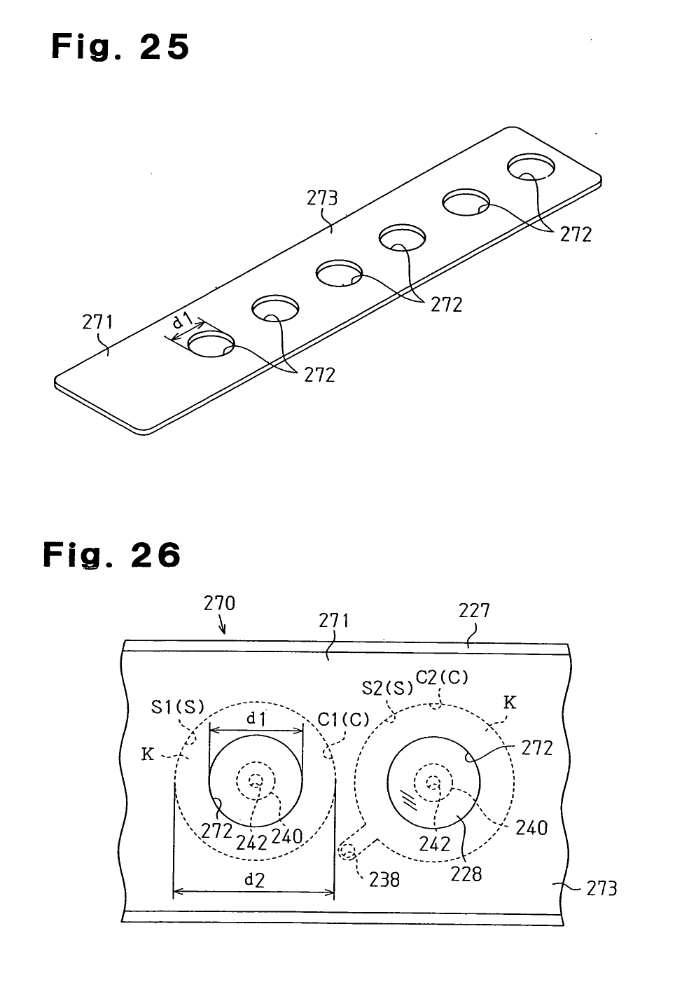

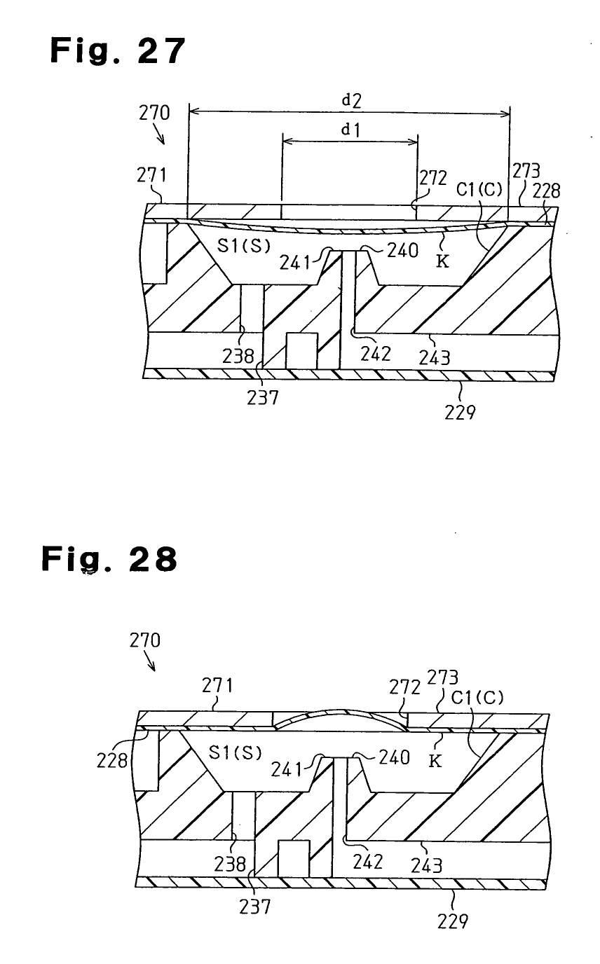

Next, a fourth embodiment according to the present invention will be described according to FIGS. 23 to 30. Since the fourth embodiment has a constitution where the choke valve 221 of the third embodiment alone is changed, the detailed description of the like parts will be omitted. FIG. 23 is a perspective view of a flow concentration path 220, and FIG. 24 is a top view of a choke valve 270 of the present embodiment. FIG. 25 is a perspective view of a regulating plate 271 constituting the choke valve 270, and FIG. 26 is an explanatory drawing for explaining the essential portions of the choke valve 270. Further, FIGS. 27 to 30 are essential part cross-sectional views for explaining the operation of the choke valve 270.

As shown in FIG. 23, a valve side connecting portion 225 of the flow concentration path 220 is connected to the choke valve 270 of the present embodiment. The choke valve 270 comprises the same main body 227 as that of the third embodiment and the first and second films 228 and 229 (see FIG. 22). Further, as shown in FIG. 24, the choke valve 270 further comprises the regulating plate 271 as regulating means provided on the main body 227.

As shown in FIG. 25, the regulating plate 271 comprises a long metal plate. Further, the regulating plate 271 is penetrated with six permissive holes 272 as lined up in a row. Each permissive hole 272 is formed in a circular shape, and its inner diameter, as shown in the permissive hole 272 at the left end in FIG. 25, becomes d1 in inner diameter. Further, from among the regulating plates 271, the portion where the permissive hole 272 is not formed becomes a blocked portion 273.

When the regulating plate 271 is mounted on the main body 227, as shown in FIG. 24, one end in a lateral direction of the regulating plate 271 is positioned so as to match a position of a step portion D formed at the side of the tube connecting portion 249 of a main body 227, and is fixed to a first film 228 by adhesive agent and the like. Then, as shown in FIGS. 26 and 27, the permissive hole 272 is arranged inward of the outer periphery of an opening sealing portion K on a circular portion (hereinafter, referred to as an opening sealing portion K) of the first film 228 as a flexible region which seals the opening of the first to sixth recess portions C1 to C6. Further, when the regulating plate 271 is mounted on the main body 227, an upper side groove 235 (see FIG. 20) sealed by the first film 228 is also blocked by the blocking portion 273 of the regulating plate 271. It is to be noted that, when the first to sixth recess portions C1 to C6 are described without making any distinction among them, they will be simply described below as a recess portion C.

As shown in FIGS. 26 and 27, the opening sealing portion K has a diameter d2 larger than the inner diameter d1 of the permissive hole 272. Hence, when the regulating plate 271 is mounted on the main body 227, the regulating plate 271 is in a state of covering the peripheral edge portion of the opening sealing portions K constituting the first to sixth ink introduction chambers S1 to S6. By arranging the permissive hole 272 of the regulating plate 271 in the central portion of each opening sealing portion K, the central portion is in a state of being not covered by the regulating plate 271. It is to be noted that, when the first to sixth ink introduction chambers S1 to S6 are described without making any distinction among them, they will be simply described below as an ink introduction chamber S.

The opening sealing portion K constituting each ink introduction chamber S is displaced according to the pressure difference between the inside and the outside of the ink introduction chamber S. For example, as shown in FIG. 30, in a case where the choke valve 270 is not provided with the regulating plate 271, when the ink is flowed into each ink introduction chamber S in a pressurized state by the driving of the pressure pump 25, the opening sealing portion K receives a force (upward in FIG. 30) to increase the volume of the ink introduction chamber S. When the amount of ink within the ink introduction chamber S flows above a predetermined amount, and the internal pressure increases above a predetermined value, the whole opening sealing portion K is displaced upward as shown in FIG. 30.

Meanwhile, the opening sealing portion K of the present embodiment is partially displaced by the pressure difference between the inside and the outside of the ink introduction chamber S. For example, when the ink flows above the predetermined amount into the ink introduction chamber S and the internal pressure of the ink introduction chamber becomes equal to or more than the predetermined value, the opening sealing portion K receives a force in a direction (upward in FIG. 27) to increase the volume of the ink introduction chamber S. At this time, as shown in FIG. 28, the opening sealing portion K is regulated for upward displacement in its peripheral edge portion by the regulating plate 271, and therefore, bulging (displacement) as a whole is prevented. Furthermore, since the central portion of the opening sealing portion K is allowed to displace upward by the arrangement of the permissive hole 272, it is in a state of being slightly displaced to the permissive hole 272. That is, when the ink is introduced into the ink introduction chamber S in a pressurized state, the displacement of the whole opening sealing portion k is regulated by the blocking portion 273 of the regulating plate 271. Moreover, by allowing the central portion alone of the opening sealing portion K to circularly bulge through the permissive hole 272, the pressure within the ink introduction chamber S is prevented from being in a highly pressurized state to cause breakage of the first film 228.

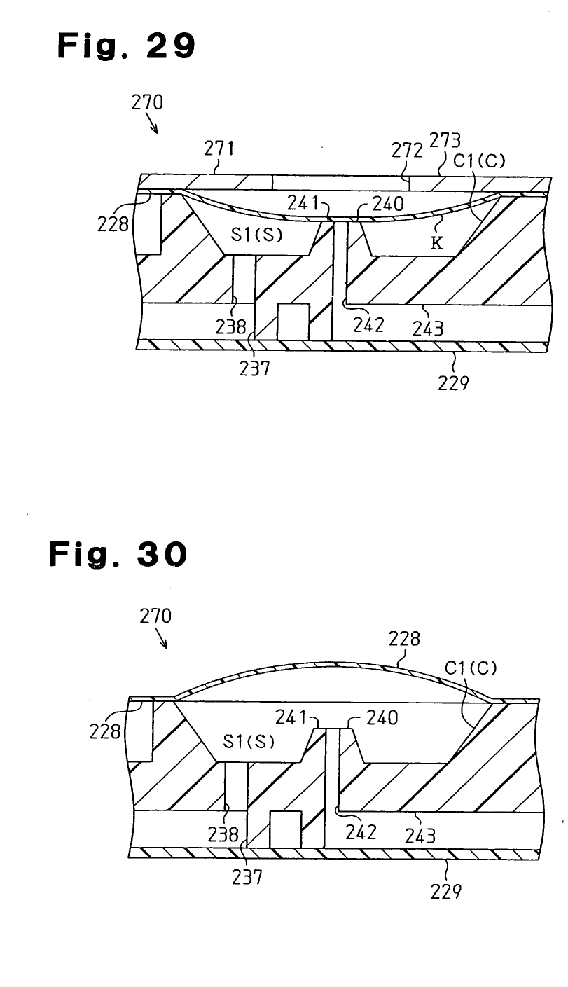

In the meanwhile, when the ink within the ink introduction chamber S is not more than the predetermined amount by the driving of a tube pump 26e and the like, and the inner pressure of the ink introduction chamber S is reduced to lower than the predetermined value, as shown in FIG. 29, the opening sealing portion K is flexed in a direction to reduce the volume of the ink introduction chamber S. As a result, the opening sealing portion K abuts against the upper surface 241 of the protruding portion 240 formed in the ink introduction chamber S, respectively, and blocks the flow of the ink to a communication hole 242. In FIG. 27, the position of the opening sealing portion K with no pressure difference between the inside and the outside of the ink introduction chamber S is shown. Further, as shown in FIG. 27, the first film 228 is not fixed to the main body 227 in a state of having no slackness at all, but in such a manner that the opening sealing portion K can bend within the ink introduction chamber S.

Next, the operation of the choke valve 270 will be described with the choke cleaning as an example. Before starting the choke cleaning, the opening sealing portion K constituting the ink introduction chamber S of the choke valve 270, as shown in FIG. 27 or 28, is at least in a state of not blocking the communication hole 242. At this time, when the ink flows above the predetermined amount into the ink introduction chamber S, as shown in FIG. 28, the central portion alone of the opening sealing portion K bulges, and the peripheral edge portion is regulated for upward movement by the regulating plate 271. As a result, the opening sealing portion K constituting each ink introduction chamber S is in a state of being regulated for upward displacement to increase the volume of the ink introduction chamber S by the regulating plate 271, and therefore, the displacement is small as a whole.

When the choke cleaning is started, a CPU 111 (see FIG. 9) stops the driving of a pressure pump motor 125 (see FIG. 9) according to a choke cleaning program, and at the same time, drives a cap lifting motor 126 (see FIG. 9). Then, the delivery of the air from a pressure pump 25 (see FIG. 12) is stopped, and the cap 26a (see FIG. 3) seals the nozzle surface.

Further, the CPU 111 advances to a drawing step, and drives a tube pump motor 127 (see FIG. 9), and accumulates negative pressure within the cap 26a. As a result, the ink is drawn through a recording head 148, and the ink within a first pressure chamber 203 and a second pressure chamber (not shown) begins to be reduced. The pressure within the first pressure chamber 203 and the second pressure chamber decreases to below the predetermined pressure, so that, similarly to the printing in the second embodiment, a second film member 189 is flexed, and a first valve member 188 and a second valve member (not shown) begin to rotate.

Then, the ink within the ink flow path of an ink supply tube 152(see FIG. 13) in the upstream side of each valve unit 155 flows within the valve unit 155. At this time, since the air from the pressure pump 25 is in a state of not being delivered, the ink within the first to the sixth ink introduction chambers S1 to S6 provided in the upstream side of the ink supply tube 152 also begins to be gradually reduced.

When the pressure within each ink introduction chamber S is reduced lower than the predetermined pressure, each opening sealing portion K of the first film 228 receives a force to approach the protruding portion 240 within each ink introduction chamber S. At this time, as described above, before each opening sealing portion K is displaced to the protruding portion 240, the opening sealing portion K is in a position not to largely isolate from the upper surface 241 of the protruding portion 240 by the regulation of the blocking portion 273 by the regulating plate 271. By so doing, in the choke cleaning, the ink drawing amount from the ink introduction chamber S until the opening sealing portion K is abutted against the protruding portion 240 is decreased. As a result, the time required from starting the driving of the tube pump 26e until the opening sealing portion K is abutted against the upper surface 241 of the protruding portion 240 is shortened.

When the opening sealing portion K abuts against the upper surface 241 of the protruding portion 240, the communication hole 242 is blocked. As a result, the flow of ink from the first to sixth ink introduction chambers S1 to S6 to the communication hole 242 is blocked. In this state, by allowing the suction operation to be continued by the tube pump 26e, with each ink introduction chamber S as a boundary, negative pressure is accumulated in the downstream side thereof. The CPU 111 measures the driving time of the tube pump motor 127 according to a choke cleaning program, and when a predetermined time elapses, it advances to a pressure increasing step, and starts the driving of the pressure pump motor 125. The CPU 111 completes the processing of the choke cleaning program when the driving of the pressure pump motor 125 is started.

As a result, the delivery of the air from the pressure pump 25 is started, and the ink from the ink cartridge 23 is supplied in a pressurized state. The ink supplied in a pressurized state flows from the upstream side of each ink introduction chamber S instantly to eliminate the negative pressure accumulated in the downstream side of each ink introduction chamber S. Then, the ink speeds up instantaneously and flows into each ink introduction chamber and to the downstream side of each ink introduction chamber S. As a result, the bubbles and impurities stagnated in the section downstream of each ink introduction chamber S are discharged instantly together with the ink from the nozzle of the recording head 148, thereby performing the so-called choke cleaning.

Consequently, according to the fourth embodiment, in addition to (9) of the second embodiment and (10) to (12) of the third embodiment, the following effects related to prevention of leakage are obtained.

(14) In the fourth embodiment, there is provided the regulating plate 271, which is provided for the choke valve 270, and regulates the displacement in a direction to reduce resistance of the flow path (a direction to increase the volume of the ink introduction chamber S), for the first film 228 flexed by the pressure difference between the inside and outside of each ink introduction chamber S. Consequently, in the choke cleaning, when the flow path resistance is increased by flexing the opening sealing portion K of the first film 228, since the opening sealing portion K is regulated in advance for displacement in a direction to decrease the flow path resistance by the regulating plate 271, the range of the displacement of the opening sealing portion K becomes small. That is, the opening sealing portion K in the choke cleaning promptly displaces to a position (a position abutting against the upper surface 241 of the protruding portion 240) required for the cleaning, and therefore, the time required until the flow path of the downstream side of the ink introduction chamber S is blocked is shortened, thereby improving the responsiveness of the opening sealing portion K to the drive start of the tube pump 26e.

(15) In the fourth embodiment, the regulating plate 271 is provided opposite to the ink introduction chamber S of the first film 228, and by blocking the peripheral edge portion of the opening sealing portion K from the outside, the displacement of the opening sealing portion K to the outside is regulated. Hence, the regulating plate 271 is provided from above the opening sealing portion K, and the displacement thereof is prevented from leaking by blocking its peripheral edge portion alone, and therefore, it is prevented from leaking simply constituted. Further, since the regulating plate 271 is provided outside of the ink flow path, contamination of the ink and disturbance of the ink flow is prevented from leaking.

(16) In the fourth embodiment, the regulating plate 271 blocks the peripheral edge portion of the opening sealing portion K, and is formed by the plate blocking portion 273 for regulating the displacement in a direction to enlarge the volume of the ink introduction chamber S and the blocking portion 273, and comprises the permissive hole 272 for allowing the displacement of the central portion of the opening sealing portion K. Hence, while regulating the displacement of the opening sealing portion K by the blocking portion 273, the displacement of the central portion of the opening sealing portion K is partially allowed by the permissive hole 272, so that the breakage of the first film 228 by that pressure is prevented in a case where the pressure within the ink introduction chamber S becomes high pressure. Further, making the blocking portion 273 in a plate shape simplifies the constitution.

(17) In the fourth embodiment, six sections of the first to sixth ink introduction chambers S1 to S6 are provided, and the main body 227 fixed with the first and second films 228 and 229 on the upper surface and the lower surface thereof is provided with the regulating plate 271. The regulating plate 271 comprises the blocking portion 273 for blocking the peripheral edge portion of the opening sealing portion K from among each opening sealing portion K constituting the first to sixth ink introduction chambers S1 to S6 and the permissive hole 272 for allowing the displacement of the central portion of each opening sealing portion K, respectively. Hence, there is no need to provide the regulating plate for regulating the displacement of each opening sealing portion K separately for each opening sealing portion K. Hence, an increase in the number of steps for manufacturing and steps for assembling is reduced.

Incidentally, the present embodiment may be changed as follows.

In the first embodiment, the first and second ink introduction chambers 84a and 84b of the valve unit 21 are formed by the first film member 45, the first and second square recess portions 61a and 61b, and the first and second spherical recess portions 63a and 63b. The first and second step surfaces 65a and 65b formed between the first and second square recess portions 61a and 61b and the first and second spherical recess portions 63a and 63b are provided with the first and second filters 43a and 43b.

The first film member 45 abuts against or is isolated from the first and second filters 43a and 43b, so that the flow path resistance is changed. If the flow path resistance is changed by the flexing of the first film member 45, the first and second ink introduction chambers 84a and 84b may be changed so as to be of other constitutions. For example, the first and second ink introduction chambers 84a and 84b may be configured without the first and second filters 43a and 43b.

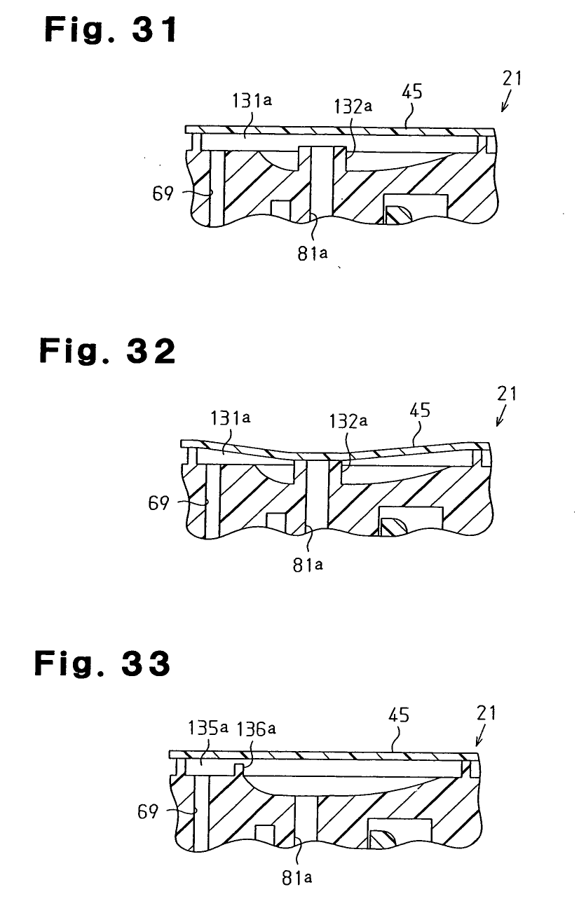

For example, similarly to the second to fourth embodiments, as shown in FIG. 31, a first ink introduction chamber 131a may comprise an annular projecting portion 132a provided so as to surround a communication hole 81a. By so doing, as shown in FIG. 32, when the choke cleaning is performed, the first film member 45 is flexed inside so as to abut against the annular projecting portion 132a, and the communication hole 81a is reliably sealed. As a result, more definite choke cleaning is performed. The second ink introduction chamber may be similarly changed.

In the first, second and fourth embodiments, the first film member 45 and the film 157 are flexed in a direction (in a direction to increase the flow path resistance) to reduce the volume of the first and second ink introduction chambers 84a and 85b, and the ink introduction chambers 178 and S when the pressure within the first and second introduction chambers 84a and 84b, and the ink introduction chambers 178 and S is reduced to lower than the predetermined pressure.

As shown in FIG. 36, the valve unit 21 may be provided with biasing means 137a for biasing the first film member 45 (the film 157 and the first film 228) always in a direction to reduce the volume of the first ink introduction chamber 84a (the ink introduction chamber 178 and S). The biasing means 137a may comprise the flow path forming member 41, a fixed end portion 139a unmovable to the main body 156, and a coil spring 141a located between the fixed end portion 139a and the first film member 45.

According to this, unless the pressure pump 25 is driven, and the pressurized ink is supplied, the first film member 45 (the film 157 and the first film 228) is always maintained in a position to increase the flow path resistance within the first ink introduction chamber 84a (the ink introduction chambers 178 and S). As a result, for example, at the time of maintenance and the like of the ink jet recording apparatuses 11 and 145, when the driving of the pressure pump 25 is not stopped, the flow path resistance within the first ink introduction chamber 84a (the ink introduction chamber 178 and S) is maintained high as it is. Consequently, at the exchange time of the ink cartridge 23 and the like, leakage of the ink from the connecting portion and the like with the ink supply tubes 35 and 152 and the ink cartridge 23 is reduced. The second ink introduction chamber 84b may be similarly changed so as to be provided with the biasing means.

In the first embodiment, in the negative pressure accumulation of the choke cleaning, the first film member 45 abuts against the first and second filters 43a and 43b, so that the flow of the ink passing through the first and second filters 43a and 43b are blocked. If the flow path resistance is increased for the ink passing through the first and second filters 43a and 43b, the flow may be totally blocked.

Further, in the second embodiment, the film 157 abuts against the protruding portion 179 so as to block the communication hole 180. In the third and fourth embodiments, the first film 228 abuts against the protruding portion 240 so as to block the communication hole 242. If the flow path resistance is increased for the ink passing through the communication holes 180 and 242, the flow does not need to be totally blocked.

In the first embodiment, the first and second ink introduction chambers 84a and 84b are provided integrally with the valve unit 21 which is provided with the first and second pressure chambers 106a and 106b and the first and second valve members 49a and 49b. However, the first and second ink introduction chambers 84a and 84b may be provided so as to be isolated from the valve unit 21.

In the first, third and fourth embodiments, a seal material to block the communication holes 81a and 242 may be attached to the inner sides of the first film member 45, the second film member 51 and the first film 228, similarly to the second embodiment.

In the second embodiment, though each ink introduction chamber 178 of the film 157 is provided with the seal material 183, this material may be omitted. Further, in the third embodiment, though the outside of the first film 228 is provided with six sections of biasing spring 261 confronting the first ink introduction chamber S1 to the sixth ink introduction chamber S6, these springs may be omitted.

In the second to fourth embodiments, the undersides of the ink introduction chamber 178 and the first ink introduction chamber S1 to the sixth ink introduction chamber S6 are provided with the protrusion portions 179 and 240 penetrated with the communication holes 180 and 242. In addition to the above, the protrusion portions 179 and 240 may be omitted, and similarly to the first embodiment, the filter is accommodated into the recess portion, and the film 157 or the first film 228 is abutted against this filter, so that the ink passing through the filter may be blocked, thereby blocking the communication holes 180 and 242.

In the second to fourth embodiments, though the recess portion 177 and the first recess portion C1 to the sixth recess portion C6 comprise the inclined surfaces, and at the same time, form the undersides thereof in a flat surface shape, the shape thereof may be other than that, and for example, it may be spherical. Further, though the recess portion 177 and the first recess portion C1 to the sixth recess portion C6 are formed in a circular shape, similarly to the first embodiment, the shape thereof may be square and the like.

In the third and fourth embodiments, though the lengths D1 to D6 of the first ink flow path L1 to the sixth ink flow path L6 of the flow concentration path 220 are taken as the sizes of the length D1, the length D2, the length D4, the length D5 and the length D6 in order, the flow path may be formed other than in this order. Further, though the lengths M1 to M6 of the flow path from the introduction holes 234 of the choke valve 221 and 270 to the first ink introduction chamber S1 to the sixth ink introduction chamber S6 are taken as the length M1 to the length M6 in order, the flow path may be formed other than in this order. That is, the length of the whole ink flow path comprising the ink flow path of the flow concentration path 220 and the ink flow path of the choke valves 221 and 270 connected therewith may be equal.

In the third and fourth embodiments, although the choke valves 221 and 270 comprise six sections of the first ink introduction chamber S1 to the sixth ink introduction chamber S6, the number of ink introduction chambers may be any number more than one as long as the number is equal to the types of the ink to be used in the ink jet recording apparatus 145. Further, in a case where the ink jet recording apparatus uses one type of the ink and the like, the choke valve formed with one ink introduction chamber may be connected to the flow concentration path 220.

In the second to the fourth embodiments, the ink jet recording apparatus 145 is provided with the flow concentration paths 151 and 220, and these flow concentration paths 151 and 220 are formed integrally with the ink flow path and the air flow path. In addition to the above described, in the second embodiment, instead of the flow concentration path 151, the ink supply tube 35 and the air supply tube 39 similarly to the first embodiment may be provided. The connecting side of each ink cartridge 23 may be provided with the connecting portion formed with the ink introduction chamber 178, and this connection portion may be connected to one end of the ink supply tube 35. Further, in the third and fourth embodiments, instead of the flow concentration path 220, the ink supply tube 35 and the air supply tube 39 may be provided. In the midst of the ink supply tube 152 connecting between the valve unit 155 and the ink cartridge 23, the choke valves 221 and 270 may be provided.

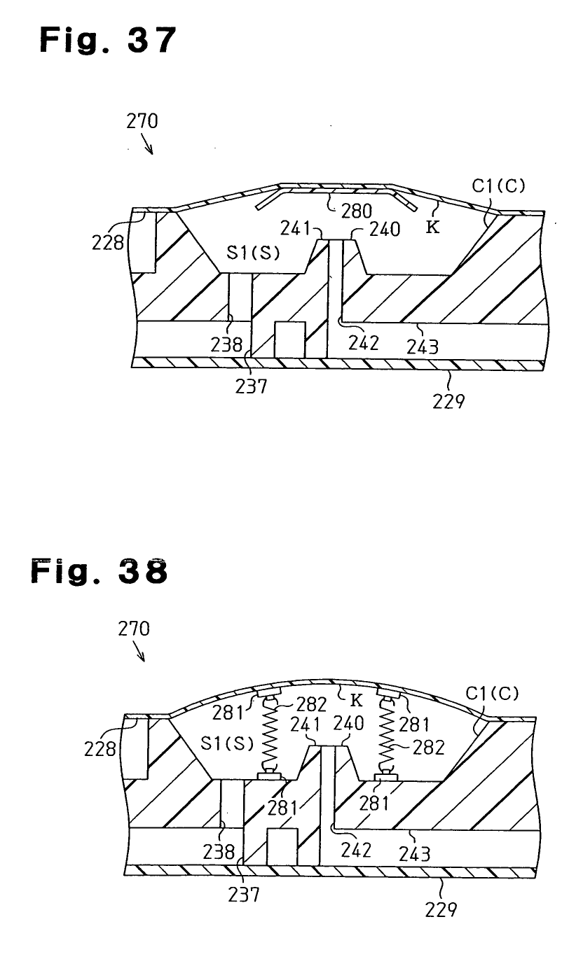

In the fourth embodiment, the regulating means may be provided to the ink introduction chamber S of the first film 228. For example, as shown in FIG. 37, the pressure receiving plate 280 may be provided in the inner side of the opening sealing portion K constituting the ink introduction chamber S. A part of the pressure receiving plate 280 may be fixed to the inner side of the opening sealing portion K, and the other part may be hung down according to the gravity without fixing it to the opening sealing portion K. By so doing, the opening sealing portion K receives a force so as to be flexed to the ink introduction chamber S by the gravity of the pressure receiving plate 280, and the displacement in a direction to enlarge the volume of the ink introduction chamber S is regulated.

Further, as shown in FIG. 38, elastic means as regulating means may be provided to the ink introduction chamber S of the first film 228. For example, two pairs of latch portion 281 may be provided in the inner side of the opening sealing portion K constituting the ink introduction chamber S and in the underside of the ink introduction chamber S, and the winding end of a tension spring 282 may be latched on each latch portion 281, respectively. An elastic force allowing the protruding portion 240 within the ink introduction chamber S to approach the opening sealing portion K may be provided by the tension spring 282. The elastic means is not limited to the tension spring, but may comprise an elastic member such as a rubber member and the like.

In the fourth embodiment, a compression spring for biasing the first film 228 to the ink introduction chamber S may be provided in the outside of the ink introduction chamber S. Further, regulating means may be provided, which comprises a surface which is not provided on the first film 228, but abuts against the opening sealing portion K only when the opening sealing portion K is bulged, and regulates the displacement in a direction to enlarge the opening sealing portion K.

In the fourth embodiment, the permissive hole 272 is not formed in the regulating plate 271, but may be formed in a simple plate shape. By so doing, for example, when the inside of the ink introduction chamber S is not highly pressurized to the extent that the first film 228 is broken, the time required until the opening sealing portion K blocks the communication hole 242 at the choke cleaning is shortened, so that the responsiveness as the choke valve is improved.

In the fourth embodiment, to regulate the displacement of the opening sealing portion K constituting a plurality of ink introduction chambers S, although the regulating plate 271 is provided with a plurality of permissive holes 272, similarly to the second embodiment, each ink introduction chamber S separately provided may be provided with the regulating plate provided with the regulating hole.

In the fourth embodiment, although the regulating plate 271 is made adaptable to the ink introduction chambers of the second and third embodiments, the constitution may be such that the plate 271 is provided in the valve unit 21 of the first embodiment. That is, the first and second ink introduction chambers 84a and 84b of the valve unit 21 are provided with the regulating plate provided with the regulation hole, respectively, and the first film member 45 may be regulated to displace in a direction for isolation from the first and second filters 43a and 43b.

In the fourth embodiment, although six sections of permissive hole equal to each opening sealing portion K are formed on the regulating plate 271, the permissive hole may be not less than six sections. For example, the regulating plate 271 may comprise a plurality of permissive holes for one opening sealing portion K. By so doing, the breakage of the first film 228 is more reliably prevented.

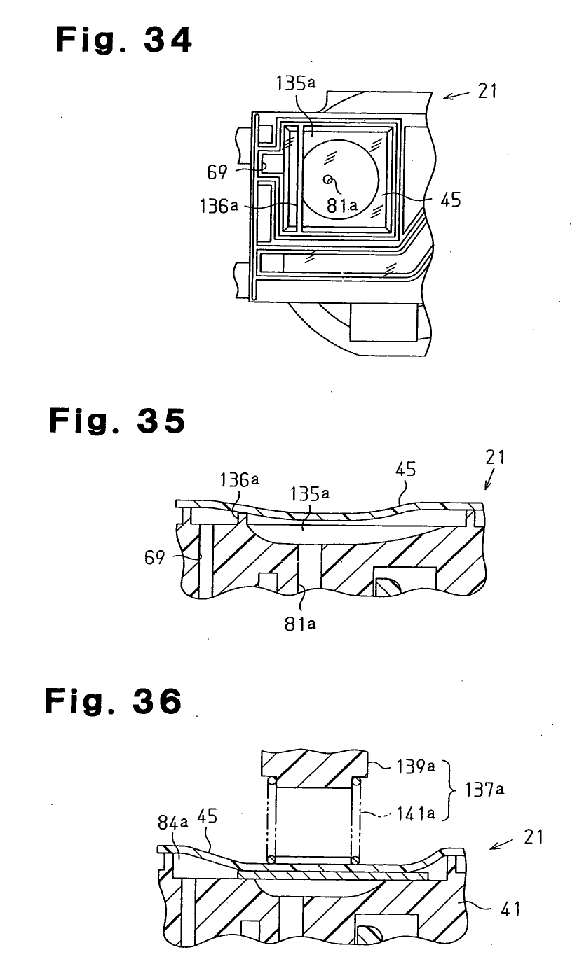

In each of the above described embodiments, as shown in FIGS. 33 and 34, a first ink introduction chamber 135a (the ink introduction chamber 178 and the first ink introduction chamber S1 to the sixth ink introduction chamber S6) may be provided with a rib 136a. This rib 136a does not abut against the first film member 45 (the film 157 and the first film 228) at the time of printing. The rib 136a, as shown in FIG. 35, abuts against the first film member 45 (the film 157 and the first film 228) at the pressure accumulation time by the choke cleaning, and is provided so as to block the flow between the communication hole 69 and the communication hole 81c(the communication holes 180 and 242). The second ink introduction chamber may be changed similarly.

(Fifth Embodiment)

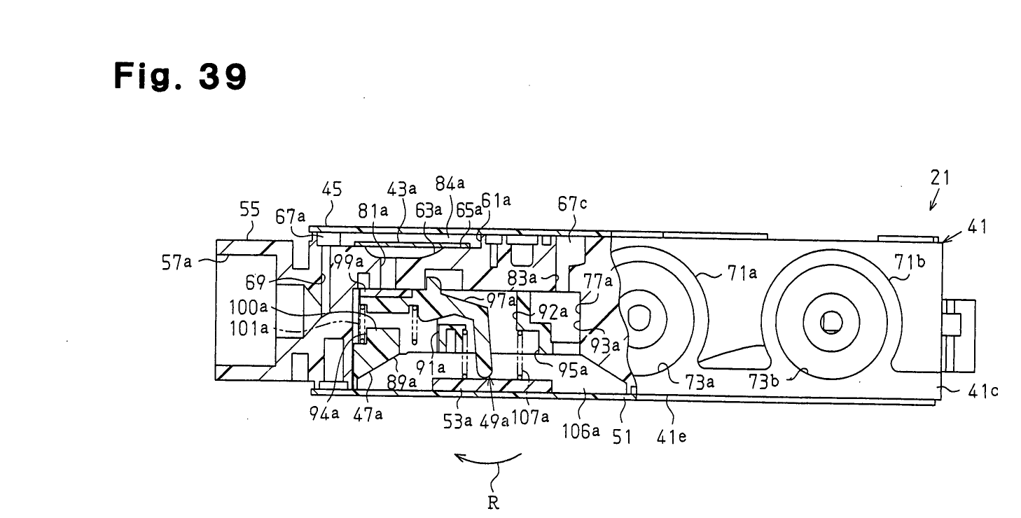

Next, a fifth embodiment according to the present invention will be described in detail according to FIGS. 39 to 41 by focusing on points of difference with the first embodiment.

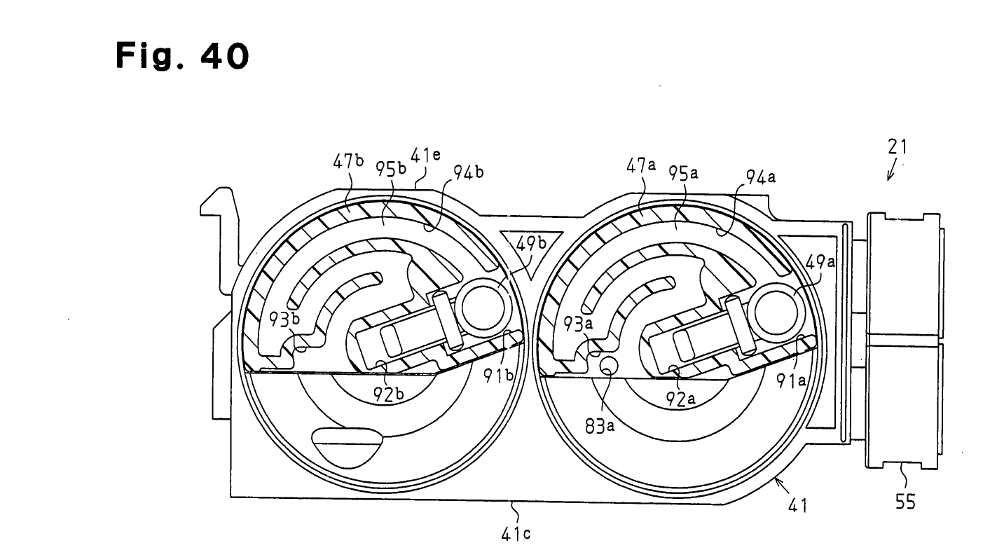

As shown in FIG. 40, first and second fitting members 47a and 47b are formed with first and second sigmoid grooves 94a and 94b, respectively. First and second sigmoid flow paths 95a and 95b are formed by the first and second engaging recess portions 77a and 77b of the flow path forming member 41, respectively. In the present embodiment, a bubble non-trap flow path is formed by the first and second sigmoid flow paths 95a and 95b.

One ends of the first and second sigmoid grooves 94a and 94b communicate with the first and second ink inflow holes 91a and 91b, and the other ends thereof communicate with the first and second ink outflow holes 93a and 93b. Consequently, with respect to the first and second sigmoid flow paths 95a and 95b, the one ends thereof communicate with the first and second ink inflow holes 91a and 91b, and the other ends thereof communicate with the first and second ink outflow holes 93a and 93b.

Further, the flow path cross-sectional areas of the first and second sigmoid flow paths 95a and 95b are formed so as to be sizes capable of securing the flow speed of the ink to the extent that the bubble contained in the ink is not stagnated within the first and second sigmoid flow paths 95a and 95b. That is, they are formed so as to be relatively small flow path cross-sectional areas.

As shown in FIG. 39, a second film member 51 is formed in substantially the same shape by the same material as that of the first film member 45, and is hot-welded to an upper surface 41e of the flow path forming member 41. At this time, the openings of first and second large recess portions 89a and 89b are sealed by the second film member 51, so that the second film member 51 is hot-welded to the flow path forming member 41. In this way, as shown in FIG. 39, first and second pressure chambers 106a and 106b are formed by the second film member 51 and the first and second large recess portion 89a and 89b. That is, a part of the wall surfaces of the first and second pressure chambers 106a and 106b is formed by the second film member 51. In the present embodiment, a bubble trap flow path, a bubble accumulator, and a liquid reservoir chamber comprise the first and second pressure chambers 106a and 106b.

Because of the above described constitution, as shown in FIG. 39, in the valve unit 21 of the present embodiment, when the ink flows into a first ink introduction hole 57a, the flowed ink begins to flow into a first ink inflow hole 91a through a communication hole 69, a first flow path 85a, a first ink introduction chamber 84a, and a communication hole 81a. The ink flowed into the first ink inflow hole 91a, from among two flow paths of the first sigmoid flow path 95a and the first pressure chamber 106a, passes through at least one of them, and flows out to the ink outflow hole 93a, and is supplied to a recording head 20 (see FIG. 1) from a first ink outflow 93a through a communication hole 83a, a third flow path 85c, and a first ink discharge hole 73a.

Further, similarly, in the valve unit 21 of the present embodiment, when the ink flows into a second ink introduction hole 57b, the flowed ink begins to flow into the second ink inflow hole 91b through the communication hole, the second flow path 85b, the second ink introduction chamber 84b, and a communication hole 81b. The ink flowed into the second ink inflow hole 91b, from among two flow paths of the second sigmoid flow path 95b and the second pressure chamber 106b, passes through at least one of them, and flows out to the second ink outflow hole 93b, and is supplied to the recording head 20 from the second ink outflow hole 93b through the communication hole 83b and a second ink discharge hole 73b.

In the present embodiment, the liquid supply path comprises each flow path from the first and second ink introduction holes 57a and 57b to the recording head 20.

Further, the second film member 51 is flexed by the pressure difference between the inside and the outside of the first and second pressure chambers 106a and 106b. That is, the second film member 51 is flexed in a direction to reduce the volume of the first and second pressure chambers 106a and 106b when the pressure within the first and second pressure chambers 106a and 106b are reduced to lower than the predetermined pressure.

In the present embodiment, depending on the flexing degree of the second film member 51, the volume of the first and second pressure chambers 106a and 106b changes between a first volume V1 to a second volume V2. The first volume V1 is larger than the second volume V2.

Accompanying the change of the volume in the first and second pressure chambers 106a and 106b, the flow path resistance given by the ink passing through the first and second pressure chambers 106a and 106b also changes. In the present embodiment, accompanying the change of the volume in the first and second pressure chambers 106a and 106b from the first volume V1 to the second volume V2, the flow path resistance changes between the intervals from a first flow path resistance value K1 to a second flow path resistance value K2. The first flow path resistance value K1 is smaller than the Second flow path resistance value K2.

In other words, the larger the degree of the flexing in the second film member 51 as well as the smaller the volume of the first and second pressure chambers 106a and 106b, the larger the flow path resistance.

Further, in the present embodiment, the first and second sigmoid flow paths 95a and 95b have the magnitude of the flow path resistance given to the ink formed so as to become a magnitude between the first flow path resistance value K1 and the second flow path resistance value K2. Consequently, when the degree of the flexing in the second film member 51 is small, and the volume of the first and second pressure chambers 106a and 106b is close to the first volume V1, the flow path resistance provided to the ink by the first and second pressure chambers 106a and 106b approaches the first flow path resistance value K1, and becomes smaller than the flow path resistance provided to the ink by the first and second sigmoid flow paths 95a and 95b. Consequently, in such a case, the ink flowed into the first and second ink inflow holes 91a and 91b positively passes through the first and second pressure chambers 106a and 106b, and flows out to the first and second ink outflow holes 93a and 93b.

Further, when the degree of the flexing in the second film member 51 is large, and the volume of the first and second pressure chambers 106a and 106b approaches the second volume V2, the flow path resistance provided to the ink by the first and second pressure chambers 106a and 106b approaches the second flow path resistance value K2, and becomes larger than the flow path resistance provided to the ink by the first and second sigmoid flow paths 95a and 95b. Consequently, in such a case, the ink flowed into the first and second ink inflow holes 91a and 91b positively passes through the first and second pressure sigmoid flow paths 95a and 95b, and flows out to the first and second ink outflow holes 93a and 93b.

That is, the distribution of the flow amount when the ink flowed into the first and second ink inflow holes 91a and 91b flows into the first and second pressure chambers 106a and 106b and the first and second sigmoid flow paths 95a and 95b is determined by the degree of the flexing of the second film member 51. The larger the flexing of the second film member 51, the more the distribution factor of the ink flowing into the first and second sigmoid flow paths 95a and 95b is increased.

Next, the operation of the ink jet recording apparatus 11 will be described.

First, the operation of the ink jet recording apparatus 11 at the time of normal printing will be described. At the time of normal printing, the ink is in a state of filling from an ink pack 32 to the recording head 20 for each color, and a pressure pump 125 is in a state of being driven through a second motor drive circuit 119 by a CPU 111, and the ink within the ink pack 32 is maintained in a pressurized state by pressurized air introduced into a gap 33 of an ink cartridge 23. Consequently, during printing, the ink is in a state of being supplied in a pressurized state from the ink cartridge 23 to a valve unit 21.

The valve unit 21 is supplied with the ink introduced in a pressurized state from the ink pack 32 for each color. As shown in FIG. 39, for example, the ink supplied to the first ink introduction chamber 84a through the first ink introduction hole 57a is maintained in a state of having high pressure. Consequently, the first film member 45 of the valve unit 21 is maintained in a state of being not flexed. As a result, the ink supplied into the first ink introduction hole 57a is in a state of being capable of passing through a first filter 43a.

The first pressure chamber 106a is in a state of being filled with the ink, and a first pressure receiving plate 53a is isolated from a first large recess portion 89a, and is in a state of having the volume close to the first volume V1. Consequently, the flow path resistance provided to the ink by the first pressure chamber 106a is a value close to the first flow path resistance value K1, and is smaller than the flow path resistance given to the ink by the first sigmoid flow path 95a. As a result, the ink flowing into the first ink inflow hole 91a positively passes through the first pressure chamber 106a, and flows out to the first ink outflow hole 93a.

In this state, when a printing is started based on an image data, the ejection of ink is performed from the recording head 20, and according to the ejection amount of the ink, the ink within the pressure chamber 106a of the valve unit 21 is supplied to the recording head 20 through the first ink discharge hole 73a and the like. As a result, the ink within the first pressure chamber 106a is reduced, and the inner pressure within the first pressure chamber 106a is reduced.

When the pressure of the ink within the first pressure chamber 106a is reduced to lower than the predetermined pressure, as shown in FIG. 10, the second film member 51 is flexed in a direction to reduce the volume within the first pressure chamber 106a. As a result, a first valve member main body 97a is rotated by a first pressure receiving plate 53a, and a communication state is established between the communication hole 81a and the first ink inflow hole 91a. The ink stored in a pressurized state within the first ink introduction chamber 84a flows into the first pressure chamber 106a, and the ink is caused to fill the first pressure chamber 106a.

Further, when the ink flows into the first pressure chamber 106a, the ink pressure within the first pressure chamber 106a is increased. As a result, the flexing of the second film member 51 is eliminated, and the first valve member main body 97a rotates toward the original position, and a non-communication state is established again between the communication hole 81a and the first ink inflow hole 91a.

That is, when the ink within the first pressure chamber 106 is reduced, and the inner pressure decreases to below the predetermined value, a communication state is established between the communication hole 81a and the first ink inflow hole 91a, and the ink is supplied to the first pressure chamber 106a. Further, with the ink supplied to the first pressure chamber 106a, the pressure of ink within the first pressure chamber 106a is increased, and when it becomes equal to or more than the predetermined value, a non-communication state is established between the communication hole 81a and the first ink inflow hole 91a, and the supply of the ink to the first pressure chamber 106a is stopped.

As a result, at the time of printing, the ink adjusted so as to have a pressure value within a predetermined range is in an accumulated state within the first pressure chamber 106a, and stability of the ink supply to the recording head 20 is secured.

At the time of printing, since the second film member 51, even if flexed, has its flexing promptly eliminated by the inflow of the ink from the first communication hole 81a, a volume change within the first pressure chamber 106a stays within a subtle range in the vicinity of the first volume V1. Consequently, at the time of printing, the flow path resistance given to the ink by the first pressure chamber 106a is always close to the first flow path resistance value K1, and is smaller than the flow path resistance provided to the ink by the first sigmoid flow path 95a. Consequently, the ink flowing into the first ink inflow hole 91a positively passes through the first ink pressure chamber 106a, and flows out to the first ink outflow hole 93a.

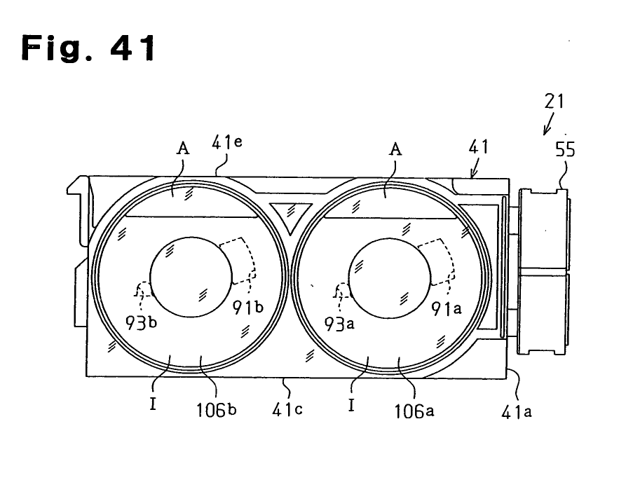

As shown in FIG. 41, since the first ink inflow hole 91a and the first ink outflow hole 93a are located in the vicinity of the central portion of the vertical direction of the first pressure chamber 106a, a bubble A contained in ink I flowed into the first pressure chamber 106a moves to a ceiling portion of the vertical direction of the first pressure chamber 106a due to the difference in specific gravity with the ink I. As a result, the bubble A is unable to flow out of the first pressure chamber 106 through the first ink outflow hole 93a, and is in a trapped state within the first pressure chamber 106a. In this way, the bubble in the ink passing through the valve unit 21 during the printing is trapped in the first pressure chamber 106a. Consequently, bubbles contained in the ink supplied to the recording head 20 are reduced, thereby improving printing quality.

With respect to the ink also supplied to the second ink introduction chamber 84b through the second ink introduction chamber 57b, similarly to the ink supplied to the first ink introduction chamber 84a, it is adjusted to have a pressure of predetermined range in the second pressure chamber 106b, and the bubble thereof is trapped.

Next, the operation of the ink jet recording apparatus 11 for the choke cleaning will be described. In the present embodiment also, similarly to each of the above described embodiments, an input portion 115 (see FIG. 9) is operated by the user so that choke cleaning is performed. When an ON signal is inputted to a CPU 111 by the operation of the input portion 115, the CPU 111 first drives a carriage motor 17 according to a choke cleaning program, and moves a carriage 15 to the home position.

Further, the CPU 111 stops the driving of the pressure pump 125 so as not to allow the pressurized air to be delivered from a pressure pump 25. As a result, the ink is in a state of being supplied in a non-pressurized state from the ink cartridge 23 to the valve unit 21. Subsequently, the CPU 111 drives a cap lifting motor 123, and lifts a cap 26a so as to seal the nozzle surface of the recording head 20. When the CPU 111 lifts the cap 26a, it advances to a flow amount reducing step, and drives a tube pump motor 127, and forms a negative pressure within the cap 26a.

As a result, the ink is drawn through the recording head 20, and the ink within the first and second pressure chambers 106a and 106b of the valve unit 21 begins to be reduced. In FIG. 11 a state is shown of the ink being reduced in the pressure chamber 106a, and with respect to the second pressure chamber 106b, as it is the same as the first pressure chamber 106a, the illustration thereof is omitted. As shown in FIG. 11, the pressure within the first and second pressure chambers 106a and 106b is reduced to lower than the predetermined pressure, so that, similarly to at printing time, the second film member 51 and the first and second valve member main bodies 97a and 97b and the like operate. As a result, a communication state is established between the first and second communication holes 81a and 81b and the first and second ink inflow holes 91a and 91b.

Then, the ink within the first and second ink introduction chambers 84a and 84b flows within the first and second pressure chambers 106a and 106b. However, for this choke cleaning, as described above, the ink from the ink cartridge 23 is supplied in the non-pressurized state within the first and second ink introduction chambers 84a and 84b. Consequently, the pressure within the first and second ink introduction chambers 84a and 84b also begins to reduce as a communication state is established between the first and second communication holes 81a and 81b and the first and second ink inflow holes 91a and 91b.

When the pressure within the first and second ink introduction chambers 84a and 84b is reduced to lower than the predetermined pressure, the first film member 45 is flexed, the first film member 45 abuts against the first and second filters 43a and 43b. As a result, the flow of the ink passing through the first and second filers 43a and 43b is blocked.

Next, the CPU 111 advances to drawing and flow amount changing steps, and in this state, allows the suction operation to be continued by the tube pump 26e. As a result, with the first and second ink introduction chambers 84a and 84b as a boundary, negative pressure is accumulated in the downstream side thereof. The degree of flexing of the second film member 51 becomes large, and the volume of the first and second pressure chambers 106a and 106b approaches the second volume V2. Then, the flow path resistance within the first and second pressure chambers 106a and 106b approaches the second flow path resistance value K2, and becomes larger than the flow path resistance of the first and second sigmoid flow paths 95a and 95b. As a result, the ink flowing into the first and second ink inflow holes 91a and 91b positively flows into the first and second sigmoid flow paths 95a and 95b.

The bubble A (see FIG. 41) trapped during printing is stagnated within the first and second pressure chambers 106a and 106b. However, the bubble A has no place to go within the first and second pressure chambers 106a and 106b as the degree of flexing of the second film member 51 becomes large by the continuation of the suction operation of the tube pump 26e. As a result, the bubble A moves to the first and second sigmoid flow paths 95a and 95b through the first and second ink inflow holes 91a and 91b.

As described above, since the first and second sigmoid flow paths 95a and 95b are formed relatively small in the flow path cross-sectional area thereof, in the first and second sigmoid flow paths 95a and 96a, the ink flows at a relatively high speed. Consequently, the bubble A flowed into the first and second sigmoid flow paths 95a and 95a is guided to the first and second ink outflow holes 93a and 93b without being stagnated in the first and second sigmoid flow paths 95a and 96a.

As a result, the bubble A trapped within the first and second pressure chambers 106a and 106b is moved to the recording head 20 through the first and second sigmoid flow paths 95a and 95b, and is discharged to the cap 26a through the nozzle of the recording head 20.

The CPU 111 measures the driving time of the tube pump 127 according to the choke cleaning program, and when a predetermined time elapses, it advances to a flow amount increasing step, and starts the driving of the pressure pump motor 125. The CPU 111 completes the processing of the choke cleaning program when the driving of the pressure pump motor 125 is started.

As a result, the delivery of the pressurized air from the pressure pump 25 is started, the ink is supplied in a pressurized state from the ink cartridge 23 to the valve unit 21. Then, the ink is supplied to the first and second ink introduction chambers 84a and 84b of the valve unit 21, and the flexing of the first film member 45 is eliminated. In this way, the first film member 45 is isolated from the first and second filters 43a and 43b, and the flow of the ink passing through the first and second filters 43a and 43b is allowed.

The ink flows instantly from the upstream side to eliminate the negative pressure accumulated in the section downstream of the first and second ink introduction chambers 84a and 84b, and the ink speeds up instantaneously in the and flows. As a result, the bubbles and impurities stagnated in the section downstream of the first and second ink introduction chambers 84a and 84b are discharged instantly together with the ink from the nozzle of the recording head 20, thereby performing the so-called choke cleaning operation.

As a result, after the completion of the choke cleaning, the ink is filled in the first and second pressure chambers 106a and 106b with the trapped bubble A in a state of being removed. Consequently, by performing the choke cleaning periodically, a bubble A trapped within the first and second pressure chambers 106a and 106b is periodically and reliably removed. As a result, trapping ability for bubbles in the first and second pressure chambers 106a and 106b is maintained without being reduced.

According to the fifth embodiment, the following effects are obtained.

(1) In the fifth embodiment, in the valve unit 21, the ink flowed into the first and second ink introduction chambers 57a and 57b is supplied to the recording head 20 by passing through at least either of the first and second sigmoid flow paths 95a and 95b or the first and second pressure chambers 106a and 106b. The first and second pressure chambers 106a and 106b are constituted to be able to easily trap a bubble. Further, the first and second sigmoid flow paths 95a and 95b have the flow path cross-sectional areas therefore formed in a size capable of securing the flow speed of the ink to the extent that a bubble contained in the ink is not stagnated within the first and second sigmoid flow paths 95a and 95b. Consequently, the first and second sigmoid flow paths 95a and 95b are constituted to be difficult to trap a bubble. Further, the distribution of the flow amount of the ink flowing into the first and second pressure chambers 106a and 106b and the first and second sigmoid flow paths 95a and 95b is changed by the flexing of the second film member 51.

Consequently, by the flexing size of the second film member 51, during printing, plenty of ink is allowed to flow into the first and second pressure chambers 106a and 106b. A probability of trapping the bubble contained in the ink supplied to the recording head 20 is enhanced. As a result, deterioration of printing performance by the discharge of bubbles together with ink from the recording head 20 is prevented.

Further, when the bubble trapped in the first and second pressure chambers 106a and 106b grows, and there arises a limit to the trapping ability of the bubble, the ink is allowed to flow into the first and second sigmoid flow paths 95a and 95b in plenty by the flexing size of the second film member 51. In this way, by the flow of the ink from the first and second sigmoid flow paths 95a and 95b to the recording head 20, the bubble trapped within the first and second pressure chambers 106a and 106b are guided to the first and second sigmoid flow paths 95a and 95b, and is discharged from the recording head 20. As a result, the removal of the bubble stagnated in the first and second pressure chambers 106a and 106b is reliably performed, and the trapping ability of the bubble in the first and second pressure chambers 106a and 106b is restored.

(2) In the above described embodiment, in the valve unit 21, the first and second ink inflow holes 91a and 91b and the first and second ink outflow holes 93a and 93b are provided substantially in the center of the vertical direction of the first and second pressure chambers 106a and 106b. Consequently, when the ink flows into the first and second pressure chambers 106a and 106b, a bubble contained in the liquid rises within the first and second pressure chambers 106a and 106b due to the difference in specific gravity with the ink, so that the bubble is not allowed to outflow from the first and second outflow holes 93a and 93b. As a result, the bubble is trapped by a simple mechanism, and there is no need to provide a complicated device for trapping bubbles, and therefore, the whole structure of the ink jet recording apparatus 11 is simplified.

(3) In the above described embodiment, the larger the degree of flexing of the second film member 51, the more the volume within the first and second pressure chambers 106a and 106b is reduced. The more the volume within the first and second pressure chambers 106a and 106b is reduced, the higher the flow path resistance with the first and second pressure chambers 106a and 106b, and the distribution of the flow amount of the ink flowing into the first and second sigmoid flow paths 95a and 95b is increased.

Consequently, when a bubble having been trapped in the first and second pressure chambers 106a and 106b grows, the flow amount of the ink flowing along the first and second sigmoid flow paths 95a and 95b is increased by sharply flexing the second film member 51. At this time, since the first and second pressure chambers 106a and 106b have the volume thereof reduced by the flexing of the second film member 51, the bubble within the first and second pressure chambers 106a and 106b is in a state of having no place to flow. Consequently, when the flow amount of the first and second sigmoid flow paths 95a and 95b is increased, and the bubble having no place to flow, is more reliably guided to the first and second sigmoid flow paths 95a and 95b, and the bubble trapped within the first and second pressure chambers 106a and 106b is more reliably removed.

(4) In the above described embodiment, the second film member 51 is a member flexed by the pressure difference between the inside and the outside of the first and second pressure chambers 106a and 106b. The inside and outside pressure difference is generated inside and outside of the first and second pressure chambers 106a and 106b by the driving of the pressure pump 25 and a capping device 26.

Consequently, the second film member 51 is indirectly flexed by a pressure change within the first and second pressure chambers 106a and 106b, which is generated by driving the pressure pump 25 and the capping device 26. That is, since driving means such as an actuator is not provided to directly bend the second film member 51, the driving means for displacing the second film member 51 is provided in a position spaced away from the second film member 51. As a result, the degree of freedom for design of the ink jet recording apparatus 11 is increased.

Further, to perform the choke cleaning, the device originally provided for the ink jet recording apparatus 11 is used also as a device for generating the pressure difference between the inside and the outside of the first and second pressure chambers 106a and 106b, and therefore, the mechanism of the device is simplified.

(5) In the above described embodiment, the first and second pressure chambers 106a and 106b provided for stabilizing the supply of the ink to the recording head 20 is used also as a liquid reservoir chamber for trapping the bubble. Consequently, the structure of the ink jet recording apparatus 11 is simplified.

(6) In the above described embodiment, the first and second sigmoid flow paths 95a and 95b are formed in an S-shape. According to this, in a totally compact state, the first and second sigmoid flow paths 95a and 95b are formed so that the length of the flow path is in a relatively long shape. As a result, the flow resistance of the first and second sigmoid flow paths 95a and 95b is made relatively high, and during printing, the constitution is made such that the inflow of ink is made difficult.

The above described embodiment may be modified as follows.

In the above embodiment, the first and second pressure chambers 106a and 106b as the liquid reservoir chambers trap the bubble by providing the first and second ink inflow holes 91a and 91b and the first and second ink outflow holes 93a and 93b substantially in the central portion of the vertical direction of the first and second pressure chambers 106a and 106b. If the holes are to be below the ceiling portions of the first and second pressure chambers 106a and 106b, the positions of the first and second ink inflow holes 91a and 91b and the first and second ink outflow holes 93a and 93b may be changed to other positions.

Further, if the bubble contained in the ink passing through the first and second pressure chambers 106a and 106b is trapped, the first and second pressure chambers 106a and 106b is changed to other constitutions.

In the fifth embodiment, the flow path resistance is changed by the second film member 51 and the like which change the volumes of the first and second pressure chambers 106a and 106b. The distribution factor of the flow amount of the ink between the first and second pressure chambers 106a and 106b and the first and second sigmoid flow paths 95a and 95b is changed. If the distribution factor of the flow amount of the ink between the first and second pressure chambers 106a and 106b and the first and second sigmoid flow paths 95a and 95b is changed, it may be changed by other distributing means. For example, the distribution factor of the flow amount of the ink between the first and second pressure chambers 106a and 106b and the first and second sigmoid flow paths 95a and 95b may be mechanically distributed by an on-off valve and the like.

In the fifth embodiment, the volumes of the first and second pressure chambers 106a and 106b are changed by flexing the second film member 51. These volumes may be changed by other flexible members. Further, the volumes of the first and second pressure chambers 106a and 106b may be changed by other volume changing means other than the flexible member.

In the fifth embodiment, the second film member 51 is flexed by a pressure adjusting step for changing the internal and external pressure of the first and second pressure chambers 106a and 106b. The second film member 51 may be flexed by displacing means other than the pressure adjusting means. For example, the actuator and the like directly flexing the second film member may be used as the displacing means.

In the fifth embodiment, the second film member 51 is flexed by adjusting the pressure of the ink by operation of the capping device 26 constituting the pressure adjusting means, the pressure pump 25, the first and second filters 43a and 43b, the first film member 45, and the first and second ink introduction chambers 84a and 84b. The second film member 51 may be flexed by generating the pressure difference between the inside and the outside of the first and second pressure chambers 106a and 107 by other pressure adjusting means.

In the fifth embodiment, the suction means is implemented as the capping device 26. This may be changed to another suction means capable of drawing the ink from the nozzle of the recording head 20.

In the fifth embodiment, the flow amount adjusting means comprises the pressure pump 25, the first and second filters 43a and 43b, the first film member 45, and the first and second ink introduction chambers 84a and 84b. This may be materialized into other flow amount adjusting means if the flow amount of the ink in the section upstream of the first and second pressure chambers 106a and 106b and the first and second sigmoid flow paths 95a and 95b is changed. For example, it may be materialized into the choke valve and the like which adjust the flow amount by crushing an ink supply tube 35.

In the fifth embodiment, at the negative pressure accumulation time, the first film member 45 abuts against the first and second filters 43a and 43b, so that the flow of the ink passing through the first and second filters 43a and 43b is blocked. If this increases the flow resistance to the ink passing through the first and second filers 43a and 43b, incomplete blocking of the flow may be performed.

In the fifth embodiment, the liquid reservoir chamber is materialized into the first and second pressure chambers 106a and 106b provided for the valve unit 21. This liquid reservoir chamber may be provided so as to be a separate body from the first and second pressure chambers 106a and 106b.

In the fifth embodiment, the first and second sigmoid flow paths 95a and 95b are formed in an S-shape. These flow paths may be formed in a serpentine shape other than the S-shape. Further, if the first and second sigmoid flow paths 95a and 95b have the magnitude of the flow path resistance thereof to be a value between the first flow path resistance value K1 and the second flow path resistance value K2, and at the same time, have the flow path cross-sectional areas capable of securing the flow speed, and capable of moving the bubble by opposing the buoyancy of the bubble, those flow paths may be changed to the flow paths of the other shapes.

In the fifth embodiment, as shown in FIG. 39, the choke valve 21 using the first film member 45 is provided for the valve unit 21. Further, the valve unit 21 is provided with the ink supply flow path (the first and second pressure chambers 106a and 106b) to the head at the normal printing time and the bubble discharge flow path (the first and second sigmoid flow paths 95a and 95b), and is provided with a flow path changing mechanism to selectively use the bubble discharge flow path in the choke cleaning.

Such a flow path changing mechanism is adapted for the device of the second embodiment. In this case, for example, a valve unit 155 shown in FIG. 18 is provided with the first and second sigmoid flow paths 95a and 95b in addition to the first and second pressure chambers 106a and 106b, and by the second film member 189 and the like changing the volume of the first and second pressure chambers 106a and 106b, the flow path resistance may be changed so as to change the distribution factor of the flow amount of the ink between the first and second pressure chambers and the first and second sigmoid flow paths.

Further, in each of the above described embodiments, though the first film member 45, the film 157, and the first film 228 may be made of the material capable of being hot-welded to thermoplastic resin, they may be formed of an elastic material such as an elastomer formed in a film shape. In this case, the film is attached to the flow path forming member 41 by adhesive agent and the like. By so doing, the film serves also as a function for the seal material.

In each of the above described embodiments, the suction means is implemented into the capping device 26. This may be changed to other suction means capable of drawing the ink from the nozzle of the recording head 20.

In each of the above described embodiments, the pressure adjusting means is implemented into the pressure pump 25 and the pressure tube 37. If this changes the pressure of the ink supplied to the first and second ink introduction chambers 84a and 84b of the valve unit 21, the ink introduction chamber 178 of the flow concentration path 151 or the first ink introduction chamber S1 to the sixth ink introduction chamber S6 of the choke valve 221, it may be implemented into another pressure adjusting means.

In each of the above described embodiments, the choke cleaning program is a program, which allows the CPU 111 to measure the driving time of the tube pump motor 127, and start the driving of the pressure pump motor 125 when the predetermined time elapses. The choke cleaning program may be a program where the CPU 111 starts the driving of the pressure pump motor 125 based on a factor other than the measuring result of the driving time of the tube pump motor 127.

In each of the above described embodiments, the valve units 21 and 155 correspond to ink of two colors, and one section each of the valve units 21 and 155 comprises two each of the ink introduction chamber, the pressure chamber and the like. The number of ink introduction chambers, pressure chambers and the like may be changed so that the valve units 21 and 155 correspond to ink of one color or ink of three colors.

In each of the above described embodiments, the ink cartridge 23 as the liquid cartridge comprises the ink pack 32 as the liquid accommodating portion, and the ink case 31 as the pressure chamber. This may be implemented into a liquid cartridge comprising another liquid accommodation portion and pressure chamber. As for the other liquid accommodating portion, it may be implemented into a portion forming the liquid accommodating portion and pressure chamber by partitioning the inside of a case by a film and the like as a flexible portion.

In each of the above described embodiments, a liquid ejection apparatus is described by using an ink jet recording apparatus 11 (including a printing apparatus such as a facsimile, a copier and the like) for ejecting the ink as the liquid ejection apparatus. This may be implemented into a liquid ejection apparatus for ejecting other liquid. For example, as for the liquid ejection apparatus for ejecting other liquid, it may be a liquid ejection apparatus for ejecting a liquid such as an electrode material, a color material and the like used in the manufacture of a liquid crystal display, an EL display and a surface-emission type display, a liquid ejection apparatus for ejecting a bioorganic substance used in the manufacture of a biochip, and a sample ejection apparatus as a precision pipette.

1. A liquid ejection apparatus, comprising:
liquid reservoir means for storing a liquid;
a liquid ejection head for ejecting said liquid toward a target;
a liquid supply path for guiding said liquid to said liquid ejection head from said liquid reservoir means; and
suction means for drawing said liquid from the liquid ejection head;
wherein said liquid supply path comprises a plurality of wall surfaces, and a part of the wall surfaces is formed of a flexible member that is flexed by pressure difference between the inside and the outside of said liquid supply path; and
wherein said liquid ejection apparatus comprises pressure adjusting means for adjusting the pressure of a fluid within said liquid supply path in the upstream side of said flexible member.

2. The liquid ejection apparatus according to claim 1,
wherein said liquid supply path comprises:
a large cross-sectional area flow path and a small cross-sectional area flow path, the flow paths having different cross-sectional areas and being mutually continued; and
wherein said flexible member confronts a step formed by said large cross-sectional area flow path and small cross-sectional area flow path.

3. The liquid ejection apparatus according to claim 2, wherein said step formed by said large cross-sectional area flow path and said small cross-sectional area flow path is located in a section downstream of said flexible member.

4. The liquid ejection apparatus according to claim 2, further comprising:
a liquid supply valve unit having a pressure chamber and an on-off valve, the pressure chamber temporarily storing said liquid on said liquid supply path and reducing said temporarily stored liquid as said liquid is ejected from said liquid ejection head, and the on-off valve detecting a negative pressure accompanying reduction of said liquid within the pressure chamber and switching a supply and a non-supply of said liquid from said liquid supply path to said pressure chamber,
wherein said large cross-sectional area flow path and said small cross-sectional area flow path are provided integrally with a flow path forming member constituting said liquid supply valve unit.

5. The liquid ejection apparatus according to claim 2, further comprising:
a liquid supply valve unit having a pressure chamber and an on-off valve, the pressure chamber temporarily storing said liquid on said liquid supply path and reducing said temporarily stored liquid as said liquid is ejected from said liquid ejection head, and the on-off valve for detecting a negative pressure accompanying reduction of said liquid within the pressure chamber and switching a supply and a non-supply of said liquid from said liquid supply path to said pressure chamber,
wherein said large cross-sectional area flow path and said small cross-sectional area flow path are provided in a separate member from said liquid supply valve unit, and are provided in the upstream side of said liquid supply valve unit.

6. The liquid ejection apparatus according to claim 2,
wherein said liquid reservoir means comprises a plurality of liquid cartridges, and said liquid supply path comprises a plurality of liquid paths each corresponding to one of the liquid cartridges;
wherein, with respect to the lengths of the liquid supply paths, the length from a liquid lead out port provided for each liquid cartridge to said large cross-sectional area flow path, the length from said liquid lead out port to said small cross-sectional area flow path, or the length from said liquid lead out port to said step is the same for all the liquid supply paths.

7. The liquid ejection apparatus according to claim 5,
wherein said large cross-sectional area flow path and said small cross-sectional area flow path are formed in a connecting portion for connecting said liquid reservoir means to said liquid supply path.

8. The liquid ejection apparatus according to claim 5,
wherein said liquid reservoir means comprises a plurality of liquid cartridges, and said liquid supply path comprises a plurality of liquid supply paths each corresponding to one of the liquid cartridges,
wherein the flow path forming member is provided between said liquid cartridges and said liquid supply valve unit, and
wherein said large cross-sectional area flow path and said small cross-sectional area flow path constituting each liquid supply path are provided integrally with said flow path forming member.

9. The liquid ejection apparatus according to claim 8,
wherein regulating means for regulating displacement in a direction to reduce flow path resistance in said liquid supply path is provided for said flexible member.

10. The liquid ejection apparatus according to claim 9,
wherein said regulating means regulates the displacement to the outside of said flexible member by blocking from the outside at least a part of the flexible areas of said flexible member.

11. The liquid ejection apparatus according to claim 10,
wherein said regulating means is a liquid ejection apparatus formed in a plate shape.

12. The liquid ejection apparatus according to claim 11,
wherein said regulating means comprises:
a blocking portion for blocking at least a part of the flexible areas of said flexible member; and
a hole portion allowing the displacement of said flexible member.

13. The liquid ejection apparatus according to claim 9,
wherein said regulating means is provided for said flow path forming member;
said regulating means comprising: the blocking portion for blocking each flexible area of said flexible member confronting each step formed by said each large cross-sectional area flow path and small cross-sectional area flow path; and
the hole portion partially allowing the displacement of said flexible area.

14. The liquid ejection apparatus according to claim 1,
wherein said liquid supply path comprises a filter in the midst thereof, and
wherein said flexible member is provided at a position to confront said filter.

15. The liquid ejection apparatus according to claim 2, further comprising a seal portion corresponding to said small cross-sectional area flow path, wherein said flexible member confronts said seal portion.

16. The liquid ejection apparatus according to claim 1, further comprising:
biasing means for biasing said flexible member in a direction to increase the flow path resistance in said liquid supply path.

17. The liquid ejection apparatus according to claim 1,
wherein said liquid reservoir means is a liquid cartridge having a flexible portion and comprising a liquid accommodating portion capable of containing a liquid and a pressure chamber for pressurizing said flexible portion of the liquid accommodating portion,
wherein said pressure adjusting means comprises:
a pressure pump for supplying pressurized air; and
an air flow path guiding said pressurized air to said pressure chamber.

18. The liquid ejection apparatus according to claim 2, wherein said flexible member is provided with a seal member confronting said small cross-sectional area flow path.

19. The liquid ejection apparatus according to claim 16, wherein said biasing means presses said flexible member to said step.

20. A driving method for a liquid ejection apparatus, wherein the liquid ejection apparatus stores a liquid, has
a liquid ejection head for ejecting said liquid toward a target; and
a liquid supply path for guiding said liquid to said liquid ejection head and a part of wall surfaces of said liquid supply path is formed of a flexible member that is flexed by the pressure difference between the inside and the outside of said liquid supply path,
said driving method comprising:
reducing the pressure of fluid within said liquid supply path in the upstream side of said flexible member;
drawing said liquid from said liquid ejection head when the pressure of said fluid within said liquid supply path in the upstream side of said flexible member is reduced to equal to or lower than a predetermined value; and
increasing the pressure of said fluid within said liquid supply path in the upstream side of said flexible member subsequent to said drawing.

21. A liquid ejection apparatus, comprising:
liquid reservoir means for storing a liquid;
a liquid ejection head for ejecting said liquid toward a target; and
a liquid supply path for guiding said liquid to said liquid ejection head from said liquid reservoir means;
said liquid supply path, comprising:
a bubble trap flow path comprising a bubble accumulator capable of trapping a bubble contained in said liquid; and
a bubble non-trap flow path in which a flow path cross-sectional area is determined to be able to transfer said bubble against buoyancy of said bubble, and
distributing means in which said bubble trap flow path and bubble non-trap flow path are mutually arranged in parallel, and a distribution factor of the flow amount of said liquid flowing through said bubble trap flow path and said bubble non-trap flow path is changed.

22. The liquid ejection apparatus according to claim 21, wherein said bubble accumulator comprises:
a liquid reservoir chamber;
a liquid inflow hole for allowing said liquid to flow into said liquid reservoir chamber; and
a liquid outflow hole for allowing said liquid to outflow from said liquid reservoir chamber;
wherein said liquid inflow hole and said liquid outflow hole are provided so as to be located further downward than a ceiling portion of said liquid reservoir chamber.

23. The liquid ejection apparatus according to claim 22,
wherein said distributing means is volume-changing means that changes flow path resistance of said bubble trap flow path from a first flow path resistance value to a second flow path resistance value larger than the first flow path resistance of said bubble trap flow path by changing the volume of said liquid reservoir chamber between the first volume and the second volume to be larger than the first volume, and
wherein said bubble non-trap flow path is formed such that the magnitude of its flow path resistance is between said first flow path resistance and said second flow path resistance.

24. The liquid ejection apparatus according to claim 23,
wherein said volume changing means comprises:
a flexible member constituting a part of the wall surface of said liquid reservoir chamber; and
displacing means for flexing said flexible member.

25. The liquid ejection apparatus according to claim 24,
wherein said flexible member is flexed by the pressure difference between the inside and the outside of said liquid reservoir chamber, and
wherein said displacing means is pressure adjusting means for allowing said liquid reservoir chamber to generate said pressure difference.

26. The liquid ejection apparatus according to claim 25,
wherein said pressure adjusting means comprises:
flow amount adjusting means for changing flow amount of said liquid flowing in said liquid supply path in a section upstream of said bubble trap flow path and said bubble non-trap flow path; and
suction means for drawing said liquid from said liquid ejection head.

27. The liquid ejection apparatus according to claim 22, further comprising a liquid supply valve unit,
said valve unit having:
a pressure chamber for temporarily storing said liquid on said liquid supply path and reducing said temporarily stored liquid as said liquid is ejected from said liquid ejection head; and
the on-off valve for detecting the negative pressure accompanying the reduction of said liquid within the pressure chamber and changing the supply and the non-supply of said liquid from said liquid supply path to said pressure chamber, and
wherein said liquid reservoir chamber is equivalent to said pressure chamber.

28. The liquid ejection apparatus according to claim 21,
wherein said bubble non-trap flow path is serpentine.

29. A liquid ejection apparatus, comprising;
liquid reservoir means for storing a liquid;
a liquid ejection head for ejecting said liquid toward a target;
a liquid supply path for guiding said/liquid to said liquid ejection head from said liquid reservoir means, the liquid supply path containing a bubble trap flow path formed in a flow path forming member and comprising a bubble accumulator capable of trapping a bubble contained in said liquid, and a bubble non-trap flow path in which the flow path cross-sectional area is determined to be able to transfer said bubble against buoyancy of said bubble, wherein said bubble trap flow path and bubble non-trap flow path are mutually arranged in parallel;
distributing means for changing a distribution factor of the flow amount of said liquid flowing through said bubble trap flow path and said bubble non-trap flow path; and
pressure adjusting means in which said liquid supply path comprises a plurality of wall surfaces, and a part of the wall surfaces is formed of a flexible member that is flexed by the inside-and-outside pressure difference of said liquid supply path, and the pressure adjusting means adjusts the pressure of the liquid within said liquid supply path in the upstream side of said flexible member;
wherein said liquid supply path is further connected to a large cross-sectional area flow path and a small cross-sectional area flow path, which are different in the flow path cross-sectional area, and mutually continued;
wherein said flexible member confronts a step formed by said large cross-sectional area flow path and said small cross-sectional area flow path; and
wherein said large cross-sectional area flow path and said small area flow path are provided in a member apart from said flow path forming member, and are provided in the upstream side of the flow path forming member.

30. A driving method for a liquid ejection apparatus, that stores a liquid, and includes a liquid ejection head for ejecting said liquid toward a target and a liquid supply path for guiding said liquid to said liquid ejection head, with said liquid supply path comprising a bubble trap flow path capable of trapping a bubble contained in said liquid and a bubble non-trap flow path, which is connected to the bubble trap flow path in parallel, and in which the flow path cross-sectional area is determined to be able to transfer said bubble against buoyancy of said bubble,
said driving method comprising:
changing a distribution factor of said flow amount of said liquid so that the flow amount of said liquid flowing through said bubble non-trap flow path is greater than the flow amount of said bubble trap flow path;
reducing the flow amount of said liquid flowing through said liquid supply path in the section upstream of said bubble trap flow path and said bubble non trap flow path;
drawing said liquid from said liquid ejection head; and
increasing the flow amount of said liquid flowing through said liquid supply path subsequent to said drawing.
